(19) United States
(12) Patent Application Publication
(10) Pub. No.: US 2013/0200606 A1
(43) Pub. Date: Aug. 8, 2013

(54) SECURITY IMPROVEMENTS FOR FLEXIBLE SUBSTRATES

(71) Applicant: Ralph Mahmoud Omar, Douglas (GB)

(72) Inventor: Ralph Mahmoud Omar, Douglas (GB)

(21) Appl. No.: 13/805,303

(22) PCT Filed: Jun. 24, 2011
(86) PCT No.: PCT/IB11/52800

§ 371 Date: Jan. 25, 2013

(30) Foreign Application Priority Data
Jun. 25, 2010 (GB) 1010735.7
Aug. 26, 2010 (GB) 1014254.5
Dec. 6, 2010 (GB) 1020604.3

(51) Int. Cl. G06K 9/00; B42D 15/00; B41J 2/435

(52) U.S. Cl. CPC G06K 9/00442; B41J 2/435; B42D 15/00
USPC 283/74; 347/200; 382/135; 382/115; 382/100

(57) ABSTRACT

A method of creating an optical security element in a value document using a low-cost printing device of a data processing terminal is described. The method comprises: providing a flexible substrate having a pre-printed ink portion; wherein the pre-printed ink portion is provided in an unexposed state which does not provide an optical security function of the security element; configuring a variable laser irradiation device to determine a part of the unexposed pre-printed ink portion to be exposed to laser radiation in a machine-controlled manner, and exposing the unexposed pre-printed ink portion to laser radiation in the machine-controlled manner to create from the pre-printed ink portion a predefined pattern, wherein the optical characteristics of the pattern provide the optical security element.

### TECHNICAL FIELD

The present invention concerns security improvements for flexible substrates, such as tickets/financial instruments/legal documents/legal certificates or other forms of valuable documents (“Value Documents”) containing security elements. These type of documents have a paper/polymer/plastic and/or metallic (or combinations of the same) substrate (hereinafter referred to as ‘financial instruments or value documents’, for example banknotes). It also includes the use and/or creation of value documents which are (partially or in their entirety) see-through to the human eye and which comprise of two or more layers with one layer being any type of transparent material including for example varnish/plastic/plastic film/polymer and/or resin or combinations of the same. The present invention also specifically concerns improvements relating to the creation of low-cost long-term secure documents, and more particularly though not exclusively to low-cost distributed printing of value documents. These documents may be capable of multiple use or validation both during and beyond the short term. In view if this, it is desirable to maintain the same methodology of validation whilst attempting to avoid denigration of their security features through multiple use or validation to avoid them becoming unusable during the short term, which would necessitate considerable further expense of a reissue of the secure document. The present invention also extends to authentication techniques for use with such documents and to the field of secure data transmission and in particular to an improved steganographic method of securely transmitting data between remotely located terminals.

### BACKGROUND

The unauthorised reproduction and tampering of financial instruments/value documents is a significant concern to financial and government institutions, and accordingly significant resources are invested in security measures to prevent such acts of fraud. Often a direct correlation exists between the complexity of the security measures employed, the level of security provided, and the associated costs. Accordingly, the value of the financial instruments/value documents to be protected have a significant bearing on the choice of employed security measure. This is most evident in banknote production. Lower value banknotes tend to have fewer security measures to prevent counterfeiting, and accordingly are produced at lower cost, whilst the production costs of higher value banknotes are greater due to the complex security features employed.

The production costs for printing banknotes and/or other forms of financial instruments/value documents having a security feature including legal documents and other forms of certificates recording or enabling the exchange of value or certificates recording legal functions, comprising traditional security features, are considerable, and only become manageable when large economies of scale are involved. This is due to the specialised hardware required to provide the different printing techniques necessary to create each of the specific security features, which ultimately facilitate the identification of counterfeit banknotes. Such methods are unsuitable for production of small numbers of financial instruments/value documents, due to the large base costs.

Furthermore, the high operational costs associated with the specialised hardware required for printing banknotes, means that production tends to be centralised in a select few locations within each country. Accordingly, traditional banknote printing methods are not suitable for applications where the production of paper and/or other man-made or man-processed substance-based tickets occurs in a plurality of different locations, where the economies of scale required for cost effective production cannot be met. In addition, some instruments recording value transactions or providing a legal record of the same, are achieved by thermographic printing and cannot be printed at site of issue (using long-lasting inks or inks with security features mitigating against forgery). This is due to cost and technological barriers requiring the use of expensive and cumbersome printing devices and ‘wet’ ink processes in small and otherwise inexpensive thermographic printing machines. Conventional high security printing is technically not possible in thermographic printing environments and is cost prohibitive to place within or close by to the same thermographic printing facility.

It is desired to provide an alternative, low-cost security measure for use with flexible substrates such as tickets and paper and/or polymer and/or plastic and/or metallic (or combinations of the same) substrate based financial instruments/value documents, which are capable of providing the same level of protection against counterfeiting, as achieved by traditional banknote printing methods. Additionally, it is an objective to provide a system and method, which may be easily incorporated into existing financial instrument/value document issuing terminals at low cost.

Another different prior art problem is described below. Secure value documents, which have a designed lifespan of over six months, are and have been produced by several different methods. Common to each of these methods is the feature of selecting a durable substrate for the document as this is considered to be essential to the longer life span of the value document. The cost of such durable substrates can be expensive and also can require complex expensive printing machinery to handle this type of substrate. The term ‘long-term’ as used herein in this document is intended to cover a time period of greater than six months and preferably a period of 1 to 10 years (and greater where possible), but can refer to a period less than six months where documents are issued in a high-wear environment where usage causes wear and tear more commensurate with a period in excess of six months.

As the value documents are designed to have a long life, they typically have a greater value and are more susceptible to fraud. For this reason, such documents also tend to be produced in a sophisticated manner which is more difficult for a forger to reproduce. Also such value documents tend to have a multitude of security features such as watermarks, colour variations, metallic foil strips, seals and holograms provided in them to make them harder to copy (for example as seen in banknotes). However, whilst security is improved, the cost of the document and its printing again become relatively expensive. Also the cost of the printing machinery, for example banknote printing machinery, required to produce the complex document also increases substantially along with the complexity of process, complexity of use and requirement for special security and environmental conditions.

The need for the above different types of security features stems from the requirement to have a visually verifiable security device on the value document which can give the owner or recipient of the value document confidence that the value document is not a forgery. This needs to be able to be determined without recourse to any authentication procedure, which may be required on redemption of the value document.

Furthermore, in systems configured to carry out authentication of such value documents, problems can arise. One problem is in the tracking of each value document produced which presents a significant issue when the number of such documents produced is very high. This is because each value document must be uniquely identifiable and verifiable during its lifespan. Also having unique numbering systems in place to cope with the required volume of unique numbers can result in high costs. Furthermore, as any numbering schema and authentication procedure used is valid for a long period of time, they need to be even more secure against the higher risk of fraud. This disadvantageously results in complex high-cost authentication procedures being used.

It is thus desired to mitigate at least some of the above described problems with low-cost printing.

Another different problem with the known prior art is now described with reference to FIG. 1. FIG. 1 is a schematic process diagram illustrating the traditional method used to print banknotes. Such traditional methods involve incorporating several security features in the printing process which deter counterfeiting and tampering, due to the inherent practical difficulties in accurately reproducing the security features. Additionally, the security features facilitate the detection of counterfeits and tampered banknotes. Production of the required security features is a complex process. Typically, banknote printing is a multi-stage process comprising several different printing methods. An outline of the main printing processes involved in banknote printing are discussed below.

A substrate 10, commonly cotton paper or polymer paper, is fed into a first printing module 12. Typically, the first printing module 12 will be an offset printer, which is responsible for printing the background image appearing on a banknote. The substrate 10 is then passed to an intaglio printer 14, where a raised print is printed on the substrate 10. The raised print provides the banknote 10 with a texture which is perceptible to touch, and is achieved by using printing plates with incisions of the raised image to be printed on the banknote 10. Intaglio printing may also be used to print latent images on the substrate 10, which are only perceptible at very small incident angles. The substrate 10 is next passed to a letterpress printer 16 where one or more unique identifiers (not shown), such as serial numbers are printed on the substrate 10. This facilitates tracking and auditing of banknotes. It is not uncommon for a banknote to feature a plurality of different serial numbers. The final stage of the banknote printing process is cutting and stacking 18, wherein the printed substrate is cut into individual banknotes for circulation.

Additional steps are often incorporated into the above outlined banknote printing process. For example, the addition of holograms, using hot-stamping foil; the inclusion of security threads in the substrate during manufacture of the cotton paper and/or polymer paper; the use of colour-changing inks; fluorescent dyes; thermochromatic ink; and magnetic inks are all non-exhaustive examples of commonly used security features prevalent in modern banknote printing.

Whilst the security features present in the majority of modern banknotes render accurate fraudulent reproduction/counterfeiting and/or tampering of banknotes extremely difficult, the cost of the required hardware, renders the method unsuitable for most applications, and in particular for those applications requiring non-centralised low-cost production of flexible substrates, such as tickets and paper and/or man-made or man-processed other substance-based financial instruments/value documents. In the specific example of banknote production, centralised production is highly desirable as it facilitates control of the banknote supply chain, which is critical to banknote production. However, such a requirement is not always necessary nor desirable, and will be dependent on the type of value document concerned.

For example, lottery tickets are often manufactured ‘on-site’ at terminals located at distribution points. Often, there are a plurality of different distribution points remotely located to one another. Whilst the majority of lottery tickets may not be associated with any significant value, the select few which are associated with a winning jackpot, may have a significant value associated with them. Accordingly, preventing the fraudulent reproduction and/or tampering of winning lottery tickets is an important requirement for lottery providers. Banknote printing methods are unsuitable for this application due to the relatively high costs associated with the required printing hardware, and its unsuitability for inclusion in existing ‘on-site’ distribution terminals. It is not practical to centralise the production of lottery tickets designed for mass distribution on terminals in order to inculcate security features and installing specialised printing hardware used in banknote production at each lottery terminal dispatch site is not cost-effective nor physically practical due to the physical size of the required hardware. In addition, on occasion lottery tickets and/or lottery draw information and/or other form of prize draw information contained in tickets or other forms of physical receipt can be an incorporated part of a premium bond or other financial instruments which will have value from the moment it is printed thus mitigating against distributed printing methods (due to security risks as these will be impossible to render open to the use of security ink features). Such restrictions thus negatively mitigate against the wide distribution of premium bonds or prize associated financial instruments outside secure environments as they ‘have value’ on first printing as opposed to actual issue to a customer and hence have to be issued in a highly controlled and secure environment.

It is also desired to mitigate or overcome these problems.

### SUMMARY OF THE INVENTION

One aspect of the present invention provides an alternative, low-cost system and method for preventing the fraudulent duplication, counterfeiting and/or tampering of flexible substrates such as tickets or paper and/or man-made or man-processed other substance-based financial instruments/value documents. In particular, a system and method incorporating the use of electromagnetic-sensitive inks (EM-sensitive inks) in the manufacture and validation of financial instruments is provided for. In addition, a pre-prepared wet ink strip placed in a protected layer could be adapted to be attached to paper and/or man-made or man-processed other substance-based financial instruments/value documents suitable for thermographic printing to allow various ablation processes using electromagnetic spectrum energy sources to be applied to the strip in an ablating process to appear to ‘print’ a wet ink effect at a later stage within the thermographic printing environment.

One aspect of the present invention proposes a system and method of emblazing a security feature on any financial instrument/value document, by ablating a pre-existing ink strip, sensitive to electromagnetic radiation, with high-intensity, substantially monochromatic light to form a security feature comprising a pattern in the pre-printed ink layer. The ink strip is preferably resistant to chemical attack.

More specifically according to one aspect of the present invention there is provided a method of creating an optical security element in a value document using a low-cost printing device of a data processing terminal, the method comprising: providing a flexible substrate having a pre-printed ink portion; wherein the pre-printed ink portion is provided in an unexposed state which does not provide an optical security function of the security element; configuring a variable laser irradiation device to determine a part of the unexposed pre-printed ink portion to be exposed to laser radiation in a machine-controlled manner, and exposing the unexposed pre-printed ink portion to laser radiation in the machine-controlled manner to create from the pre-printed ink portion a predefined pattern, wherein the optical characteristics of the pattern provide the optical security element.

An example of a suitable chemical which could be used to create a pattern in the ink layers would be an ink eradicator. Ink eradicators disrupt the geometry of the dye molecules in ink so that light is no longer filtered. The molecules are disrupted by Sulfite or Hydroxide ions binding to the central carbon atoms of the dye. The ink is not destroyed by the erasing process, but is made invisible.

Expensive specialist printing machines for printing a new security feature are thus avoided, by forming in or on the raw substrate a strip of ink, which is sensitive to electromagnetic radiation, and during the process of manufacture of the flexible substrate, exposing portions of that strip to electromagnetic radiation to form a stencil of an authentication number, code, or mark. This process of taking away ink from a block, rather than printing it, is much cheaper as it does not require expensive specialist equipment. Also, this process can be bolted onto existing printing processes inexpensively.

During manufacture of the financial instruments/value documents, existing EM-sensitive ink strips are ablated, using high-intensity, focused monochromatic light. Such light can be provided by monochromatic lasers and/or other technically possible and cost-effective light and/or electromagnetic radiation sources.

Validation of financial instruments/value documents manufactured in accordance with the method and system of the present invention, is provided by analysis of the reflectance spectrum of the ablated EM-sensitive ink strips.

Ablation of the EM-sensitive ink strips comprises ablating a security feature in the ink strip, for subsequent verification. Types of EM-sensitive inks which can be used are colour shifting or OVI or optically variable ink and OVMI or optically variable magnetic ink for example.

Ablation of the EM-sensitive ink strips is provided for by a laser, having an operational bandwidth selected on the basis of the optical characteristics of the employed ink type that is on the basis of the wavelengths which the ink strip is sensitive to.

In preferred embodiments, an infrared laser and/or light and/or electromagnetic radiation source is employed to ablate a security feature on an infrared and/or light and/or electromagnetic radiation sensitive ink strip. Alternatively, a laser operating in the ultraviolet light spectrum may be employed in conjunction with ultraviolet light sensitive ink.

Verification of the ablated security features is performed from an analysis of the reflectance spectrum of the ablated EM-sensitive ink strip.

In an alternative embodiment of the present invention, a dual-layer ink strip is employed, comprising of a first EM-sensitive ink strip printed on top of a second chemical-resistant ink strip, such that the ablated first EM-sensitive ink strip effectively forms a stencil, superimposed on the second chemical and/or laser and/or light and/or electromagnetic radiation-resistant ink strip.

Preferably in a dual-layer ink strip, the lower layer comprises a wavelength shifting property, which absorbs light at one wavelength, preferably in the non-visible spectrum, and transmits light at another, preferably visible wavelength.

Validation of the dual-layer ink strip is performed by irradiating the EM-sensitive ink strip with electromagnetic radiation, the bandwidth of which being selected on the basis of the optical characteristics of the inks comprised within the dual-layer ink strip, such that the reflectance spectrum of the second chemical-resistant ink strip is distinguishable from the reflectance spectrum of the first EM-sensitive ink strip.

According to another aspect of the present invention there is provided a printing device for creating an optical security element in a value document, the device comprising: a variable electromagnetic energy irradiation device; a module for providing a flexible substrate having a pre-printed ink portion; wherein the pre-printed ink portion is provided in an unexposed state which does not provide an optical security function of the security element; a processor for determining a part of the unexposed pre-printed ink portion to be exposed to radiation in a machine-controlled manner; a controller for controlling the variable irradiation device to expose the unexposed pre-printed ink portion to electromagnetic radiation in the machine-controlled manner to create from the pre-printed ink portion a predefined pattern, wherein the optical characteristics of the pattern provide the optical security element.

The present invention also extends to a data processing terminal including a low-cost printing device comprising a variable irradiation device; a module for providing a flexible substrate having a pre-printed ink portion; wherein the pre-printed ink portion is provided in an unexposed state which does not provide an optical security function of the security element; a processor for determining a part of the unexposed pre-printed ink portion to be exposed to radiation in a machine-controlled manner, a controller for controlling the variable irradiation device to expose the unexposed pre-printed ink portion to radiation in the machine-controlled manner to create from the pre-printed ink portion a predefined pattern, wherein the optical characteristics of the pattern provide the optical security element.

The present invention in another aspect is directed to providing a novel method of and apparatus for producing a relatively low-cost value document, which has a relatively long lifespan and can be produced using relatively low-cost apparatus. Preferably, the low-cost value document also incorporates security features suitable for documents having such a long-life.

According to one aspect of the present invention there is provided a long-term value document having a low-cost thermal printing substrate with portions thereof provided respectively with an independent identifier and a symbol in long-term ink on the low-cost substrate, wherein the independent identifier is related to the symbol in a machine-verifiable manner using data not provided on the document.

One advantage of the present invention is that the value document can be produced relatively cheaply using inexpensive apparatus. There is no requirement to use expensive substrates which have been made to incorporate watermarked areas, and include expensive holographic devices or embedded metal foil strips. Rather, the substrate can advantageously be comprised of inexpensive thermographic paper. This advantageously enables the value document to be produced in a distributed manner for example at multiple distributed locations, for example retail outlets in a similar manner to a lottery ticketing system.

The current invention addresses a problem of how to devise a long-term security feature on thermographic or other paper printed on a highly-distributed basis whilst maintaining security against fraud and forgery. Also, this may be required as a visually verifiable feature in addition to conventional authentication procedures which tie visible identification codes on the value documents to covert corresponding records used for authentication in an authentication system. The problem is that if visible identification codes are made to have a long lifespan via ink effects, then it makes it much more likely that the authentication relationship can be determined by hackers over time by the comparison of many series of entries. Alternatively, the number of algorithmic authentication connections that are required have to be extremely large to obviate this problem which in itself is disadvantageous.

The solution to this problem as provided by one of the embodiments described herein is to print both a serial number and a date number or some other central database recorded number and a symbol in long-term ink on the low-cost substrate. The symbol is also stored in a data file in a central database of an authentication computer system such that for tickets with serial number ‘x’ or date ‘y’, an conversion algorithm which is provided in the computer system is used which generates a corresponding covert file number corresponding to an address of the data file in the database where the random symbol that is printed on the ticket is deposited.

According to another aspect of the present invention there is provided a printing device for creating an optical security element in a value document, the device comprising: a variable electromagnetic energy irradiation device; a module for providing a flexible substrate having a pre-printed ink portion; wherein the pre-printed ink portion is provided in an unexposed state which does not provide an optical security function of the security element; a processor for determining a part of the unexposed pre-printed ink portion to be exposed to radiation in a machine-controlled manner; a controller for controlling the variable irradiation device to expose the unexposed pre-printed ink portion to electromagnetic radiation in the machine-controlled manner to create from the pre-printed ink portion a predefined pattern, wherein the optical characteristics of the pattern provide the optical security element.

The present invention also extends to a validation process for use with a value document comprising a machine-readable validation identifier and a machine-readable serial identifier on the value document, the validation process comprising: reading the validation and the serial identifiers at a validation terminal; using machine-stored information to determine a resultant validation identifier from the read serial number or a resultant serial identifier from the read validation identifier; comparing the resultant validation or serial identifier with the respective read validation or serial identifier; and validating the value document if the read and resultant validation or serial identifiers are equivalent.

Alternatively one aspect of the present invention could be considered to be directed to a validation process for use with a value document comprising a machine-readable serial identifier, a machine-readable independent identifier and a symbol identifier on the value document, the validation process comprising: reading the serial and validation identifiers at a remote validation terminal; transmitting at least the serial and validation identifiers to a central validation server; exposing the serial and validation identifiers to an address determining algorithm; using an address determined by the algorithm to look up a validation symbol stored at the address location; and enabling comparison of the validation symbol and the respective symbol identifier to enable validation of the value document.

In a validation scan, a remote terminal can send the symbol to the central authentication system and the authentication system exposes the date or serial number to the relevant algorithm for that series (there may be several different conversion algorithms, one for each different range of dates or serial numbers, which are periodically changed). The result is an address which refers to the covert file in the central database. The contents of which are retrieved and compared with the originally received information from the terminal. If the two compared symbols match, the authentication computer system and sends back a “valid” authentication signal back to the remote terminal.

As the ticket only carries the serial number and the symbol, a hacker cannot know what algorithm pertains to that date series or serial number series and also cannot know what file the symbol would be kept in. A straight reproduction of the actual ticket would be required to defraud the system.

As an extra security feature, personal information could be rendered in the ticket by the terminal. This would be by way of the person entering such personal information into the terminal such as date of birth (whether in full or in part) or initial or surname (or any portions thereof) and the terminal using a laser to ablate that information back onto the ticket in some readable, possibly encrypted form. This would ensure that only the person associated with the ticket (typically its purchaser) could redeem that ticket as their personal information could be recalled for authentication. The personalization of the receipt/ticket/certificate to the named bearer adds a further layer of security.

The security of the above-described authentication method, is in the use of a covert file reference which pertains to a unique ticket tied to a single person with the same names as on the ticket. As a further option, the symbol can have a small feature or attribute missing which is only detectable by a scanner but which does not photocopy. For example, the symbol may be a statue of a human with eleven toes rather than ten, or a sunburst missing two of the expected sunburst rays. Any fraudulent photocopy of the original may not reproduce that symbol correctly with the attribute intact.

Furthermore, the ticket can be printed with a photocopy-sensitive ink so that any attempt to produce a fraudulent copy would destroy the inks of the original thereby not only preventing copying but also destroying the value of the original.

One aspect of the present invention is also extends to a networked terminal for validating an issued value document, the terminal comprising: a display screen for presenting information to the user; a data input interface for enabling user input of input data; a first scanner for scanning an issued value document to generate value document data; a second scanner for scanning a machine-readable identity item verifying the identity of the user to generate user identification data; a processor for collating user input data, the value document data and the user identification data into an authentication request message; and a communication means for transmitting the authentication request to a central server.

Also another aspect of the present invention is directed to a method of creating a uniquely identifiable value document on one of a plurality of networked low-cost data processing terminals, the method comprising: obtaining a unique terminal identifier of the data processing terminal; using a unique terminal identifier of the data processing terminal as a first part of a serial identifier; obtaining a second part of the serial identifier created by use of a number generating process; combining the first and second parts of the serial identifier to generate the serial identifier of the value document; and printing the serial identifier on the value document.

### BRIEF DESCRIPTION OF THE DRAWINGS

Embodiments of the present invention are now described with reference to the accompanying drawings in which:

FIG. 1 is a schematic diagram of traditional prior art banknote printing process;

FIG. 2 is a schematic diagram, illustrating how a security feature may be added to a flexible substrate, such as paper-based financial instruments, in accordance with an embodiment of the present invention;

FIG. 2a is a schematic diagram, illustrating a system in accordance with a preferred embodiment of the present invention, wherein a validation code is ablated onto an electromagnetic-sensitive inks strip using a laser;

FIG. 3 is a process flow chart outlining the preferred method used in accordance with an embodiment of the present invention;

FIG. 4a is an example of a lottery ticket featuring a security feature ablated on a single ink layer, in accordance with the present invention;

FIG. 4b is an example of a lottery ticket featuring a security feature ablated on a dual ink layer, in accordance with the present invention;

FIG. 5 is a schematic diagram showing a value document having both a validation identifier and a serial identifier being irradiated with laser light to enable machine reading of the validation identifier from the ablated electromagnetic-sensitive ink strip;

FIG. 5a is a schematic block diagram of the distributed system for validating a value document according to an embodiment of the present invention;

FIG. 6 is a process flow chart outlining a method of securely validating a lottery ticket, featuring an ablated electromagnetic ink strip, in accordance with the present invention;

FIGS. 6a, 6b, and 6c are process flow charts illustrating alternative methods of validating a lottery ticket in accordance with alternative embodiments of the present invention;

FIG. 7 is a cross-sectional view of a three-layer ink strip printed on a flexible substrate of the Value Document in accordance with another embodiment of the present invention;

FIGS. 8a and 8b are a cross-sectional view of a two-layer ink strip printed on a flexible substrate of the Value Document showing the two stages of recording information in the ink layer of the value document in accordance with another embodiment of the present invention;

FIG. 9 is a schematic cross-sectional view of a first printing arrangement including a single rotary drum print head according to an embodiment of the present invention;

FIG. 10a is a schematic cross-sectional view of a second printing arrangement including a multiple rotary drum print head comprising annular rotatable stencils for use in creating exposed regions of an ink layer in a value document according to another embodiment of the present invention;

FIG. 10b is a schematic perspective view of the rotary drum print head of FIG. 10a;

FIG. 11a is a schematic cross-sectional view of a third printing arrangement including a non-permanent LCD stencil exposure head for use in creating exposed regions of an ink layer in a value document according to another embodiment of the present invention;

FIG. 11b is a schematic plan view of the single high-resolution LCD of the non-permanent LCD stencil exposure head of FIG. 11a;

FIGS. 12a, 12b and 12c are sectional views of a value document showing the different stages of creating exposed regions of an ink layer in the value document in accordance with another embodiment of the present invention;

FIG. 13a is a plan view of a graphical serial number template from which a particular serial number is defined according to another embodiment of the present invention;

FIG. 13b is the graphical serial number template of FIG. 13a with the numbers obscured by a covering layer in at least the vicinity of the numbers;

FIG. 13c the graphical serial number template of FIG. 13b showing specific areas of the covering layer which have been removed together with linking lines revealing the serial number to be used;

FIG. 14a is a plan view of a graphical serial number template using concentric rings from which a particular serial number is defined according to another embodiment of the present invention;

FIG. 14b is the graphical serial number template of FIG. 14a with the numbers obscured by a covering layer in at least the vicinity of the numbers;

FIG. 14c the graphical serial number template of FIG. 14b showing specific areas of the covering layer which have been removed together revealing the serial number to be used;

FIG. 14d is a plan view of an image overprinted on the graphical serial number template of FIG. 14a using concentric rings from which a particular serial number is defined according to another embodiment of the present invention;

FIG. 14e is a plan view of the overprinted image on the graphical serial number template of FIG. 14d showing a particular serial number is created in combination with an overprinted image;

FIG. 14f is a plan view of the overprinted image on the graphical serial number template of FIG. 14d showing a set of registration marks for alignment of the laser with the underlying graphical template;

FIG. 15 is a schematic diagram showing a distributed networked system having terminals in different countries/regions and a central server, according to an embodiment of the present invention;

FIG. 16 is a schematic block showing the features of a remote terminal shown in FIG. 15;

FIG. 17 is a schematic block diagram showing a distributed networked system including servers and splitters used for validating the identity of a person according to an embodiment of the present invention;

FIG. 18a is a schematic plan view of a first value document produced according to an embodiment of the present invention;

FIG. 18b is a schematic longitudinal section through the value document shown in FIG. 18a;

FIG. 19a is a schematic plan view of a second value document produced according to an embodiment of the present invention;

FIG. 19b is a schematic longitudinal section through the value document shown in FIG. 19a;

FIG. 20a is a schematic plan view of a third value document produced according to an embodiment of the present invention;

FIG. 20b is a schematic longitudinal section through the value document shown in FIG. 20a;

FIG. 21 is a schematic diagram showing the elements of a low-cost printing apparatus used to produce the value document of FIG. 20a;

FIG. 22 is a schematic block diagram of an authentication system for use with the value document of any of FIG. 18a, 19a or 20a;

FIG. 23 is a schematic block diagram of a new manual data input ticket for a prize-draw/lottery;

FIG. 24 is a schematic front view of a ticket registration terminal; and

FIG. 25 is a schematic block diagram of a new type of value document.

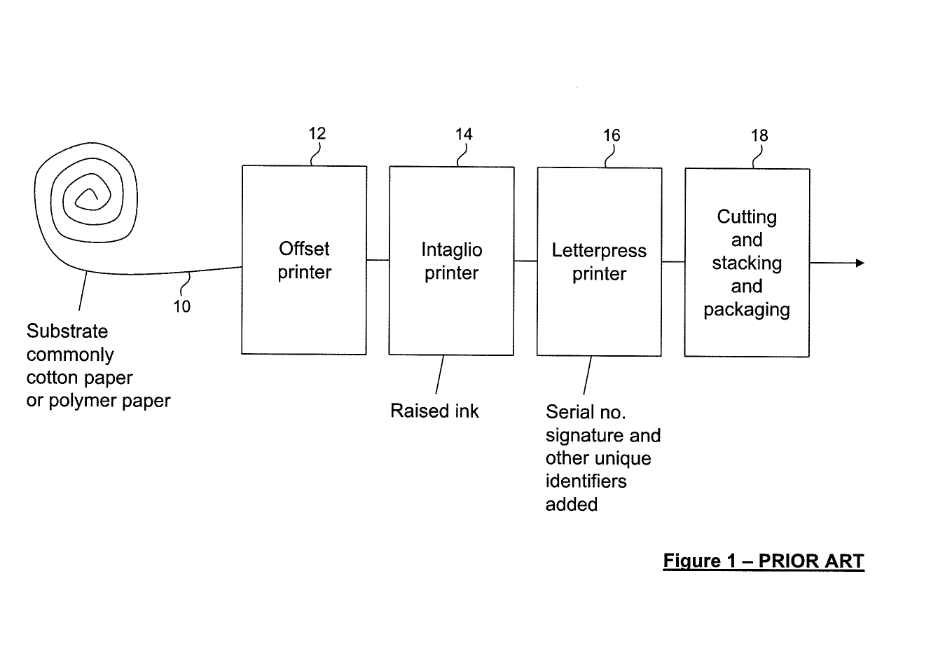

### DETAILED DESCRIPTION OF PREFERRED EMBODIMENTS

The term ‘value document’ as used herein is to be interpreted broadly and covers any type printed value item and covers items such as banknotes, bonds, vouchers, coupons, financial instruments or financial records or receipts with an intrinsic value and tickets of all descriptions including, but not exclusively lottery tickets.

The skilled addressee will appreciate that all ensuing references to ‘EM-sensitive ink strip’ refer to ink strips which are sensitive to specific bandwidths of light. The terms electromagnetic radiation and light may be used interchangeably, and in general electromagnetic radiation is used to refer to any wavelength and/or frequency of light. All references to wavelengths visible to the naked eye will be specifically referred to as such.

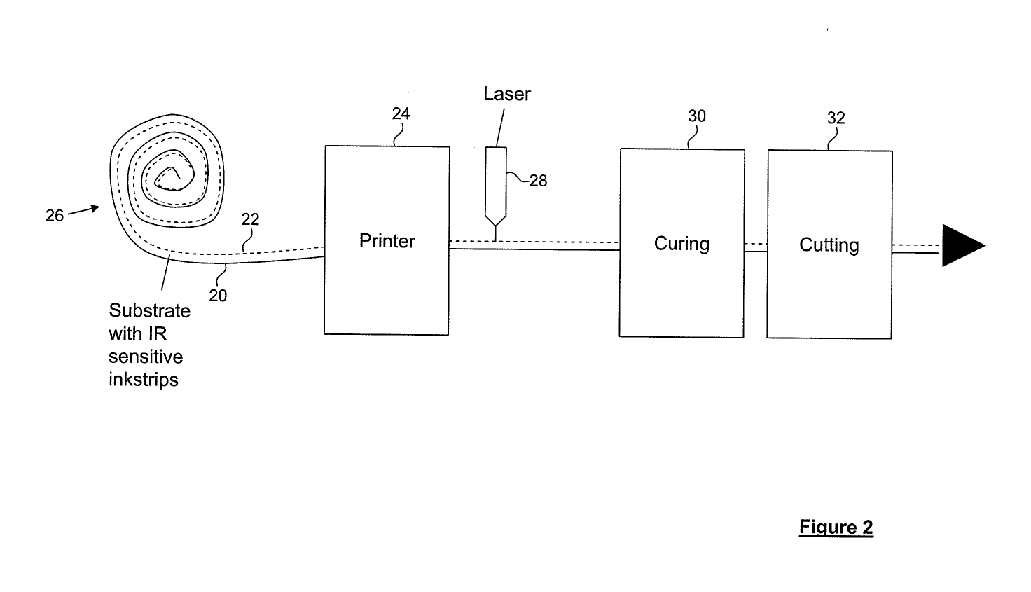

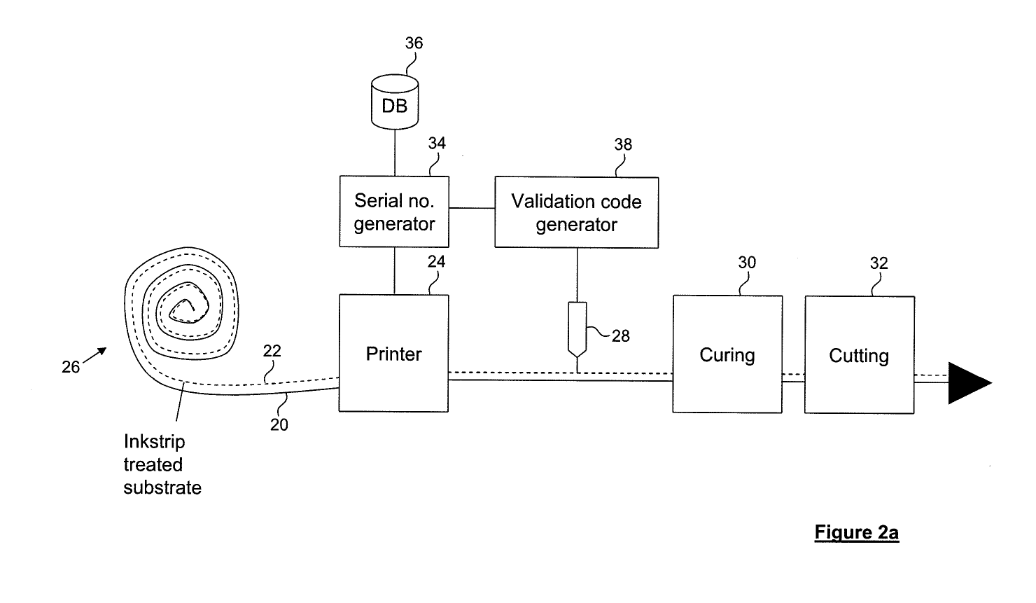

FIG. 2 is an outline of a preferred embodiment of the system and method of the present invention, and illustrates how a security feature may be added at low cost to a flexible substrate, such as a ticket of a paper-based financial instruments/value documents. A substrate 20, containing prepared EM-sensitive ink strips 22 is fed through a printer 24. The substrate 20 may be provided on a roll 26 as shown in FIG. 2 or alternatively as a stack of cut sheets (not shown) each having the ink strips 22 provided thereon which are then individually fed into the printer 24. The ink strips 22 are sensitive to specific wavelengths of electromagnetic radiation, and are preferably printed or attached on the substrate 20 at the point of manufacture. The substrate 20 is fed to the printer 24 where the required image is printed on the surface of the substrate 20. A security feature can be added to the substrate by ablating a selected verifiable design, or alphanumeric code on the prepared ink strip, with a high-intensity, substantially monochromatic electromagnetic radiation source, such as a laser 28. The operational bandwidth, or equivalently the operational wavelength of the high-intensity electromagnetic radiation source is selected in accordance with the sensitivity characteristics of the EM-sensitive ink strip 22. The ablated ink strip is then cured at a curing station 30 to protect against further fraudulent ablation of the EM-sensitive ink strip.

Curing of the EM-sensitive ink strip 22 prevents tampering of the ablated ink strip. Once the EM-sensitive ink strip is cured, it is no longer sensitive to high-intensity incident electromagnetic radiation, such as produced by a laser. Curing of the EM-sensitive ink strip may either relate to covering the ablated ink strip with an EM-resistant coating, or it may relate to a chemical substance which reacts with the EM-sensitive ink strip, thereby changing the properties of the ink strip. Such materials/substances are not described further as they will be known to the skilled person.

However, it is to be appreciated that curing of the ablated ink strip 22 is not always necessary. Curing is primarily required in those embodiments where further fraudulent ablation of the EM-sensitive ink strip may not be detectable. For example, in embodiments where either an alphanumeric or a numerical code is ablated on the EM-sensitive ink strip using a non-adjustable font, curing of the ink strip may not be required. A non-adjustable font relates to any font where it is not possible to make a first character appear as a different character, by simple manipulation of the first character. Cursive fonts are an example of non-adjustable fonts. No cursive alphanumeric character may be easily manipulated to appear as another alphanumeric character. LED/LCD style fonts are fairly simple to manipulate, since each alphanumeric character is represented by a different combination of straight lines. Accordingly, it is not possible to manipulate alphanumeric characters printed in non-adjustable fonts, without such modifications being readily identifiable. Furthermore, since the present embodiment involves ablating a validation code on an EM-sensitive ink strip 22, a fraudulent user's actions are restricted to manipulating any existing character within the validation code, by addition of features, and never by removal. Where non-adjustable fonts are employed, curing of the ablated EM-sensitive ink strip adds only a further layer of security, and may be dispensed with if required.

Reverting to the example depicted in FIG. 2, once the EM-sensitive ink strip 22 has been cured, the financial instruments are cut at a cutting station 32 into individual instruments (not shown).

The present method may be incorporated into any existing financial instrument printing process, as long as an EM-sensitive ink strip is provided on the printable substrate, and the process incorporates a laser, or other high-intensity electromagnetic radiation source, and optionally a curing step, into the printing process. The relative low cost of the required hardware makes the present method suitable for ‘on-site’ printing applications, for example in terminals (such as lottery terminals, ATM's and/or cash registers and/or automated dispensers) located at distribution points, such as kiosks, supermarkets, banks, and any other location where the relevant financial instruments/value documents are distributed, with minimal modification of the existing terminals being required.

FIG. 2a illustrates a preferred embodiment wherein the EM-sensitive ink strip 22 is inexpensively ablated with a validation number, or alphanumeric code, on the basis of an existing serial number printed on the financial instrument. Henceforth all references in this description to alphanumeric validation code will comprise any numerical and/or alphanumeric code or feature, ablated on the EM-sensitive ink strip. Similarly to FIG. 2, the substrate 20 may be provided on a roll 26 or alternatively as a stack of cut sheets (not shown) each having the ink strips 22 provided thereon which are then individually fed into the printer 24.

In contrast to the embodiment illustrated in FIG. 2, in the present embodiment the printer 24 also prints a unique identifier, or equivalently a serial number which may be used to track and identify individual financial instruments/value documents. The serial number is generated by a serial number generator 34, which is either local to the printing terminal, or remotely located, and in communication via a shared communications channel. Each generated serial number is printed on a part of the substrate 20 that is to become an individual value document. In preferred embodiments, the serial number is stored in a database 36 for reference. However, ultimately whether the generated serial numbers are stored in a centrally located or a locally accessible database is dependent on the validation method employed (discussed below). In those embodiments requiring a central serial number database, the database is preferably remotely located, and in communication with the printing terminal via a shared communication channel. Preferably, the database 36 provides a central repository for all serial numbers generated by the one or more remotely located printing terminals. The aforementioned shared communication channel may feature a shared communications network such as the internet, or any other communication channel and/or network allowing the transfer of data between remotely located end points. It may also be that the serial number is reproduced on the value document by exposing the EM sensitive ink strip 22 to a laser and/or light and/or electromagnetic radiation source so that a second colour-shifting ink is exposed in the relevant section allowing the serial number to be reproduced with a ‘secure’ colour-shifting ink.

In accordance with the present embodiment, the ablated security feature may relate to a validation symbol and/or alphanumeric code, which is generated by a validation code generator 38, and ablated onto the EM-sensitive ink strip 22 with the laser 28 as previously described. In certain embodiments the validation code may be algorithmically related to the printed serial number, thereby providing a further authentication/verification means.

Following ablation, the EM-sensitive ink strip 22 is optionally cured as previously described, and finally the substrate 20 is cut into individual financial instruments for distribution.

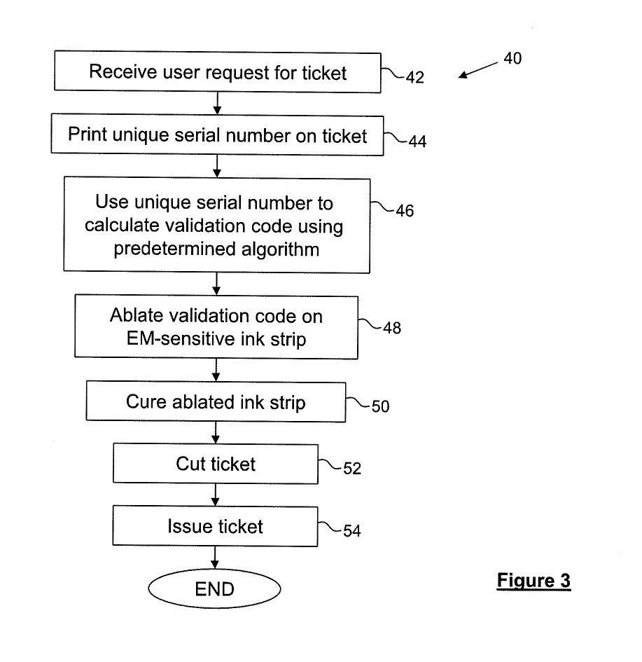

FIG. 3 is a process flow chart outlining a printing process 40 which determines how a lottery ticket may be printed at a local ‘in-store’ terminal and/or ATM and/or cash register, in accordance with an embodiment of the method and system of the present invention. In the current embodiment, the ‘in-store’ terminal is configured to print lottery tickets in accordance with the printing terminal of FIG. 2a. Furthermore, it is to be appreciated that the outlined method may be used for printing on any value document having a flexible substrate, such as a ticket or paper-based financial instrument, and the illustrated embodiment is not limited to lottery tickets.

The issuing process, or equivalently the lottery ticket printing process 40 is initiated at Step 42 by a user request for a lottery ticket, received on the ‘in-store’ terminal located at a dispatch location such as in a supermarket, at a kiosk, or at a bank. The ‘in-store’ terminal will contain a substrate 20, which may be thermographic paper, comprising pre-printed EM-sensitive ink strips 22. Upon receiving the user request, a unique serial number is printed at step 44 on the substrate 20, which is either generated locally or remotely to the terminal by the serial number generator 34. The unique serial number is used at Step 46 to generate a validation code using a predetermined algorithm. The terminal comprises a local data store for temporary storing of the serial number, which is subsequently used for validation number generation. The validation number is subsequently ablated at step 48 on the EM-sensitive ink strip 22 and is cured at step 50 to help prevent any further tampering of the ink strip 22. Following curing, the prepared ticket is cut at step 52 and issued at step 54.

All printed serial numbers are preferably stored in a centrally accessible database 36 for use during validation code generation at step 46, and optionally during the validation of the issued lottery ticket. Alternatively, the validation codes may be stored along with the serial numbers, such that validation comprises verifying that the correct one or more serial numbers are matched to the correct validation code. Such an embodiment requires that both validation codes and serial numbers are stored in an accessible database for subsequent redemption.

In yet a further alternative embodiment, neither serial number nor validation numbers require long-term storing. Rather, validation may simply consist in verifying that the ablated validation number corresponds to the printed serial number. This may be achieved by applying the predetermined algorithm to the printed serial number, and verifying that the determined validation code corresponds to the ablated validation code appearing on the ticket. Such an embodiment does not require maintaining a database of issued serial numbers, and may be preferable in situations where it is impractical to provide a remote network connection to a central database for validation, or where no shared communication channel exists between a local terminal and a remotely located central database. It can also be that such partly unregistered numbers are given extra security by an ablating or ‘stripping back’ process akin to a reverse stencil ‘exposing’ the colour-shifting ink underneath which has the same comparison validation process.

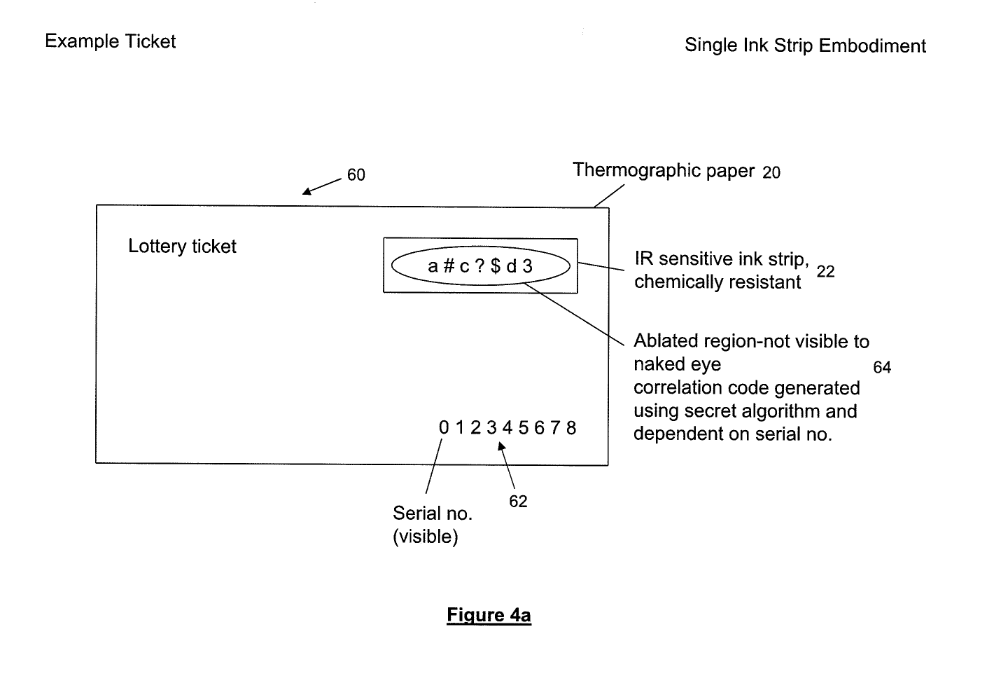

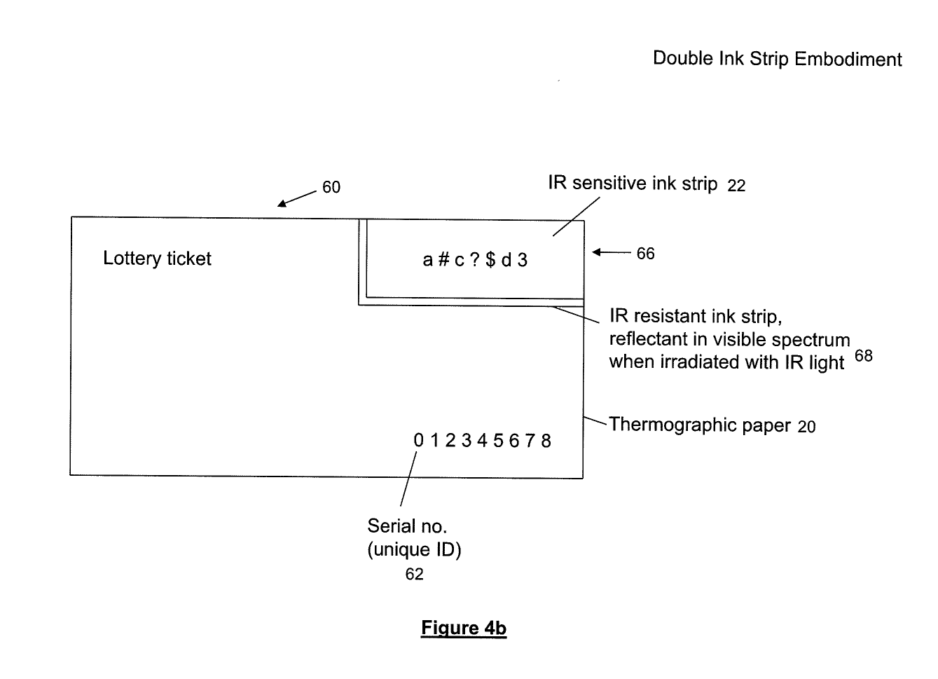

FIGS. 4a and 4b illustrate examples of financial instruments/value documents printed in accordance with the method and system of the present invention. In the illustrated examples, the value document relates to a lottery ticket 60. However, the skilled addressee will appreciate that the present method and system may equally be incorporated into banknote production, or any other value document/financial instrument production process.

FIG. 4a illustrates a lottery ticket 60 comprising a single ablated EM-sensitive ink strip 22, produced in accordance with the method and system of the present invention. Due to the relative low cost of thermographic paper when compared to cotton and/or rag based paper and other popular substrates used in banknote production, it is the preferred substrate 20 for use in the manufacture of lottery tickets and other low-value financial instruments. A serial number 62, along with all other images (not shown) printed on the substrate 20, are printed using a thermographic printer. The printed serial number 62 is visible to the naked eye, whereas an ablated validation code 64 is not visible to the naked eye in the absence of an incident fixed-wavelength-range illumination source, such as a fixed-wavelength-range lamp, emitting electromagnetic radiation having a fixed range wavelengths. In certain embodiments, the EM-sensitive ink strip 22 itself may be invisible to the naked eye.

The choice of laser 28 used for ablation, is selected on the basis of the electromagnetic sensitivities of the ink strip. For example, chemical resistant inks which are sensitive to infrared radiation may be used, in which case an infrared laser, such as a $300 Diode Infrared laser operating at 808 nm or 908 nm, is used for ablation. In embodiments where ultraviolet sensitive inks are used, a laser operating in the ultraviolet band of the light spectrum, such as a $500 pulsed nitrogen laser operating at 337 nm, is used for ablation. The skilled addressee will appreciate that any type of EM-sensitive ink may be used in conjunction with the present invention, and that the choice of ablating laser is selected on the basis of the particular optical wavelengths, and/or alternatively frequencies the selected ink strip is sensitive to.

In addition, the use of a pre-printed EM-sensitive (electromagnetic-sensitive) ink as a covering to affect the exposing of a colour-shifting ink after ablation may be desirable to create a stencil effect. This is by means of ablating a covered surface of an EM-sensitive ink strip 22 in a controlled manner so that subsequent attempts at tampering may be discernable at a later point. In this embodiment, batches of concealed numerals waiting to be uncovered in the correct order to produce the correct serial number are present in hidden areas known only to the electronic and/or mechanical controlling system (this is described in detail later). Therefore attempts to uncover a serial number will cause wrong entries indicating tampering. Colour-shifting inks already exist but are too expensive and technically difficult to be printed at a point-of-sale terminal or highly-distributed point-of-issue systems such as ATMs, cash registers and lottery terminals etc. However, the use of a pre-printed ink strip 22 in which the desired information is created by laser action solves this issue.

FIG. 4b illustrates an alternative embodiment of a lottery ticket including a dual-layer ink strip 66, comprising two different types of ink printed on top of each other. The first layer, which resides on the substrate is an EM-resistant ink layer 68. The second layer, which is printed on top of the first layer, is EM-sensitive ink strip layer 22. Ablating the second layer 22 with the required alphanumeric code and/or design creates a stencil, and has no effect on the first EM-resistant layer 68. When the ablated dual-layer ink strip 66 is illuminated with the required incident electromagnetic radiation, a portion of the incident light will either be absorbed or reflected by the second, EM-sensitive layer 22, whilst the portion of the incident light which is incident on the ablated regions of the EM-sensitive ink layer 22, will be reflected by the first, EM-resistant layer 68. Effectively the reflectance spectrum may be considered as comprising two distinguishable components namely, the reflectance component reflected from the EM-sensitive layer, and the component reflected from the EM-resistant layer. Preferably, the two ink layers 22, 68 are selected to maximise the distinguishability of the reflectance spectra, thereby allowing the ablated verification code and/or design to be determined from analysis of the reflectance spectrum.

To facilitate distinguishing between the two reflectance spectra, the first EM-resistant layer 68 may be selected to have a number of verifiable optical characteristics. For example, the first layer 68 may be selected to have colour-shifting characteristics, wherein the perceived colour is dependent on the illuminating electromagnetic radiation, and the viewing angle. Equally, the first ink layer 22 may be selected to have holographic optical properties. Any number of inks with different optical properties may be selected for use in the dual-layer embodiment. For example, both ink layers may not reflect light in the visible spectrum, and verification would only be possible using appropriate instrumentation viewing in the non-visible spectrum. Alternatively, the EM-resistant layer 68, may be selected on the basis of its reflectance spectrum. For example, selecting an EM-resistant ink layer 68 having a visible reflectance spectrum, wherein reflected light is in the visible spectrum, obviates the need for specialised instrumentation. Naturally, the reflectance spectrum will be partly dependent on the illuminating wavelength and such considerations are taken into account when selecting the type of ink layer to use. The ink layer 22 can be ‘embedded’ also in a metallic and/or plastic and/or polymer thread which then ‘conceal’ the ink to the human and/or mechanical and/or electronic eye and only become ‘visible’ after the exposure of the thread to ablating effect of the EM source (laser 28 in this embodiment). The effect can be manipulated to give the appearance of the ink feature being a symbol and/or a shape and/or a number having been printed ‘inside’ the plastic or metallic or polymer feature thus generating a ‘ship in the bottle’ illusion.

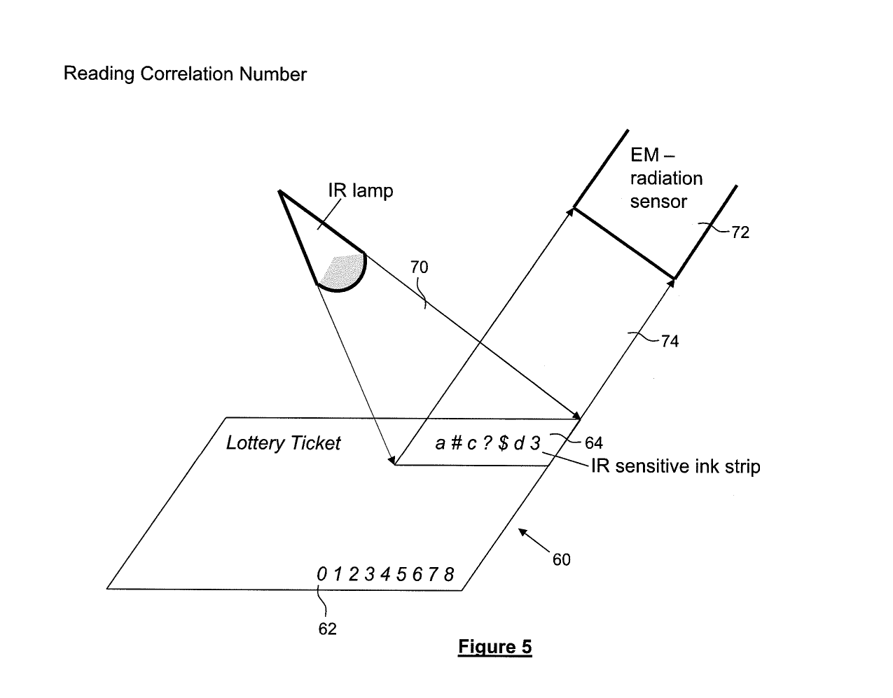

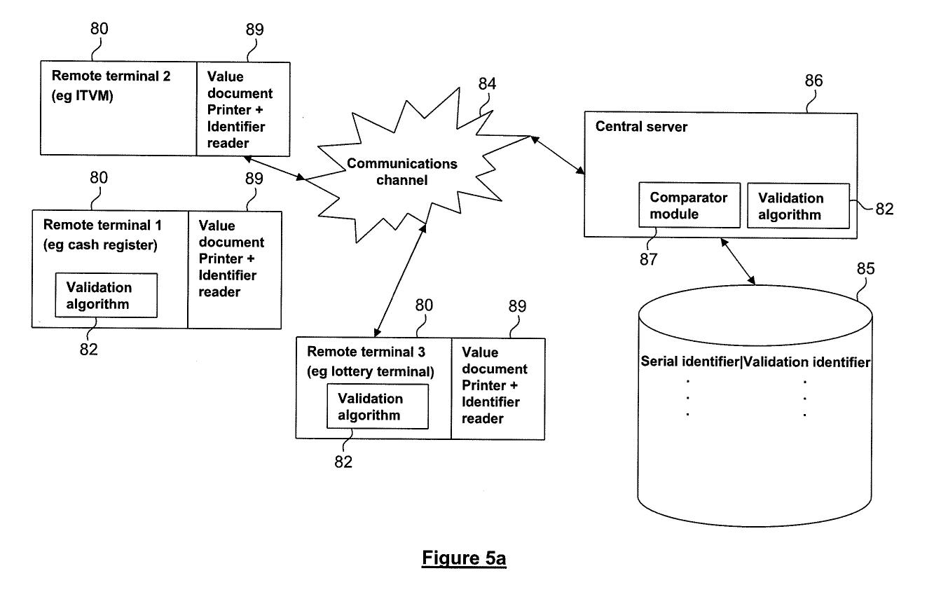

FIG. 5 illustrates how a lottery ticket (or any value document) may be validated in accordance with one embodiment of the present invention. The ablated EM-sensitive ink strip 22 is illuminated with electromagnetic radiation 70, and the reflectance spectrum analysed using an EM radiation sensor 72. The reflectance spectrum of the reflected electromagnetic radiation 74, reflected from the ablated regions 64 will be distinguishable from the reflectance spectrum of the electromagnetic radiation 74 reflected from the ink strip 22. Accordingly, the ablated alphanumeric validation code and/or design 64 is derivable from analysis of the reflectance spectrum. As mentioned previously, in certain embodiments verification may be carried out with the naked eye. However, this will be dependent on the selected EM-sensitive ink, and its optical properties. The skilled addressee will appreciate that validation may be carried out with the naked eye where the wavelength and/or frequency of the reflectance spectrum lies in the visible domain namely, where the wavelength of the reflected light lies in the approximate range 400 nm to 700 nm.

The ablated alphanumeric validation code and/or design 64 is determined by analysis of the reflectance spectrum of the ablated EM-sensitive ink strip 22. To complete verification, the authenticity of the alphanumeric validation code and/or design needs to be validated. This is described briefly below.

Several different validation processes may be used in conjunction with the present embodiments of the present invention and these are set out below.

In a first embodiment, where the alphanumeric validation code 64 is algorithmically associated with a serial number (serial identifier) 62, validation may also include a step whereby the serial number 62 and the determined validation code (validation identifier) 64 are reconciled.

Reconciliation involves determining whether the ablated validation code 64 is correctly related, via a validation algorithm, to the printed serial number 62. This may be determined in one of two different ways: either an inverse algorithm is applied to the determined validation code 64 to obtain a comparison serial number, which is then compared to the printed serial number 62 and any deviations are indicative of counterfeit value documents or of tampering; or the algorithm is applied to the printed serial number 62 and the ensuing calculated validation code is compared to the ablated validation code 64 appearing on the EM-sensitive ink strip 22, and any deviation between the two validation codes is indicative of either a counterfeit or tampered value document.

In such an embodiment as shown in FIG. 5a, a remote terminal 80 seeking the validation requires access to a validation algorithm 82 used to generate the validation code 64. The algorithm 80 may either be stored locally on each terminal (see terminal 1) 80, or where the terminals 80 have access to a communications channel 84 as shown in FIG. 5a, the validation algorithm 80 may be stored remotely in a database 85 of a central server 86 and be accessible to the remote terminal 80 for use during validation (see terminal 2). Once the determined validation identifier or the determined serial identifier have been obtained, a comparator module 87 is provided at the server 86 to compare them with the read serial number 62 and the validation code 64, to determine if there is a match. Such an embodiment does not necessitate maintaining the centrally accessible database 85 for reference, and the validation algorithm 82 may optionally be encoded in firmware. Each terminal also has a reader (scanner) 89 for reading the serial and validation identifiers, and optionally a value document printer where the terminal is also to be used for issuing value documents.

In a second embodiment also shown in FIG. 5a, validation of the value document may comprise cross-referencing the read serial number (serial identifier) 62 and the validation code (validation identifier) 64 appearing on the value document 60 with serial numbers and validation codes stored on the centrally located database 85. The terminal 80 seeking validation relays the observed serial number-validation code pair to the central server 86 and awaits confirmation of authenticity. Such a validation system requires each terminal 80 to be networked, and to have access to the centrally located database 85. Furthermore, the centrally located database 85 needs to be up-to-date and maintained with all issued serial numbers 62 and validation codes 64. Accordingly, such an embodiment is only possible where existing infrastructure can support the required networked terminal configuration.

In yet a further embodiment, validation may comprise both aforementioned methods. In a first step, the networked terminal (see terminal 3) 80 having access to the required validation algorithm 82, determines the validation code from the printed serial number 62 appearing on the value document 60. Provided that the calculated validation code positively matches the ablated validation code 64, the validation process proceeds to the second step, where the printed serial number 62 and/or the ablated validation code 64 are cross-referenced via the central server 86 to a centrally located database 85 of all issued serial numbers and/or validation numbers. Such a validation method provides the greatest level of security, since even if the validation algorithm 82 used to generate the validation codes is compromised, cross-referencing with a centrally located database 85 will identify all fraudulent value documents 60.

Validation can also just be the comparison of a few elements of the validation identifier being the same as a set of valid elements provided by the validation algorithm. These may be displayed as a set of numbers inside a visual effect of the validation identifier.

As mentioned previously in the above discussion of FIG. 5, the verification process may be automated at the point of sale and/or point of issue of the value documents and will include lottery terminals and/or ATMs and/or cash registers. In such embodiments, it is envisaged that devices similar to existing bar-code scanners may be used for verification purposes. The frequency of the incident electromagnetic radiation is selected on the basis of the optical characteristics of the selected EM-sensitive ink type.

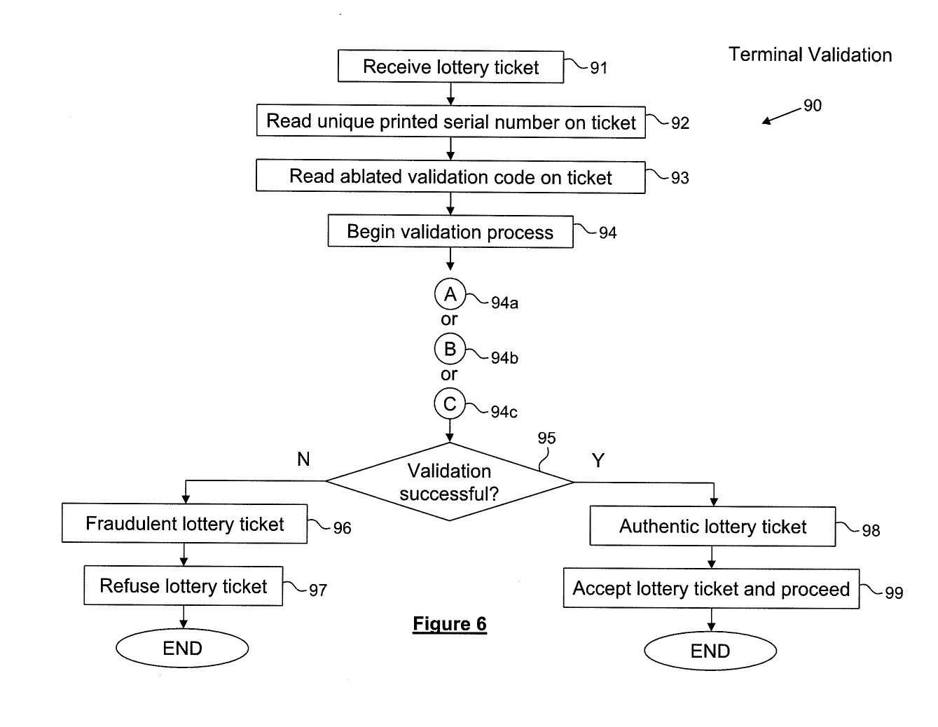

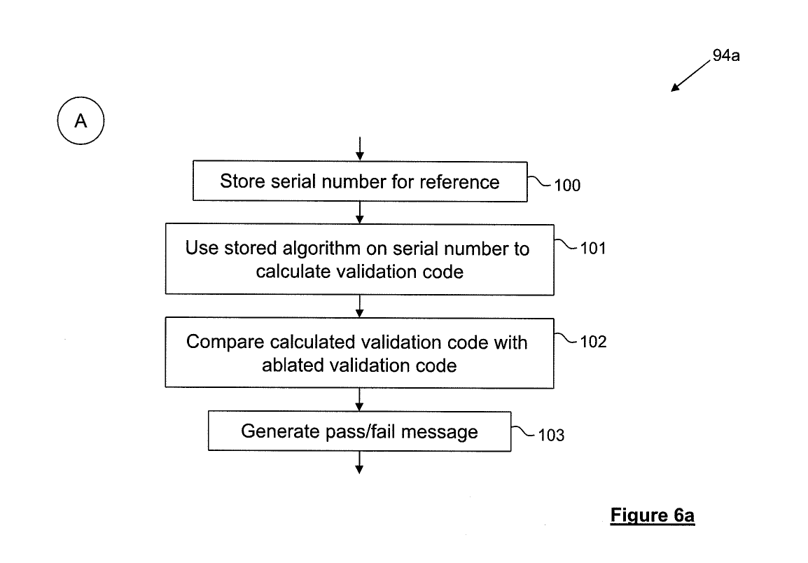

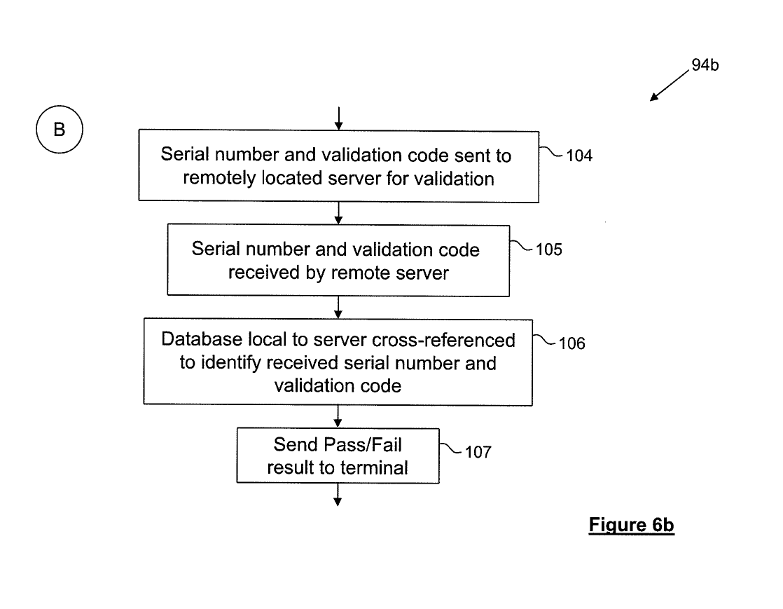

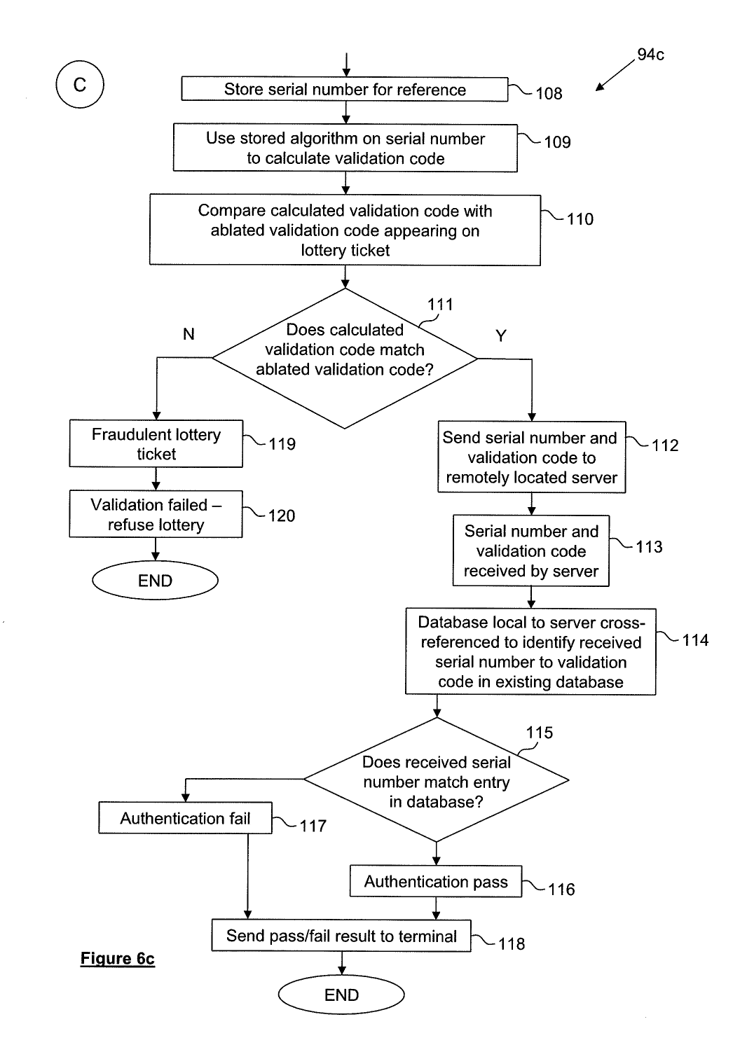

FIG. 6 is a process flow chart, outlining the different steps in a validation process 90 for validating a lottery ticket 60 in accordance with the present embodiment. However, it is to be appreciated that the outlined process may equally be used for validation of any type of value documents e.g. banknotes, cheques, premium bonds and all forms of value documents including registers of legal processes and/or legal title changes etc.

The process 90 commences with, the relevant lottery ticket, such as a lottery ticket illustrated in FIGS. 4a and/or 4b, being received at step 91 for validation. The serial number is read at Step 92. The validation number is read at step 93 by illuminating the ablated EM-sensitive ink strip using a light source which emits electromagnetic radiation of a particular wavelength, selected on the basis of the optical properties of the ink strip. For example, where the EM-sensitive ink strip is sensitive to infrared radiation, the validation code may be read by illuminating the ink strip with an infrared lamp.

Then at step 94 the validation process commences. As mentioned previously a plurality of different validation processes may be used at steps 94a, 94b and 94c for verifying the authenticity of the lottery ticket, which are described in turn in FIGS. 6a, 6b, and 6c.

FIG. 6a is a process flow chart illustrating a verification method A at step 94a which requires only that the verification terminal is provided with a verification algorithm 82 used to generate the validation code from the serial number. The observed serial number is stored at step 100 preferably in a local access memory store. The algorithm 82, which is preferably stored local to the verification terminal 80 and configures a processor to carry out the conversion, is used to operate at step 100 on the stored serial number to generate a validation code, which will be referred to as the ‘calculated validation code’ to distinguish it from the ablated validation code 64 appearing on the EM-sensitive ink strip 22 of the lottery ticket 60. The calculated validation code is compared at step 102 to the ablated validation code. Any discrepancy between the codes is indicative of a fraudulent lottery ticket, whereas a match between both codes is indicative of authenticity. The result of the comparison at step 102 is used at step 103 to create a pass/fail message which can be sent back to the remote terminal 80. It is to be appreciated that the current validation process does not require access to a centrally stored database, and validation terminals are not required to be networked, or to have remote access capabilities.

FIG. 6b outlines the verification method B 94b used in accordance with an alternative embodiment. In such an embodiment, each validation terminal 80 is provided with communication channel means 84 for communicating with a remotely located central server 86. The server comprises a centrally located database 85 of all issued lottery ticket serial numbers and/or validation codes. The read serial number 62 and validation code 64 are sent at step 104 to the central server 86 via the shared communication channel 84. Upon receipt at step 105 of both the serial number and validation codes by the server 86, the database 85 is cross-referenced to identify at step 106 the received serial number and validation code. Validation is successful when a positive match between the received serial number and validation code is made with entries stored in the database. Otherwise, validation fails and the lottery ticket is deemed fraudulent. A pass/fail message is sent at step 107 to the terminal 80 from the server 86.

It is to be appreciated that in yet further alternative embodiments, either the serial number or the validation code is sent to the remotely located server for cross-referencing.

FIG. 6c is a flow chart outlining the validation process C carried out at step 94c in yet a further alternative embodiment. The illustrated validation process 94c commences with storing at step 108 of the serial number for reference. Next local calculation of the validation code is carried out at step 109 using a validation algorithm 82 stored locally to the validation terminal 80. subsequently remote cross-referencing of the serial number and ablated validation code with a remotely located database is carried out at step 110. The local calculation of the validation code is compared at step 111 with the ablated validation code appearing on the lottery ticket in a similar manner to the validation process 94a of FIG. 6a. Provided this comparison at step 111 is successful, the serial number and/or the validation code are sent at step 112 to the remotely located server 80 for cross-referencing with a database, as described in FIG. 6b. Once the serial number and/or validation code are received at step 113, the central database 85 is cross-referenced to identify at step 114 the received serial number and validation code. A check for the matching of the received serial number 62 with a corresponding entry in the database 85 is carried out at step 115. A successful verification message is generated at step 116 only when the received serial number and/or validation number is found to match existing entries in the database. Otherwise, a failure message is generated at step 117. regardless of outcome, the results message is then sent at Step 118 to the remote terminal.

If the result of the check at Step 111 is that the calculated validation code and the read validation code 64 do not match, then this is considered at step 119 to be a fraudulent ticket and a validation failed result is generated and sent to the terminal to refuse at step 120 the lottery ticket.

Returning to the description of FIG. 6, the validation process 90 continues at step 95 with a determination of whether the validation process was successful, once a pass/fail message has been received at the terminal 80. A ‘fail’ message results in failed verification and the terminal determining at step 96 that the lottery ticket is fraudulent. Subsequently payout of the required sums to the lottery ticket holder is declined with a refusal of the lottery ticket at step 97. A ‘pass’ message indicates at step 98 that the ticket is authentic and the terminal 80 accepts the ticket at step 99 proceeds with payout of the required sums.

In alternative embodiments of the present invention, the methods described herein may be incorporated into traditional banknote printing processes, wherein an EM-sensitive ink strip is added to the banknote substrate during manufacture, and subsequently ablated with a validation code as described herein, thereby effectively providing an additional security feature to further protect against banknote reproduction and/or tampering. Furthermore, ablated validation codes may be monitored at Automatic Teller Machines (ATM) to identify any fraudulent banknotes prior to dispatch. Additionally, such an embodiment facilitates the identification and removal of fraudulent banknotes from circulation.

It is also envisaged that serial numbers and validation codes may be printed in batches on flexible substrates, such as tickets and paper and/or man-made or man-processed other substance-based value documents, prior to receiving a user request at a terminal. Such an embodiment may expedite issuing times.

The skilled reader will appreciate that whilst a majority of the embodiments described herein, comprise a feature whereby the validation identifier ablated on the pre-printed EM-sensitive ink strip is related to a serial identifier printed on the flexible substrate, it is appreciated that the validation identifier may be related to any feature and/or symbol and/or alphabetic character embedded in the substrate, for example a watermark or other feature. Additionally, the generated validation code may be encrypted. In such alternative embodiments, the validation process will then include a decryption step to read the validation code. Any known encryption method may be used.

In another embodiment, (described in detail later) the validation code which is transmitted to the central server comprises redundant information concatenated to real information. Discerning the real information from the redundant information is conducted using calculation algorithms. Also the association can be through a changing algorithm such that the central server only has to keep a record of the changing factor, not the algorithm itself. This changing factor can itself be random or correspond to a date that is concealed using the processes related to different time relativities. In this incarnation, the date, the serial number and the validation number are printed in the open but are ‘connected’ i.e. associated by an algorithm that changes according to the date but is concealed as the clock is ‘different’.

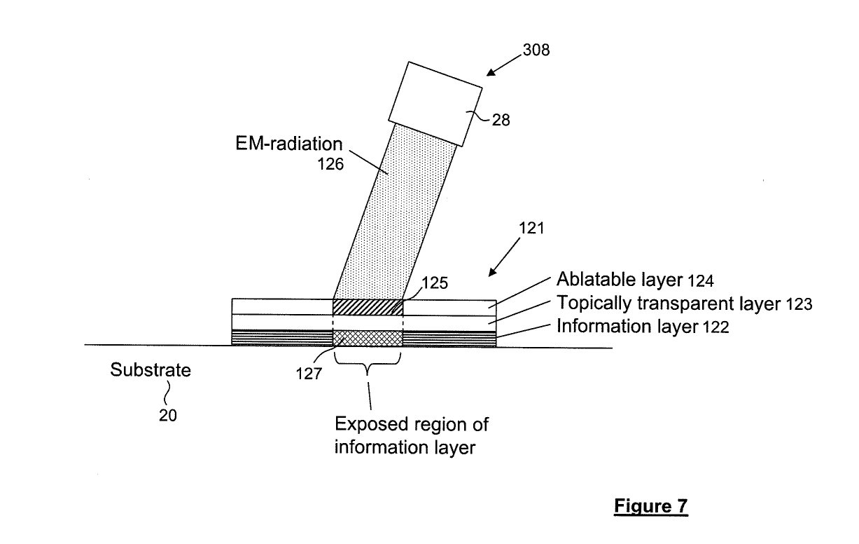

In a further aspect of the present invention, a three-layer ink strip 121 is printed on the flexible substrate of the value document, as illustrated in FIG. 7. The three-layer ink strip 121 comprises an information content layer 122, an optically transparent layer 123, and an ablatable layer 124. The ablatable ink layer 124 is comprised of an EM-sensitive ink. The EM-sensitive ink may be sensitive to a range of wavelengths of incident EM-radiation. Accordingly, the ablatable ink layer 124 is selected to be sensitive to the wavelengths emitted by the laser 28 other present light source. Preferably, irradiated regions 125 of the EM-sensitive ink are vaporised by the incident laser light 126. However, embodiments where the irradiated regions 125 become optically transparent are also envisaged. Whilst the term ‘ablatable’ and ‘ablate’ have been used throughout this specification, it is to be appreciated that the term is also intended to cover the change in optical characteristics of the exposed part of the EM-sensitive ink layer. Accordingly, irradiated regions 125, which become optically transparent, can also be considered to be ablated even though they are not physically removed from the layer.

The information content ink layer 122 may relate to an EM-resistant ink layer, and in certain embodiments may relate to a wavelength-shifting ink layer, which may also be EM-resistant. As with the previously described embodiment, the objective is to ablate a stencil in the ablatable ink layer 124, thereby allowing the information content layer 122 to be viewed through the stencil, when visible light is incident on the ink strip. This stencil effect, whereby the information content layer 122 is viewable through the ablated stencil, may be used to provide a security feature 127, such as a serial number, on the substrate 20 of the value document 60. The security feature is viewable provided that an optical contrast exists between the ablatable ink layer 124 and the uncovered portions 127 of the information content layer 122. In other words, the security feature is viewable provided that the information content layer 122 is distinguishable from the ablatable ink layer 124. The optically transparent ink layer 123, which is sandwiched between the ablatable and information content layers, allows the majority of incident EM-radiation 126 to pass through unobstructed to the information content layer 122, and provides a protective coating to the information content layer 122, without affecting the optical reflection characteristics of the information content layer 122.

The ablatable ink layer 124 may relate to an EM-sensitive colour-shifting ink or optically varying ink (OVI) or optically varying magnetic ink (OVMI), and the information content layer 122 may be replaced with metallic foil, which may optionally feature a holographic image. High-intensity light at a predetermined wavelength, such as provided by a laser, is used to ablate the required stencil on the optically varying ink layer 124. The metallic foil is then viewable through the ablated regions 125 of the optically varying ink layer 124. The use of holographic foil provides an additional level of security, and renders the fraudulent duplication of the security feature more difficult.

Equally, the ablatable ink layer 124 may be provided by an EM-sensitive foil, which may optionally feature a holographic image. In such an embodiment, the stencil is ablated on the EM-sensitive foil, such that an underlying information content layer 122 is viewable through the ablated regions of the foil. The information content layer may be provided by an optically varying ink layer, or any other type of ink, which is insensitive to the high-intensity light. The ink layer may also be provided as a liquid plastic (polymer) containing dye.

Both the information content layer 122 and the ablatable ink layer 124 may relate to colour-shifting ink or OVI or OVMI. The ablatable ink layer is selected to be an EM-sensitive colour-shifting ink or OVI or OVMI, enabling the ablation of a stencil on the layer, whilst the information content layer is selected to be EM-resistant colour-shifting ink or OVI or OVMI. The colour-shifting ink or OVI or OVMI are selected to have contrasting colour characteristics, such that they do not both reflect the same colour at the same angle of reflection. This ensures that the information content layer is always visually distinguishable from the ablatable layer, at any given viewing angle.

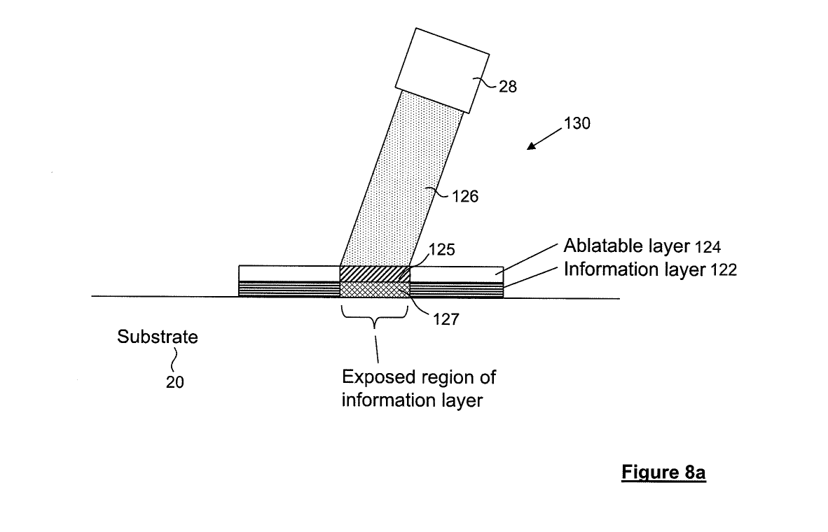

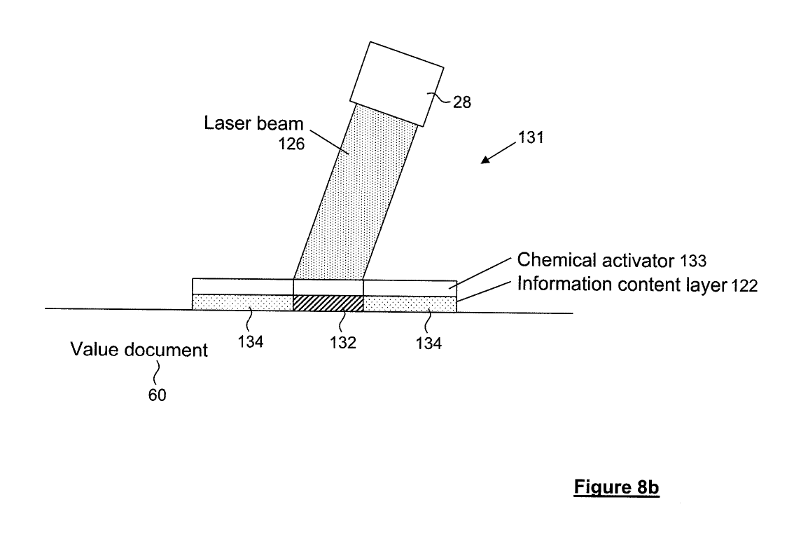

Equally, a two-layer ink strip security feature 130, comprising an information content layer 122 and an ablatable layer 124, printed on the flexible substrate 20 of the value document 60 is envisaged, and is illustrated in FIG. 8a. This alternative embodiment is similar to the embodiment disclosed in FIG. 4b, with the exception that the information content layer 122 comprises a metallic foil, which may optionally feature a holographic image. In accordance with the above described embodiments, the security feature is provided by ablating a stencil onto the ablatable ink layer 124, thereby allowing the ink foil 122 to be viewed through the ablated regions 125 of the ablatable ink layer 124. The ablatable ink layer 124 may relate to any EM-sensitive ink, including an EM-sensitive optically variable ink.

Equally, the information content layer may relate to any EM-resistant ink, including colour-shifting ink or OVI or OVMI selected to have contrasting colour characteristics with the ablatable layer as described for the three-layer ink strip security feature above.

A simpler alternative to the above-described embodiments comprises a single ablatable ink layer printed directly on the substrate of the Financial Instrument/Value Document, similar to the embodiment illustrated in FIG. 4a. The ablatable ink layer 124 may relate to a colour-shifting ink or OVI or OVMI having colour-shifting properties, which are dependent on the viewing angle. The substrate 20 of the value document is viewable through the ablated regions 125 of the ablatable ink layer 124. Similarly, the optical contrast between the colour-shifting ink or OVI or OVMI of the ablatable ink layer 124, and the substrate, allows the security feature to be viewed. This embodiment represents the cheapest, most simple method of providing the security feature on the substrate 20.

Whilst in the aforementioned embodiments the ablation of the ablation ink layer 124 is achieved using a laser 28 emitting electromagnetic radiation having a wavelength within the infrared to X-ray portion of the electromagnetic energy spectrum, the described embodiments may equally be used with alternative light sources.

In accordance with a further aspect of the invention it is envisaged that a maser light source is used in conjunction with the aforementioned embodiments. By maser is intended a substantially monochromatic, coherent light source having a Gaussian intensity profile, and emitting a wavelength within the microwave and/or radio frequency (RF) regions of the electromagnetic energy spectrum. In such embodiments, the ablatable ink layer 124 is selected to be sensitive to microwaves (assuming the maser is emitting microwaves), whilst the information content layer is microwave resistant. In this way, a stencil may be ablated in the ablatable layer 124 in a similar manner to the aforementioned embodiments.

In yet further alternative arrangements of the present invention, silica-based inks and/or gels may be used for respectively one or more of the ablation, transparent, and information content ink layers. Equally, ceramic-based varnishes may be used. As with above-described embodiments, in such alternative arrangements the ablatable layer is sensitive to the EM-radiation emitted by the laser, or other stimulating light source being used for ablation, whilst the information content layer, and when present the transparent layer, are resistant to the incident EM-radiation.

Similarly, alternative embodiments are envisaged where instead of ablating a stencil in the ablation ink layer, a mask is created in the shape of the desired security feature. Such an embodiment 131 is illustrated in FIG. 8b. As in previously described embodiments, a portion of the substrate 20 of the value document is covered with an information content ink layer 122. The selected information content ink layer 122 is sensitive to incident EM-radiation 126. Regions 132 of the information content layer 122 irradiated with EM-radiation 126 undergo a chemical transformation and become inert to a chemical activator 133 the irradiated areas 132 of the information content layer 122 become chemically resistant. Once the desired regions of the information content layer 122 have been irradiated with the EM-radiation, the ink layer, or equivalently the Financial Instrument/Value Document is washed with a chemical activator, which only reacts with the areas of the information content ink layer, which were not irradiated. The chemical activator 133 effectively acts like a solvent, removing all un-irradiated areas 134 of the information content ink layer 122 from the substrate 20. A security feature 132 is left on the substrate of the value document. In such an embodiment, the printing process may involve a further step following the laser irradiation and prior to the curing step, where the ink layers are washed or otherwise covered with or otherwise exposed to the chemical activator agent, and the activator subsequently removed. Alternatively, the ink layers may be exposed by printing or otherwise of the chemical activator which is subsequently removed.

It is to be appreciated that any composition of ink, varnish, or other type of layering material may be used with the present invention, provided that the material selected for the ablatable layer is sensitive to the selected incident EM-radiation, and the information content layer is resistant to the incident EM-radiation. Such alternative arrangements fall within the spirit and scope of the present invention.

Similarly, it is envisaged that any source of EM-radiation 28 may be used for ablation/irradiation with the above-described embodiments, provided that the source is selected such that the emitting wavelength correlates to a wavelength the ablatable ink layer 124 is sensitive to. In practice, it is likely that a minimum lower threshold power must be achieved to ablate the ink layer. Accordingly, various optical apparatus, including lens systems may be required to focus the emitted EM-radiation to obtain the required power. For this reason, and the general desire to minimise the number of components required in the printing apparatus, a laser and/or equivalently a maser is used in preferred embodiments. The laser 28 (and equally the maser) provide a substantially coherent and localised source of high-intensity EM-radiation. The localised Gaussian intensity profile of the emitted laser and/or maser beam makes it suitable for use in ablating only selected regions of the ink layer. The skilled addressee will appreciate however, that the same convenience and ease of use may be achieved with other sources of EM-radiation, when used in conjunction with a suitable lens system. The lens system may be required for the dual purpose of creating a focused beam of emitted light, and for increasing the optical power of the beam.

For example in embodiments where infrared sensitive ink layers are used, an infrared lamp in conjunction with a series of focusing lenses may be used, in place of an infrared laser, to generate a sufficiently high-intensity beam for use in ablating the ablation layer. Equally, other light sources, such as ultraviolet lamps, may be used in a similar manner.

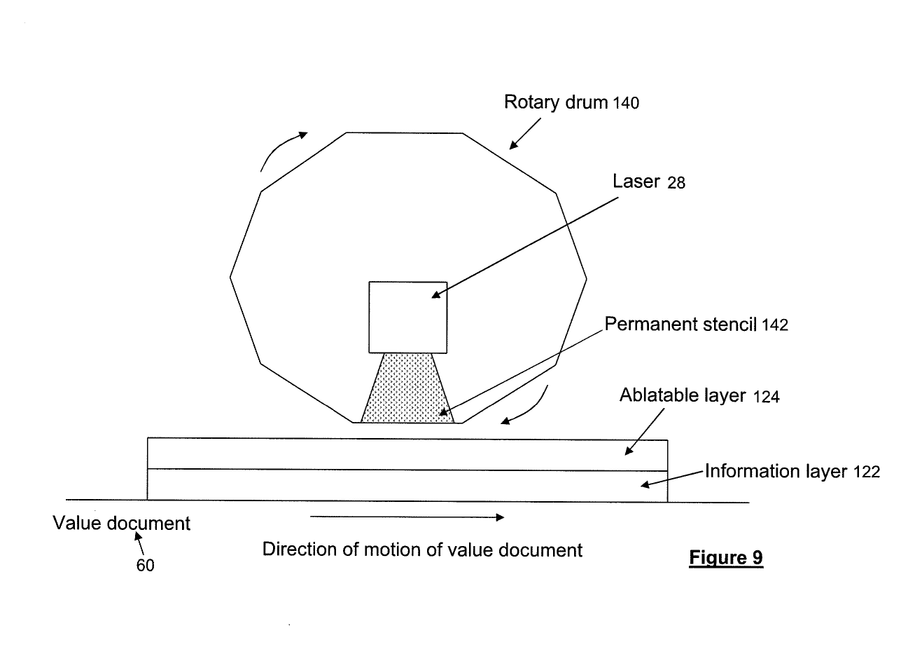

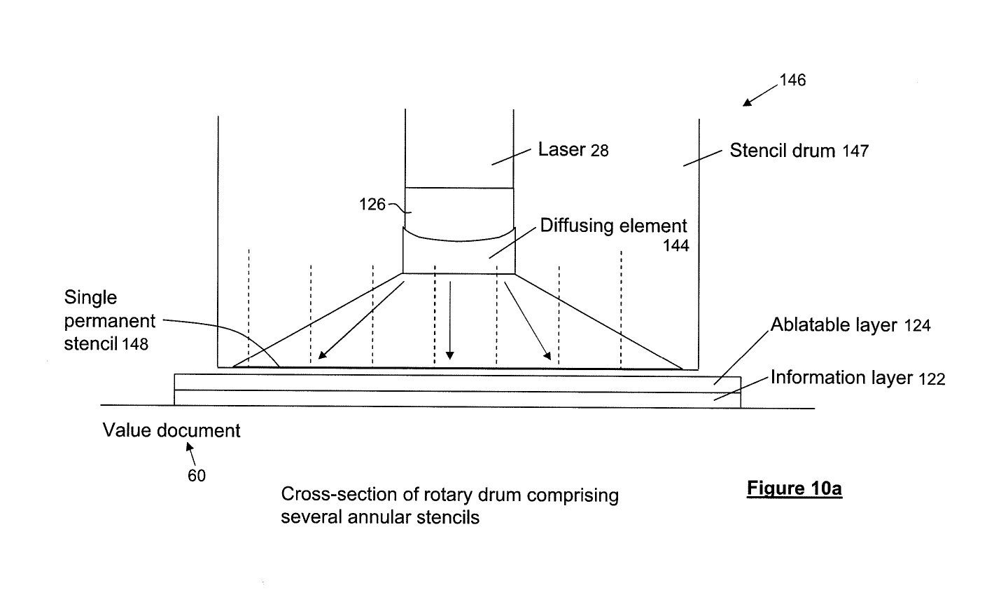

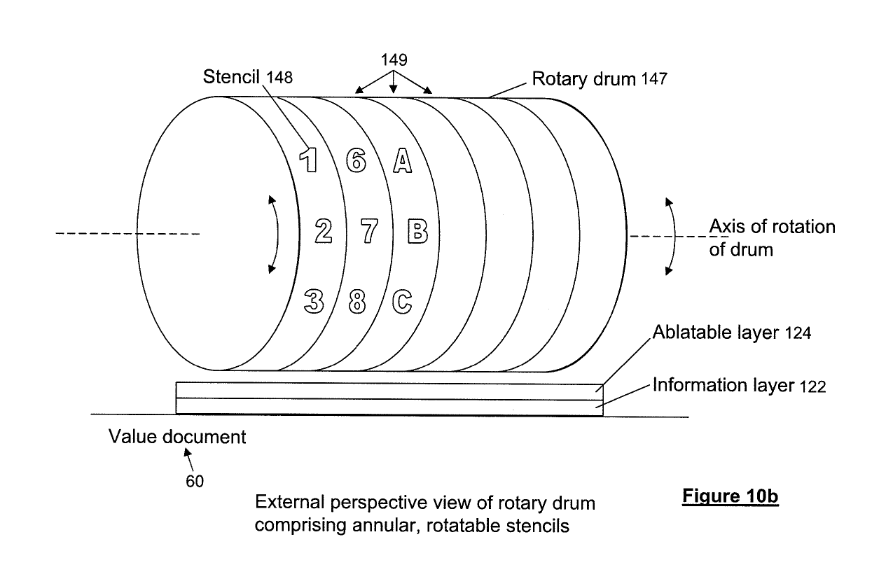

It is also envisaged that the printing apparatus illustrated in FIGS. 2 and 2a comprises a rotary drum 140 as illustrated in FIG. 9. Each face of the drum 140 relates to a different permanent stencil 142. For example, the drum 140 may feature ten faces, each face featuring a permanent stencil 142 relating to a different integer from 0 to 9. The laser 28, such as a laser diode, may be located within the drum 140, such that when the drum 140 is pressed to the surface of the ablatable, EM-sensitive ink layer 124, the area of the ablatable ink layer 124 exposed to the laser light, and subsequently ablated, has the shape of the permanent stencil 142. It is to be appreciated that the drum 140 need not be pressed against the substrate 20 in all embodiments. For example, the drum 140 may be rotated in a non-contact manner but still be positionally very close to the surface of the abatable layer 124 to avoid light diffraction errors occurring. Also the laser 28 need not be provided within the drum 140 itself and could be external with an optical laser radiation conduit conveying the light to the surface of the ink layer. In this manner the desired integer is ablated on the ablatable ink layer 124 without the need for complicated and costly laser beam manipulation arrangements. In the illustrated embodiment, the integers are ablated individually on the EM-sensitive ink layer. Between the ablating of successive integers on the ablatable ink layer 124, the value document 60 is moved horizontally and/or vertically along the press, enabling the rotary drum 140 to be placed above the ablatable ink layer region where the subsequent integer is to be ablated. Alternatively, the value document 60 may remain static and instead the rotary drum 140 and the laser 28 are moved horizontally and/or vertically along the length of the ablatable ink layer strip 22 during the ablating of the security feature. Dependent on the spot size of the laser's radiation beam, an optical diffusing element 144 (an example is shown in FIG. 10a) may be required to enable the entire permanent stencil 142 to be irradiated during the ablation of a single integer. The optical diffusing element 144 increases the cross-sectional area of the laser beam 126, ensuring the entire shape of the stencil 142 is ablated onto the ablatable ink layer. Alternatively, the laser 28 and/or drum 140 may be free to move along the stencil in a simple and predetermined manner.

It is also possible for more complicated drums to be provided. For example a drum 140 having 36 sides, where each side provides a stencil for a number or an alphabetic character, may be used.

FIG. 10a illustrates a cross-sectional view of a rotary stencil drum 146 in accordance with an alternative embodiment. The rotary stencil drum 146 is comprised of several individually rotatable, annular shaped stencils drums 147. Each annular shaped stencil drum 147 features one or more different stencils 148 on its surface. The laser light source 28 (or any other EM-radiation source) is affixed within the stencil drum 147.

FIG. 10a illustrates a single light source 28 affixed within the stencil drum 147. An optically diffusing element 144 is placed in the path of the emitted light 126 to ensure the entire internal surface area of the stencil drum 147 is irradiated simultaneously with the emitted light.

FIG. 10b is a perspective view of the stencil drum illustrated in FIG. 10a. The stencil drum 147 is clearly comprised of several different, individually freely rotatable, annular shaped stencil drums 149. Each stencil drum 147 features several different stencils. Such an arrangement ensures that a variety of different security features may be ablated on the value document. As can be seen numbers or characters can be provided as stencils on each drum 149. Whilst it may be preferable, it is not necessary, to have all of the letters of the alphabet available on a drum 149 and this would be the case in the shown embodiment where the drum only has 10 sides.

The optically diffusing element 144 is optional and is only required where the area of the one or more stencils 148 requiring illumination, is larger than the cross-sectional area of the emitted light beam 126, and where it is not desirable to move the laser along the stencil.

As an alternative, and to obviate the need for using a diffusing optical element, several light sources 28 may be affixed within the stencil drum 147. In this way, the entire stencil area is illuminated simultaneously.

The stencil drum 147 is preferably placed into contact with or is very close to the ablatable ink layer 124 during printing, to minimise diffractive effects resulting from the EM-radiation passing through the stencil. Such diffractive effects are accentuated the further the ablatable ink layer 124 is located from the surface of the rotary drum 140.

In an embodiment of the invention, the ablating of the security feature occurs preferably after a quality check has been performed. The quality check identifies all defective value documents, which do not satisfy the required quality requirements. Once identified, the defective documents are removed from the printing process or are marked in some cases or in others referenced physically or on a database by an added or already present feature as ‘defective’ and are missed out in the subsequent printing process. The security feature is only ablated on value documents which have satisfied the quality requirements. Every manufacturing process will produce a number of defective products. Where printing is concerned, such defects may relate to the incorrect colour being printed, or in the incorrect placement of the ink or some other defect. Conventional optical measuring instrumentation may be used to automate the identification of defective value documents. In one embodiment, the identified defective value documents are removed from the printing process by cutting the value documents from the sheets in which they are printed prior to the ablation process. In another embodiment, the defective value documents are merely identified and excluded from the subsequent printing process which prints a security feature (which can be the serial number for example) on each document. In this way, serial numbers for example are only ever added to non-defective financial instruments/value documents. In this embodiment after the security features have been printed the sheets are cut to form the individual value documents.

This also leads to two types of specific quality checking. The first type is a check which occurs before ablation of the security feature. This is a general check to see if any aspect of the document is defective. All value documents passing this stage have the security feature ablated on the document. The second type of check is optional and would be carried out on a separate device positioned after the ablation process. This device would carry out a check, after the security feature has been ablated, to confirm that the ablated security feature was formed correctly on the value document. If there is an error here, the document can be identified as defective and struck out. The serial number of the defective document can then be reused in the prior security feature ablation stage.

It is also to be appreciated that the process of printing security features is carried out in parallel on sheets (either pre-cut or on a roll) of value documents. In this way, tens of documents are printed in parallel (simultaneously) across the width of a sheet. This would require a more complicated stencil drum as each of the security features to be printed in parallel would require its own drum or alternatively its own portion of a large stencil drum.

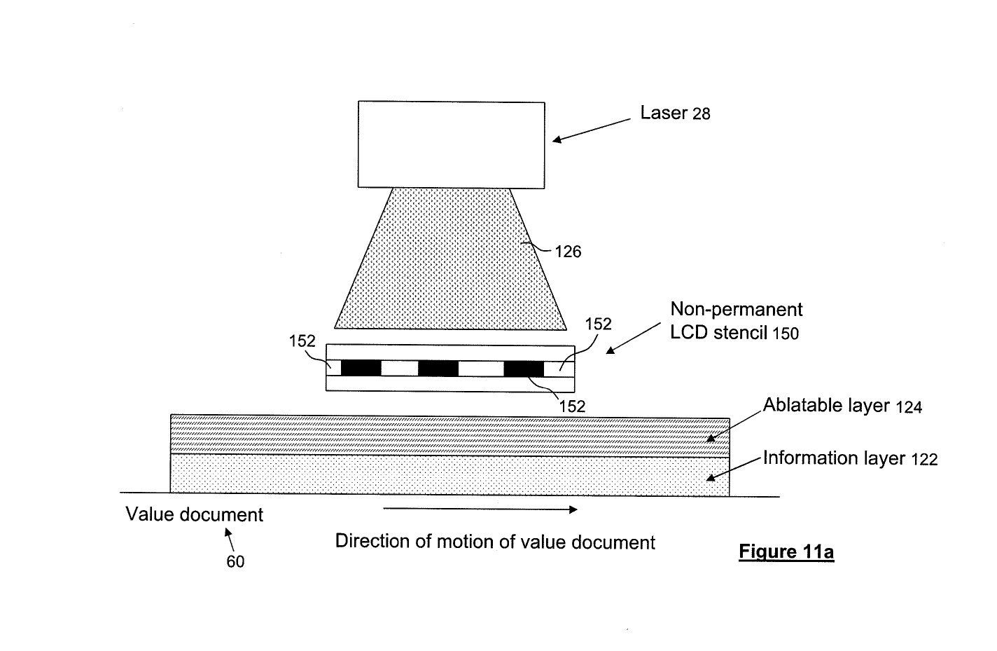

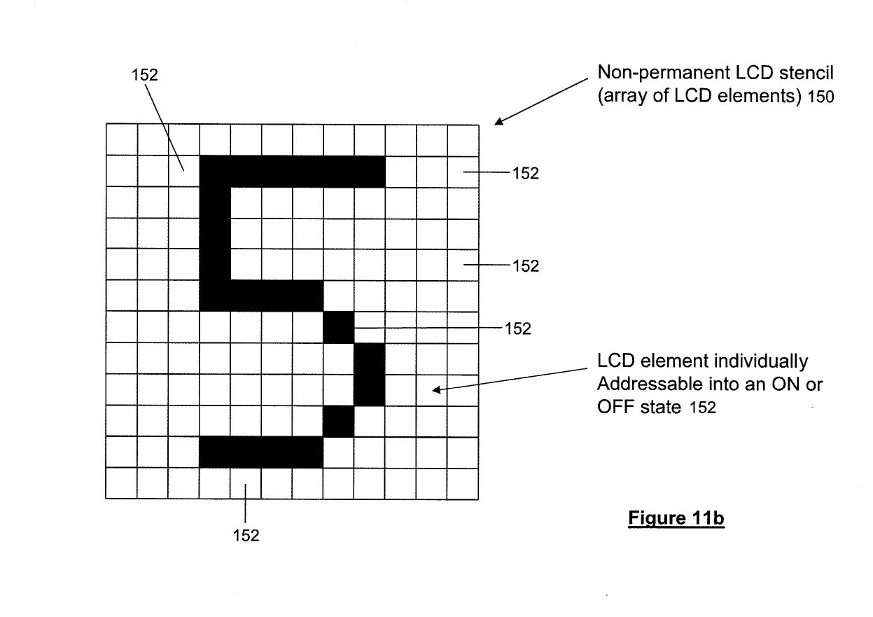

It is possible, in another embodiment, to replace the rotary drum 140 with a glass LCD stencil 150 as shown in FIG. 11a. The glass LCD stencil 150 is a relatively thin device which has LCD crystal elements 152 provided within its structure. Each LCD element makes up a pixel of an overall image which is displayed when the LCD crystal element 152 is in an ‘ON state. In this ON state, the LCD crystal element 152 rearranges the molecules within its structure to block light. The glass LCD stencil 150 has a plurality of such elements 152 arranged in an array representing one character to be provided by the stencil as shown in FIG. 11b. The advantage of the glass LCD stencil 150 is that it is much simpler in design than the rotary drum 140 and has no moving parts which improves reliability and reduces cost. Also the stencil is non-permanent and can be reconfigured to a different stencil under electronic control (as will be well understood by the skilled addressee). Merely by controlling the combination of elements which are turned on, a different stencil can advantageously be formed. Furthermore, there are no light reflecting issues to resolve in this embodiment which are present to some degree in the rotary drum stencil embodiment.

FIG. 11b shows a single high-resolution stencil (a matrix of 12×12 elements) but lower resolutions are also possible to make the construction of the stencil simpler (such as a matrix of 8×8 or 5×8 elements). A plurality of such stencils 150 forming a set would be arranged adjacent to each other to replace the rotary drum 140 comprising several annular rotatable stencils 149 shown in FIG. 10b. Similarly a plurality of such sets of stencils 150 could be provided for carrying out ablation in parallel on a plurality of value documents provided across a sheet of value documents.

It is to be appreciated that the above described glass LCD stencil 150 is one example of the type of device which could be used as a non-permanent stencil. Any form of transparent substrate which has the ability on a pixel-by pixel basis to change its opacity and can be controlled electronically can be used as the non-permanent stencil.

As suggested in the preceding paragraphs, rather than creating stencils in the ablatable ink layer 124, in a further aspect of the present invention an EM-sensitive ink is used whose optical characteristics are irreversibly changed when irradiated with EM-radiation. For example, regions of the ink layer irradiated with EM-radiation become optically transparent thereby allowing the underlying information content layer to be viewable. In such embodiments the stencil effect is provided by the optically transparent regions, rather than by ablated regions in the ink layer.

In yet further alternative embodiments, the ablated validation code may relate to a barcode.

An alternative embodiment of that shown in FIG. 10b is to replace some of the stencil rotary drums 149 with conventional ink printing drums. This would result in a combination of stencils and direct ink printing drums which would enable the security feature to have a combination of fixed ink and colour-shifting ink or OVI or OVMI ink elements provided on the value document.

In another embodiment (not shown), a reactive substance (possibly in liquid or gel form) is held in a plastic strip allowing for ‘predictable failure’ caused by the application of laser radiation to the plastic strip. The application of the laser radiation weakens areas in the plastic strip in a predictable way allowing for direct leakage of the substance which causes a chemical reaction in the underlying substance (layer) underneath the plastic strip. Alternatively, the action of pressure applied by rollers during a document processing stage leads to the leakage or leaching of the reactive substance from the plastic which has now been weakened to allow for predictable failure. This leads to a leakage or leaching of some of the contained reactive substance causing a staining effect on the underlying substance layer which is normally an ink layer. The amount reactive substance released can be very small to have an appreciable visible effect within the ink layer.

In another embodiment (not shown), laser radiation can be used to cut through the substrate effectively from its underside effectively exposing the ink strip directly on top side of the substrate via the cut in the substrate. The cut (or aperture created by the laser) could be in the shape of a symbol/letter/numeral or could be a series of very small holes (perforations) which in groups define a symbol/letter/numeral. The removal of the substrate in this area exposes the ink strip to chemical reaction by contact with air or other atmospheric gases. In this case, the cut or perforations would expose the ink in the pre-printed ink strip to the opened area in the substrate. This would cause the ink in the exposed region to change colour such that it could be seen to have a different colour from either side of the substrate thus exposing a number or a shape/symbol (pattern) that is directly commensurate with the cut that the laser radiation has made.

It is to be appreciated that the concept of using a plurality of perforations which in groups define a symbol/letter/numeral is applicable to any of the embodiments described herein. In particular, this is particularly useful where the surface area of the ink layer to be exposed to laser radiation is relatively large such that that the structural integrity of the value document could be affected by the ablation of the ink layer. By subdividing the laser radiation area into a plurality of sub areas, then strength of the composite value document is enhanced over the situation where a single continuous area is ablated.

It is also to be appreciated that the exposure of the ink layer to laser radiation may cause an initially transparent ink layer to become opaque or non-permeable to light. Here the molecules in the transparent ink are converted from their stable state of being transparent, to another stable state of being opaque by the action of the laser energy being imparted tot hem via the laser irradiation.

In a variation, the ink layer can be covered by a transparent layer that is resistant to laser irradiation, whilst there is nothing between the transparent layer and the substrate. The transparent layer would prevent the laser removal of the substrate going too far as it could act as an end point for the apertures created in the substrate. In addition, optionally once the apertures had been formed in the substrate, the apertures could be filled with a transparent layer deposited on the aperture-forming side of the substrate. This would have the advantageous benefit of filling the apertures with a light-transparent sealant rather than allowing the apertures to inadvertently get clogged up with non-transparent material in use, such as dust or dirt particles which would in turn affect the optical characteristics of the security feature.

This way of creating the security element in the value document creates a security feature which advantageously has one overall optical impression when viewed from one face of the document and another different overall optical impression when viewed from the other face of the document. If colour shift ink is used in the ink layer, the effects generated can be quite unique and very difficult for a forger to replicate. The overall image from one side is an mirror image of the overall symbol/letter/character image from the other side. This dual optical characteristic of a single optical security feature is highly advantageous as it provides greater security in the value document.

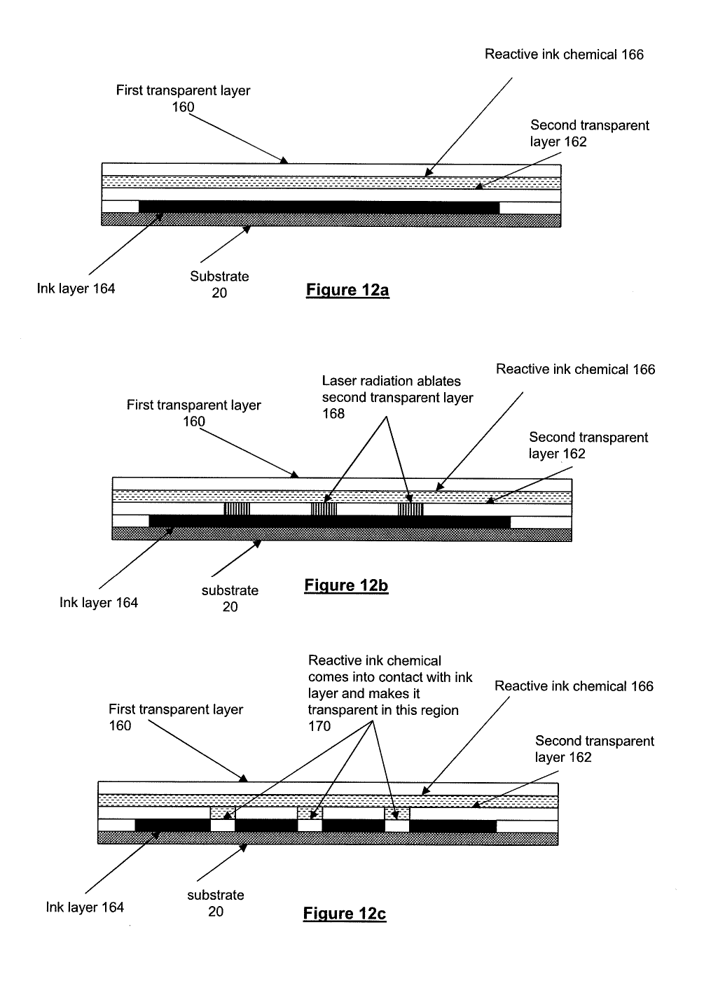

In another embodiment, as shown in FIG. 12a, two transparent layers 160, 162 above a single block of ink 164 contain a transparent reactive ink chemical layer 166 between them. When this chemical comes into contact with the ink 164, it reacts with it to either remove the ink 164 or cause it to become transparent (become clear to light). For example one type of chemical which can be used is an ink eradicator disrupts the geometry of the dye molecules in ink so that light is no longer filtered. The molecules are disrupted by sulfite or hydroxide ions binding to the central carbon atoms of the dye. The ink is not destroyed by the erasing process, but is made invisible.

The laser 28 acts to cut a figure/symbol/number 168 in the bottom transparent layer 162 which is sensitive to laser action whilst the top layer 160 is not sensitive see FIG. 12b. This causes a stencil to be created in the ink layer 164 which is provided as a layer above the substrate 20 and the reactive chemical can flow into contact with the ink layer 164 in these areas 170. A reaction takes place and the ink layer 164 is changed to be transparent in these areas 170, thereby creating a cut-out security element in the ink layer 164 as shown in FIG. 12c.

By use of colour-shifting ink, it is possible to create so called ‘ink effects’ on edges where apertures are created in any of the non-transparent layers of the value article. These edge effects are created by optical interference patterns but also help to make it more difficult to create forgeries of the value document.

It is very difficult and expensive for a forger to replicate these security features. This is because forgers normally forge using cutting techniques not chemical reactive techniques. Also the forger needs to know which wavelength of laser light is required to cause such effects in the second layer. This shifts the required forgery to an industrial process which makes it far more robust to potential illegal copying as it is very expensive to replicate this process. Techniques described above are typically used for creating serial numbers in value documents.

In addition, this method of creating serial numbers 62 on value documents 60 can provide further enhancements to the security of the process of value document distribution. The process enables creation of serial numbers on demand at an issuing terminal 80, for example an ITVM (instant ticket vending machine) or a cash register. Here value documents 60 without any visible serial number (blanks) would be provided to the vending machine and as required, value documents would be issued on demand with the serial numbers 62 being created during a dispensing procedure from the vending machine, The distribution process of the value documents is more secure because before dispensing, each value document 60 has no value and would not be a valid value document.

In one embodiment, a lottery scratch card dispenser similar to an ITVM is provided. The lottery scratch card dispenser contains a laser (typically a low-cost laser diode) so that a scanner within the dispenser scans the serial number and, either by accessing a central database or its own locally-stored algorithm(s), determines the location for laser ablation to occur. The dispenser then user laser radiation from the laser to ablate an area on the scratchcard such that it reveals a symbol/character/number associated with the serial number. In one embodiment, the revealed information can even be a copy of the serial number, such that the serial number appears in two different places on the value document and also appears in different formats.

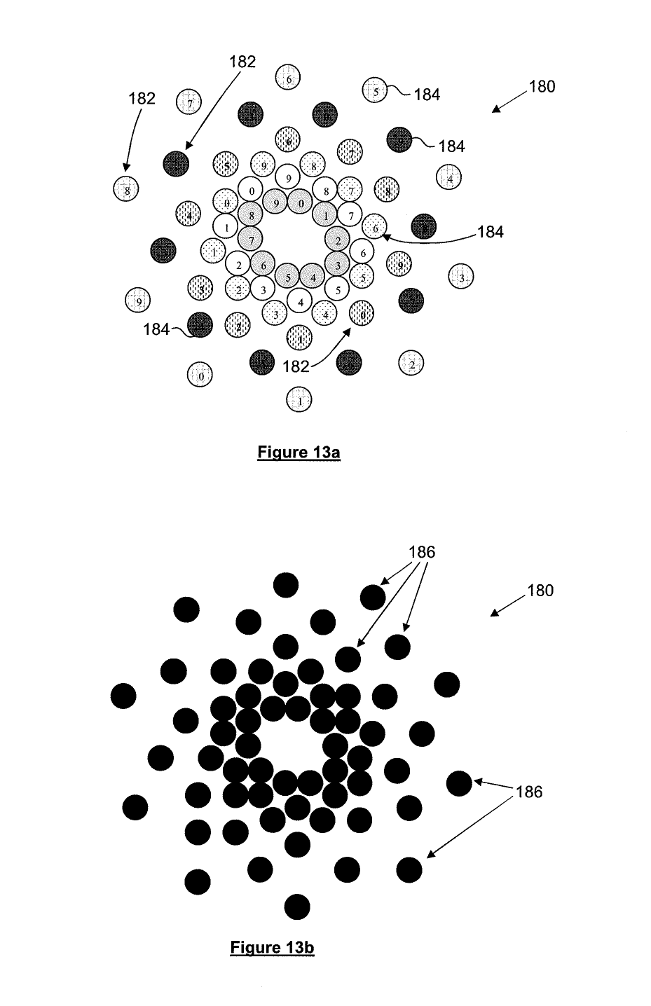

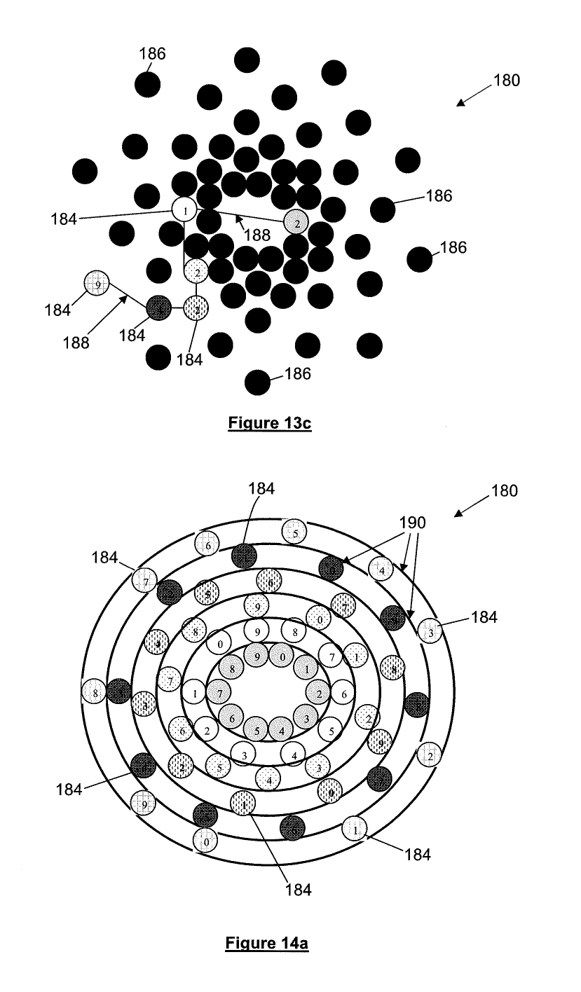

In one embodiment, in order to enable a composite serial number (or identifier) 180 to be revealed as described above, bands 182 of hidden numbers/symbols/characters 184 are provided. In the embodiment using numbers, the digits ‘0’, and ‘1’ to ‘9’ are pre-printed as a constituent part of a printed feature on the substrate (see FIG. 13a). Here the different bands 182 are shown with different shading. Each band contains the numbers 0, and 1 to 9 and the total number of bands provided is the same as the number of digits in the serial number or set of symbols printed on the flexible value document (in this example a six-digit serial number is to be provided). This area is then overprinted with an ink 186 that is sensitive to laser action (see FIG. 13b which shows the minimum arrangement of at least covering the pre-printed numbers).

When a composite serial number 180 is to be provided on the value document, this covering layer 186 is exposed to laser radiation within each area of the band 182 containing the relevant symbol/number 184 in the serial number. In this way, the composite serial number 180 is then revealed inside an area comprising the concentric circles with numbers/symbols/characters in bands. Only the relevant serial number/symbol/character 184 in each band 182 is revealed by the action of the laser and a linking line 188 running through the outer area of the band moving into the inner circles (see FIG. 13c) so that it corresponds exactly with the composite serial number 180 and will be different for each value document 60. The relevant difference here is that the numbers 184 have already been printed underneath the covering layer 186 and the action of the laser is to reveal any specific number 184 within a series of bands 182 to create a composite serial number 180 which can be read in correct order by the human eye by following the linking line 188 between the numbers.

This method can be used to reveal the totality of the serial number or particular sets of the series of the serial number. The idea is that each band contains only one number that is relevant such that if the serial number was 11111 then the laser ablation would cut out the area in band one with the number ‘1’, then the area in band two with the number ‘1’, then the area in band three with the number ‘1’ and so on. To allow the human eye to read these numbers in the same order as the serial number it would then cut a line 188 between the numbers revealed. So if the serial number was 1234, the laser would reveal the number ‘1’ in band one, the number ‘2’ in band two, the number ‘3’ in band three, and so on.

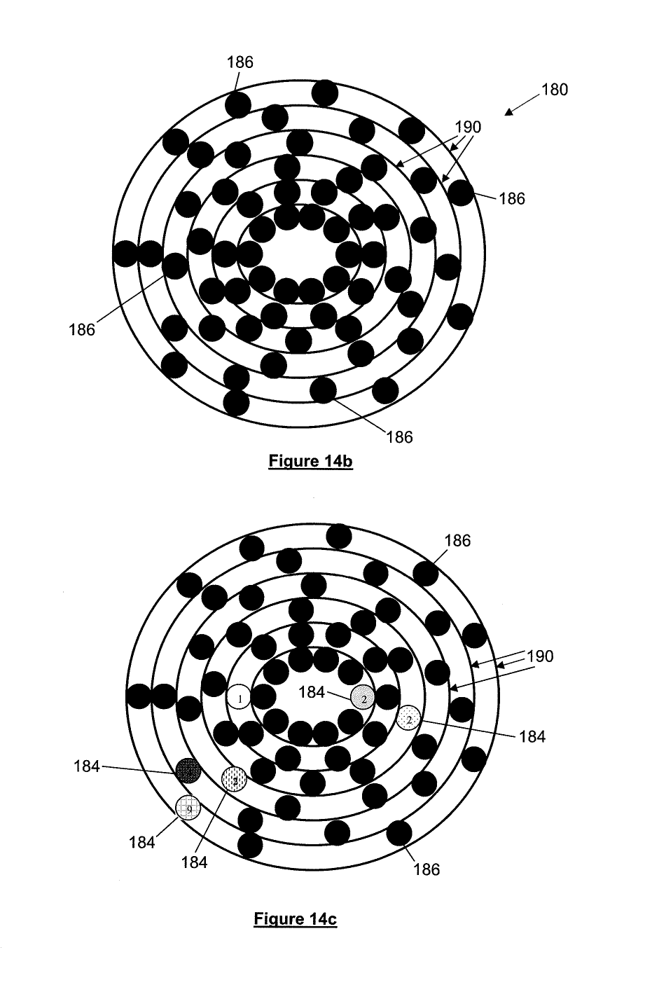

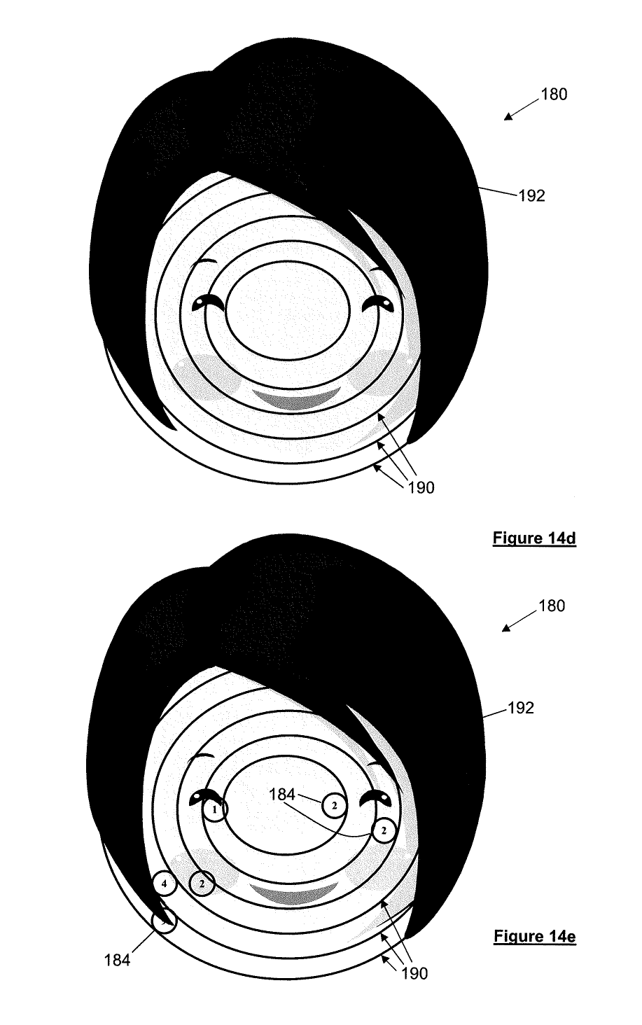

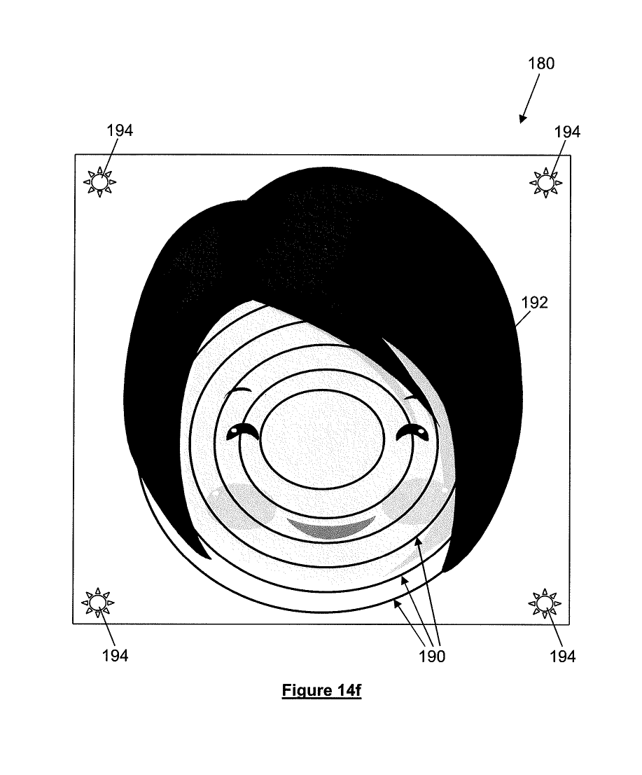

An alternative embodiment is shown in FIGS. 14a to 14c. FIG. 14a shows a set of concentric rings 190 each containing relevant pre-printed numbers 182. The important point to note is that the rings 190 are always visible to the user as they are used to read the composite serial number 180 correctly. FIG. 14b shows the numbers obscured by a covering layer 186 provided over each number 184. FIG. 14c shows the result of laser ablation of the selection portions of the covering layer 186 to reveal the desired numbers which make up the composite serial number 180. Here the provision of the concentric rings 190 enables the composite serial number 180 to be read by ensuring that the outermost number 184 is read first and the number 184 provided in the next adjacent ring 190 is read next. Accordingly, there is no need to link up the exposed numbers with a line 188 to enable the correct order information to be imparted.

It is to be appreciated that whilst only a single set of numbers has been shown to be provided in each concentric ring, further numbers could also be provided in each ring/band. This would enable the control of the laser to select which one of the equivalent numbers in a given ring should be exposed make the serial number.

The above technique can also advantageously be employed in conjunction with an overprinted image 192 as shown in FIG. 14d. The overprinted image 192 shown is of a girl's face together with the concentric distance rings 190. Also FIG. 14e shows the positions of exposed portions of the overprinted image 192 which provide the locations of the serial number elements 184 which make up the composite serial number 180. Alternatively the first technique shown in FIGS. 13a to 13c can also be under an overlying image 192 without the need for providing the concentric circles.

It is to be appreciated that the combination of a serial number of a value document defined by the exposed images of previously printed numbers/symbols/characters together with the overprinted image 192 provide a very high level of security as it becomes particularly difficult for the potential forger to replicate. Also, additional security is provided because a suspected forged value document can be confirmed as a forgery by ablating away the overprinted image 192 at a location where a known number/symbol 184 should be located. This knowledge is held by the original printer of all of the numbers/symbols/characters on the base substrate.

Creating serial numbers using the techniques described above requires the laser control processor (within the terminal printing or dispensing the value documents) to know the precise location of the pre-printed number before the portion of the overlying layer 186 or image 192 is removed. In order to ensure this alignment, exposed registration marks 194 are provided in an embodiment of the present invention which are placed on the value document substrate at its time of manufacture (see FIG. 14f). Here the overprinted image 192 of FIG. 14d is shown together with the registration marks 194 which accurately locate the position of the underlying substrate. These registration marks 194 are used as reference points which enable the control processor of the laser 28 to determine the exact locations which need to be exposed to laser radiation 126 to expose the correct numbers 184. It can do this because there is a constant relationship between the registration marks 194 and each of the numbers 184 which can be exposed by the exposure of laser radiation.

In another embodiment of the present invention, a premium bond which has a scratchcard element either within it or such that the whole scratchcard represents a premium bond can also be perforated via laser irradiation within an ITVM or manned vendor terminal. This ‘printing’ can be with a symbol or number directly equal to the serial number (or associated with the serial number via an security conversion algorithm). In addition, the process would ensure that the card was cut in an area which was open to scratching such that if it is scratched prior to the cutting then the card is rendered void, this is done to avoid stealing scratching and then buying a winning card.

In another embodiment, where the ITVM is issuing a lottery ticket in the form of a scratchcard out of a book of scratchcards, the ITVM will keep a count of tickets issued and will know also the commencing serial number of the first book. This enables the ITVM to print the scratchcard number and effective serial number using its own internal count of tickets issued and starting serial number and utilise the laser ablation methods mentioned previously to print the relevant serial number in full. This overcomes the problem that on occasion a ticket may actually come out of a book in the wrong order or a ticket in a book has been misprinted. In addition other information may also be printed onto the value document. For example, other information such as the book reference number, a time reference, a terminal reference, a validation algorithm reference, etc. can also be printed on the value document. This other information provides corroborating information regarding the validity of a issued value document.

An account of the issued serial numbers is sent to a central database together with any corroborating information. This enables the central server to validate value documents even if the number printed as the serial number at the time of manufacture does not match the number printed on the ticket by the laser ablation at the ITVM dispensing stage. In these situations, the central server uses the corroborating information to confirm that the security identifier is actually correctly provided for this value document and thus validates the value document.

The embodiments described herein are exemplary embodiments of the methods and systems of the present invention and it is to be appreciated that the current methods and systems may be used in conjunction with any flexible substrate manufacturing and validation process. Accordingly, the provided embodiments are not exhaustive, nor limiting.

### Serial Number Generation

The embodiments of the present invention also extend to the generation of serial numbers (also referred to as serial identifiers) with regard to putting these serial numbers on ordinary premium bonds or lottery tickets for example. Premium bonds, for example, have a unique serial number so when they are drawn the prize associated with the winning bond does not have to be split between different winning parties. If they are to be issued on a terminal system, there is an inherent problem as, if going for a worldwide system, there are limits to the number that can be physically printed on the ticket (for example 16 digits). Also, in generating the serial numbers on several thousands of machines distributed over a multi-jurisdictional area, how is the uniqueness of the numbers ensured? The potential lack of a unique number would cause problems on redemption. There would be a lack of certainty as to title if title were to be shown by the number thus causing the need for expensive alternative security features mitigating against the issue through any systems using point of sale (pos) systems to generate numbers. In addition, whilst these features could give extra security, they could not render the premium bond or lottery ticket as unique.

In some cases, these bonds are live and/or unredeemed for forty years or more, which will take time when checking the Central Register. If numbers are generated centrally for a worldwide scheme, there is the risk of a number occurring several times when these bonds need a unique number for the multiple prize draw purposes. This can occur even with a single prize draw product. It is desirable if part of the number has a unique identifier that cannot be replicated. If the serial numbers are generated by a central server, the server will have to have to carry out validation in the form of a check sum process and a comparison process (comparing the generated number to already issued numbers held in the database). This validation procedure would take a very long time to complete for the vast number of serial numbers which are required to be generated and presents a difficulty when validation is to be carried out in real time (an industry standard of 4 seconds being typical), namely whilst the user is waiting.

Thus it is desired to generate a number that is unique to each individual ticket in such a multinational system setting, which enables relatively fast validation of that unique number centrally.

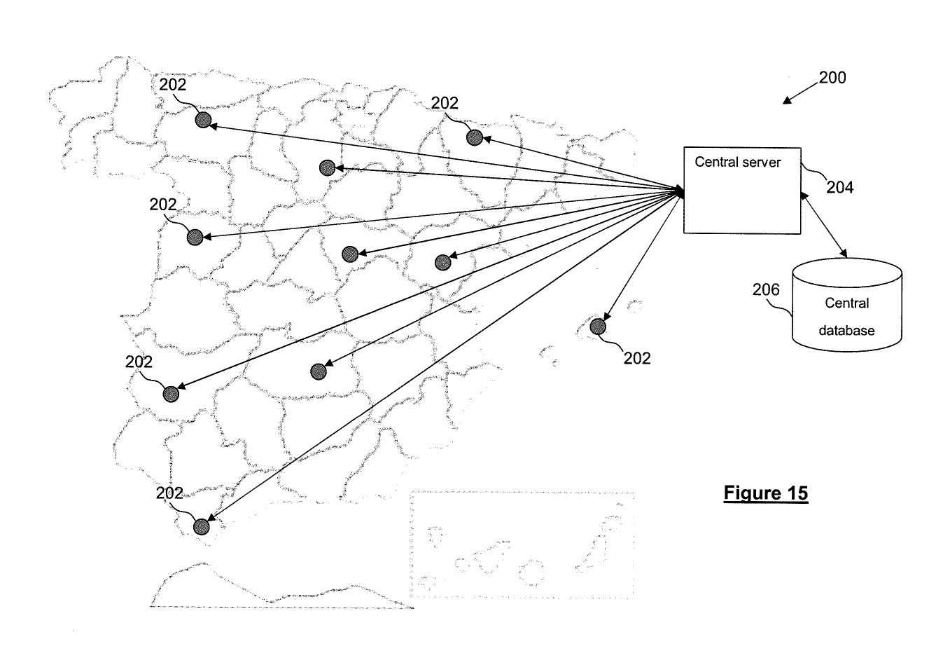

The present invention, in one aspect seeks to overcome this problem. The present aspect of the invention resides in the appreciation that an international (multi-country) system 200 as shown in FIG. 15 with a plurality of terminals 202 linked to a central server 204, the serial number of a ticket or premium bond issued by a terminal 202 can be made unique in a practically verifiable way by providing a unique identifier within the serial number, namely a terminal identification number. Optionally, other identifiers can be provided such as a regional identifier (such a country code and/or city code and/or city district code or code for some smaller form of habitation) and the data/time identifier. Such codes can also be used as an additional or separate identifier. These are either printed in the open or encrypted according to an algorithm known to the code section central server and periodically changed by it for the specific terminal. Furthermore, the Terminal ID may also be sent up unencrypted (unalgoed) in order to act as a look up index for the central server verification process. This resetting of the terminal algorithm is carried out periodically as a set-up stage for the terminal 202 before substantive use. Therefore, each terminal, in effect, creates part of the serial number and the serial number can always be traced back to the terminal indicating where and when it was generated. This also means that the random element of the serial number can in certain circumstances also be terminal-generated and only unique to that terminal. Another terminal 202 can generate the same random number but its serial number will be different due to a different generating terminal ID being provided in the serial number. For example, the random number for a lottery terminal can be based on user-selected lottery numbers which are then encrypted using an encryption algorithm provided at the terminal and then printed onto the ticket. These numbers are communicated up to the central server 204 to be stored in its central database 206 for redemption purposes. This then allows a valid lottery ticket at redemption to be validated as the winning numbers can be verified within the serial number in a secure manner.

Alternatively the random part of the serial number can be generated centrally and added to the part generated by the remote terminal 202. In this case, the terminal 202 makes a request for a serial number. The request is processed by the central server 204 to firstly validate the remote terminal 202 by means of its identity and thereafter to set up a specific database 206 (or part of a database) for that terminal for rapid validation of that number at a later point in time.

Regardless of which method of the above two methods of serial number generation is used, the advantage of this approach is that the validation stage in redemption is much faster than in the prior art as two shorter searches would be carried out, one for valid terminal ID part of the serial number which would lead to a specific smaller look up table and the other for the valid a shorter random element within the look-up table.

FIG. 16 shows a remote terminal 202 according to an embodiment of the present invention. This terminal shows all of the possible features that can be provided in the terminal, though in practice only a subset of these features may be required, dependant on the desired application and use of the terminal. As can be seen the terminal comprises a user selection input module 208 for user data input, a visual display 210 for providing the user with instructions and feedback on the process, and a value document printer 212 for printing out an issued value document. The terminal 202 is arranged to generate a value document with a unique serial identifier. Serial identifier creation is handled by the serial identifier creation module 214 which is coupled to a data store 215 storing the terminal ID 216. The data store 215 may optionally also store a regional identifier 218, product codes 220 and one or more serial number creation algorithms 222. Also the serial identifier creation module 214 has access to a local random number generator 224 and a time/date module 226 to assist in the creation of the serial identifier. The terminal 202 is networked and is provided with a communications module 228 for accessing the central server 204 and an encryption decryption module 230 for enhancing the security of the communications as required. The functions of these modules are explained below.

The concept of random number generation at the remote terminal can even be extended to spot-the-ball competitions which are played with the use of terminals. For example, a user can purchase a spot-the-ball ticket which has a grid provided about a physical picture of a football match. The ball itself is missing from the picture and the user has to guess where it would have been. In doing so, he enters his grid coordinates using the grid provided on the picture for where he considers the hidden ball to lie. The co-ordinates are entered into the terminal 202 via the user selection module 208 and used in the creation of a unique serial number for the user of that entry which is then printed via the value document printer 212 on a ticket as a receipt and proof of entry into the prize incentive game. The details can be transmitted via the communications module 228 by the terminal 202 to the central server 204, which can store the entry in its database 206. At a later point in time when the results are announced, the terminal 202 to which a winning ticket is presented can determine whether it is valid by using the serial number. In a ‘spot the ball’ competition, an exact reference can be transmitted giving the customer's estimate of where the ball should be or in fact ‘is’ (it having been blanked out) with the purpose of intertwining the reference with other information. This grid reference can be encoded (using the encryption/decryption module 230) and included in a combination with the transmitting phone number to produce a reference known only to the central server 204 and which can only be decoded with the relevant phone number.

In a further embodiment, the customer can enter and transmit his name and/or birthdate either by reference to a keypad on the phone or by numerical reference to an alphanumeric pad (user selection input module 208) provided at the terminal 202. This information can either be provided in an encrypted form on the value document, or can be used in the creation of the unique serial identifier. For a winning ticket, the winner would be that party who could provide satisfactory identification including name and birthdate and/or phone number which corresponds to those previously provided with the grid reference for the ball. This picture also can be produced in an electronic medium i.e. viewable on the screen of a phone computer or other electrical device with the grid reference outside the picture so as to allow the viewer to pick the point using the grid reference where they think the centre of the ball may be. This may be achieved by either selecting a grid reference, or moving a cursor over part of a picture which provides the grid reference.

It is also possible for other features to be used in the generation of the serial number. For example, a product code 220 can be used in conjunction with the terminal ID, and as has been mentioned the time and date (generated by the time/date module 226) and the country code (regional identifier 218) to provide a greater degree of information with the serial number. The use of time stamping in conjunction with serial number generation also enables use patterns to be used to detect fraud. If the date on which a range of serial numbers were issued is known, then any serial number being presented as generated on that day will have to fall within that field or be detected as fraudulent.

There can be further number generation at the central server level, in addition to the random number created by the user-selected numbers or where there is no user-selection of numbers. This provides an even greater level of prevention of fraud than number generation at terminal level alone. This is because of the “distributed” nature of the number generation by the system.

As has been mentioned above, the central server 204 can place algorithms (algos) 222 on each remote terminal 202 to generate the serial numbers. The ‘algos’ 222 can be changed every once in a while from the central server 204 which feeds the information down the communications link to the remote terminal 202. Different levels of security and complexity can be added. For example, a security feature can be added that if a terminal 202 is opened or interfered with, the ‘algos’ 222 disappear, are erased from memory. This would be the case if the algorithms 222 are kept in erasable or virtual memory only.

It is to be appreciated that each terminal has its own unique ID number 216 at manufacture or when it comes online. This number is hard-wired into the terminal so it cannot be affected by virtual strip outs, for example. Alternatively, the unique terminal ID number can be programmed in on installation. On installation, the terminal is also given its regional code 218, which typically is a country code identifier, such as an International dialling code number. Thus, each terminal has a unique ID number 216 plus a country code 218.

In addition (and as described in detail later), both the terminal time and the central system terminal time can be printed with or without algorithmic changes to them and a checksum of a decaying time at the central system would show the relevant terminal time in relation to the real central system time. If this was a match with the two relevant times algorithmically printed on the ticket, then the ticket would be valid. In this incarnation, the concept of a decaying time clock as described later would be used as the unique identifier tied to the terminal.

In addition, the scratch card may have a barcode that can be photographed and/or scanned and sent by mobile phone camera via mms or email to the central server to verify that card is real. The central server will then require a scratch-off process as described above to verify and/or encode the barcode on the scratch off portion of the card.

In addition, each terminal has stored within its memory 215 a plurality of algorithms 222 (referred to as ‘algos’) including an algo to scramble its own number and another to generate “self pick” or “lucky dip” number for the users.

An extra function exists with respect to scratch cards. With a pre-printed serial number on a scratch card there would be a registration requirement of calling in on any type of phone (including landline or mobile) to the central system. The serial number would be talked in or typed in by phone pad or by SMS in answer to which the central server 204 would either by voice or SMS send an instruction(s) to the customer. The instruction(s) would inform the customer which numbers and/or symbols to scratch off on the card prior to the separate customer self-chosen action whereby the customer scratches off his chosen symbols or numbers to show whether the card was a winning card. As the central server will be able to pick covered numerals or symbols to cross reference or reproduce the serial number which itself may be numerals and/or symbols on the scratch card, the customer cannot afford to scratch off anything until this process of registration is complete as they risk invalidating the card by scratching off the wrong area to show the winning card (here the area to scratch off would in effect not be revealed until the server has given the customer the relevant instructions). If this process of central server contact and validation using a serial number printed on the scratch card were also aligned with a vendor ID number which could be changed periodically and given to the vendor by the central server, then the central server could be sure that this was a valid sale mitigating against the risk of theft or forgery as only valid cards sold through a valid vendor with the correct id would be recognised. As a further protection, anyone calling in with a given serial number could be instructed to scratch off a single designated square and relay the revealed symbol and/or number underneath to the central server. Only the central server would know the symbol and/or number underneath so would be able to tell if the card was reproduced or forged. In addition to numbers or symbols for this process, letters or pictograms of various languages could be used such that the customer's name could be scratched out in its actual spelling and/or by an instructed spelling by the central server.

The way in which the present aspect of the invention works for different types of multi-function tickets, such as prize-incentive financial bonds, which are described below. Two types of multi-function tickets have been described in our co-pending International application published as WO 2010/086827, namely an ordinary bearer premium bond and a part-registered premium bond. Taking each of these in turn:

### Ordinary Bearer Premium Bond Example:

In this case, the remote terminal has a permanent encryption algorithm ‘alga’, which the central server is aware of. The permanent algo is loaded into the terminal at a programming stage of configuring the terminal for use. The terminal transmits information which is related to the premium bond, and then at a later stage once it has received information from the central server, the terminal prints the actual premium bond as a transaction slip. In this process, there is no generation of the complete serial number at the remote terminal, only part of the serial number derived from some vital information, the unique terminal ID and, possibly, the date and regional identifier as provided. There is no user selection of numbers as the random element comes from the central server.

Assuming there to be a country code and a terminal ID stored within the terminal, these two items of information are encrypted and sent to the central server together with the terminal ID in an unencrypted form.

Central server then checks and verifies that the terminal is valid/online/real by knowledge of the encryption ‘algo’ used at the authorised terminal. The remote terminal also sends up an unencrypted terminal identifier as an ‘algo’ packet. This is used by the central server to check that the correct encryption algorithm is being used by the terminal and this also helps to validate the remote terminal.

It is also possible to create the serial identifier by: use of three separate ‘algos’ each one contributing to a specific part of the serial identifier; by use of a single ‘algo’ as has been described above or by putting together a series of identifiers with knowledge of which one is correct being known to the terminal—so that a fraudulent observer of the communications between the server and the terminal cannot distinguish which is which.

When, at the server, the information is received it is decrypted, and the decrypted date and the information is compared to determine whether it is a valid terminal. Once the terminal has been validated, the server then generates its own internal number, which if using a timestamp, will be slightly different to the terminal generated number as it has a 4-second difference in the timestamp.

If successive numbers are given a date which is out of series, it is possible to detect fraudulent activity. An extra level of complexity is if the serial number is out of synchronisation or if the ‘algo’ is not known to terminal, it is then sent back to the terminal.

### Part-Registered Premium Bond:

The user at the terminal gives his surname, initial and birthdate as has been described in our co-pending international patent application published as WO 2010/086827 (however the use of a symbol is optional in this embodiment). This simple composite user ID is either used by a Terminal algo to generate part of the serial number or can be transmitted in encrypted form to the central server to be used in the random part of the serial number generation. This simple composite user ID provides additional information which can be effectively incorporated into the serial number being generated.

Single or additional ‘algos’ to create an identifying transaction identifier (printed on the ticket as a serial identifier) which takes as input the user's name, initial and birthday so when the user claims the ticket, it has this personal information of the purchaser inbuilt into the identifying transaction number.

In an another embodiment, the name of the user can be printed on the ticket or it can be hidden inside the transaction number. This system is vulnerable as it is a new way of issuing a Premium bond, as it may accidentally generate a problem (non-unique numbers), and so it cannot check everything as there is not enough time at Central Server (checks ideally need to be carried out in 4 seconds or less). This is especially true if the new system and new way of issuing a Premium bond is to be combined with any existing legacy systems that have Premium bonds which have a plurality of existing issued identifiers. It is possible to carry out a pre-check to eliminate part of the range of possible identifiers from ever being generated. The pre-check would “iterate” backwards to determine the issued identifiers. However, Premium bonds historically have to have an independent draw system and so the checksum could end up issuing the same amount.

This situation is therefore vulnerable to insider fraud, links with dead people, the making of false claims, (checksum by user name and birthday) and/or family members stealing it, —providing a considerable risk over any medium to long-term premium bond issue term. This vulnerability is cured by the use of symbols as described in our co-pending International application, mentioned above.

The holder still has to prove his ownership, but if he notes the transaction number and keeps a record, he can get back the bond. If not, the holder cannot because anybody can claim they have lost their bond—and link the transaction number to the holder. Under the present embodiments of the invention, the system can offer a bond redemption or a prize even if holder loses the ticket. This is because the transaction number is printed on each ticket.

The principle is the same for all transactions namely: a terminal number and a country code, generate the same information. The difference will be picked for the terminal by the nature of the transaction slip put into the terminal. The transaction slip in one embodiment has a product code on it which the terminal recognises. The terminal will input the product code into the encryption algo and transmit it to the server and the terminal can also send the product code up in the unencrypted (raw) form, to prevent criminals intercepting and using the data. In this way the central server knows what to expect from the terminal. The product code can be in numerical form or as a barcode or a coloured dot, or symbols etc. All of the above can be linked into scratch cards.

### Multiple Encoding/Encryption Algorithms at Terminal

According to another aspect of the invention as mentioned before, it is possible in other embodiments to have the real-time placing of more than two algorithms 222 (up to 10 or more) by an encryption algo server on the remote terminals 202 placing the encryption algo in the background i.e. between signals. In this situation, the terminal continuously receives a signal containing a stream of encryption algos, until it interrupts itself to transmit transaction data to the server. At this point, the last full encryption algorithm received would be used. Alternatively, it is possible to have long lists of encryption algos 222 present on the transaction terminal 202 and the selection of which encryption algo is to be used in which list is made by the central server 204 which transmits a reference tag (ID tag) of the encryption algo to the terminal. This allows the terminal to select alternate lists for use for random encryption algos and then either the terminal makes the switch between the old list and the new list as a one off, i.e. where it is receiving the encryption algo down the line from the encryption algo server or the encryption algo executing part of the central server, or it simply switches between lists of encryption algos and then itself randomly picks the encryption algo from the newly designated list.

Alternatively, if each lottery ticket needs to be generated with a different encryption algo, then instead of using a pseudo-random encryption key, which changes value every time it was used, it would be possible to have a tag generated by the central server attached to the end of each final transaction from the central server that changed the encryption algo in the terminal as a pseudo-random event. In this case, the pseudo-random change is the base algo present on the terminal being changed by the central server, but the central server not holding the base algo, but an iterative series of tags e.g. +4+6+8+9+12+11 which it applies in a random order that only it knows to change the algo. The server records the series of tags and stores elsewhere for a subsequent iterative process to descramble at prize winning. This is because central server knows the terminal, the base algo present on it, and the series of algo changing tags it sent and the date order they were sent out.

For a further refinement, the terminal 202 can hold a long list and randomly pick (using the random number generator 224) which algo 222 is going to be exposed to the tag. It could hold a list of these actually used in a day file with a time reference and at the end of the working day (downtime) send encrypted a list of the base algos picked by it and then exposed to the tag from the central server. The advantage to this is extra security as now a large number of functions are distributed to different servers or to different areas of the same server such that no one person or small set of people have overwhelming access rights. This significantly reduces the risk of insider fraud as some of the instruments may have validity beyond the short period normally associated with a lottery draw which would normally increase the risk of insider fraud rings having time to organise and crack codes and create false entries as the instruments are still live and have a constant value. The rationale is that the long-term/medium-term event addition to the short term lottery draw of a week to a month and prize claim period of about 6 months, now places a strain on the system as the pseudo-random generation of the algo on the terminal will have to have some accounting function in order to be used for validation of the instrument beyond 6 months. In this period, the lottery terminal may go totally out of service rendering it useless for validation unless a record is kept of its pseudo-random draw. Such a record would open it to fraud by insiders. However, the distributed way described above allows for the terminal to create the pseudo-random algo with the assistance of the central server, but also to record it in a distributed fashion with the involvement of second or third servers or with distinct firewalled areas with no overwhelming access rights.

With the tag system, the central server would possibly know all the base algos on the individual terminals of the system but not until the report stage would the central server know which base algo the terminal had randomly picked when the tag changed. Also the central system would send a set character, like a hash, that the terminal would be programmed to understand was a break character, so that the terminal would recognise a break between the final transaction information for inclusion in printed form on the ticket and the tag to be applied to the base algo of the terminal's choice to pseudo-randomly change the base algo ready for the next transaction. This changed base algo which had now been used once would in turn become the base algo for the next tag to change.

In this form of a rolling base algo, the terminal picks from a list at the start of the day with the possibility the list has been uploaded by the central server during the downtime at night and the terminal uses this as a starting point. The central server on the first boot up queries the remote terminal to check if it is listening. It then sends the tag whilst the terminal randomly picks one algo from the list and applies the tag. The terminal need only reference in its final report which was the starting algo. If the terminal is lost, the central server (which provided the list) which has a list of the original algos sent to the terminal, can run comparisons with the tag on all of them until it works out the original starting algo.

As a further security item there can be a tag starting character and a tag finishing character which allows the information to be embedded in the transaction string so as not to be spotted if someone breaks into the line. Also for extra security, two bookend tag characters can be sent the night before or at opening or sent any time during the day before during a transaction as with an established value in between the tags and then this tag can be stored by the terminal for use the next day.

### Money Laundering:

Money laundering is also an issue which has to be addressed by any system. As has been described in our co-pending international patent applications published as WO 2010/086827 and WO 2009/019612. Here, the concept of accessing non-proprietary database servers such as a government database has been described. However, this checking of identity or other data with these databases is out of any control of the user and this may not be acceptable to the user. Furthermore, the traffic at such government databases can become so great that it is detrimental of speed of access at such important databases.

Accordingly, another aspect of the present invention seeks to address this issue and provides a method of controlling or at least providing authority to access databases when an authentication process (being carried out at a central server or a terminal) conducts identity verification checks such as money laundering checks. In this case, the user only releases information which would enable the check itself to be conducted reasonably reliably rather than more personal information which could be stored and used against the person at a later date. For example, the user only releases part of the information from its personal details database to the ‘middleman’ database, e.g. name, initial and birth date but not the fact that the person is 6 ft tall and has a criminal record and lives in flat in London etc. Thus the control for the user is that only limited personal information is provided which limits the different types of checks which can be carried out. With the minimal combination of family frame and initial as well as birthdate, enough information is given for accessing Government databases for limited access to data stored there. For example the identity of a person can be confirmed by a simple ‘Yes/No’ response to a valid identity question. Also in other non-proprietary databases where further information may be accessible the present system enables a subset of that information to be accessed and used for identity checking.

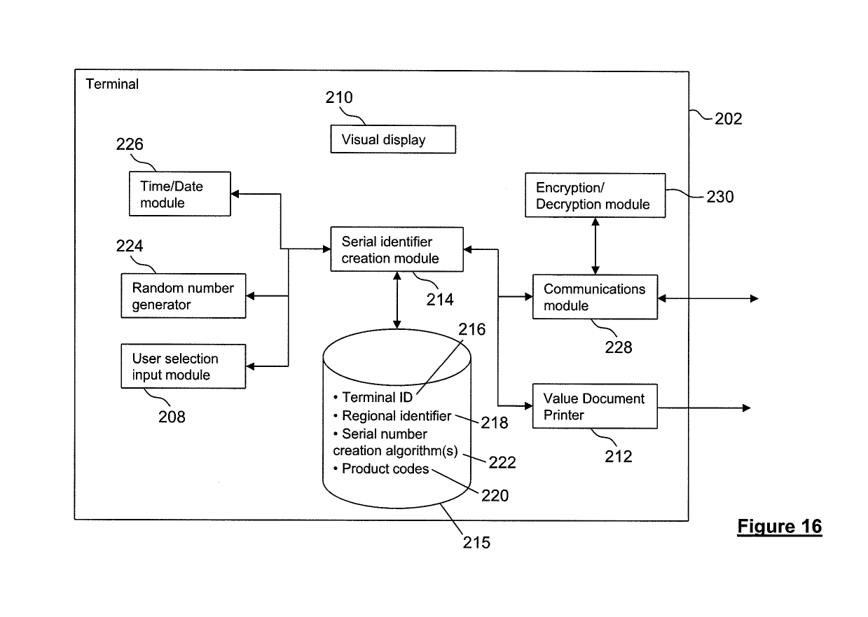

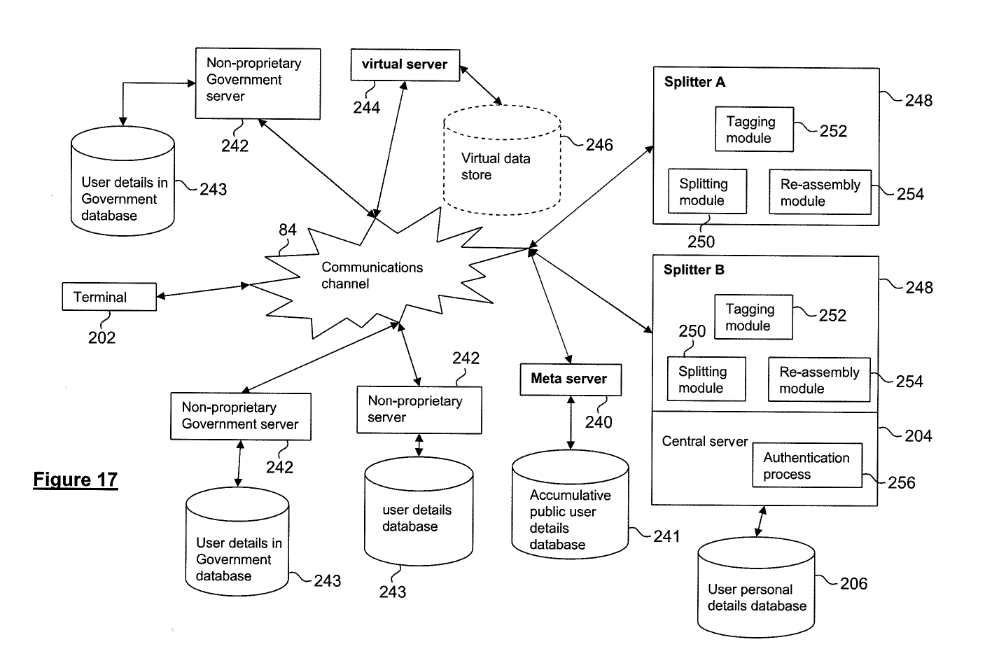

Also, as the system accesses non-proprietary servers with information about the customer which the owner of the information may not want out of his control, there is a need to provide a level of control. Three new types of money laundering check arrangements are shown in FIG. 17 and described below:

1) a meta server 240 i.e. a server that downloads relevant items of information from a non-proprietary server 242 and holds that data itself in an accumulative public user details database 241 so that at the appropriate time a request can be sent to a government server 242 for example and relevant information which it is allowed to download from the government database 243 can be copied on regular basis;

2) a virtual server 244 which does the same job as a meta server but holds it virtually in a virtual data store 246 for security purposes, i.e. deletes the data after the work has been completed; and

3) a splitter (splitter A) 248 which looks at the identity verification request from the terminal and/or central server and splits it (using a splitting module 250) for transmission to the relevant servers for a ‘yes/no’ response or a more detailed response, attaches a temporary tag to each request (using a tagging module 252) and sends it to the relevant non-proprietary server 242. The splitter 248 receives the answer back in split parts from various different servers 242 and then reassembles them (using a re-assembly module 254) according to the temporary tags assigned to each request and sends the compiled response to the original requestor.

Conceptually there could be a splitter 248 between the terminal and the various central servers for security and one between the central server and the government servers 242 with customer information. This location can be realised by providing the splitter 248 at a generally accessible location and calling it at different times during an authentication process 256. Also, the splitter could link with meta or virtual servers at the same location as the central server to speed the process (not shown). This is partly similar to packet splitting for information relay across the Internet but is managed according to the source of the request and the source of the information with coded tags known only to the splitter for security.

The purpose of any of the above arrangements, is to enable a way of accessing results regarding sensitive data which can be stored on government databases without disclosing that sensitive data in itself. Slightly less sensitive data can be released together with the results of the authentication checks to the intermediate verifiers (meta server, virtual server or database associated with splitter) and stored for subsequent authentication. The less sensitive data may be useful to store outside the government database as if this information is required it can be obtained without increasing traffic to the government server and database.

In an embodiment not shown, the data stored at the intermediate verifiers can be accessed by the person to whom that data relates. This enables people to see what authentication results are being produced for them. If there are any errors in that data this can be reported to the government server for correction.

There are three ways of interruption of an authentication message depending on when the identity check algorithm is active. It can be active when the authentication message is passed to the central server or when the message is between the central server and the terminal, or it can be interrupted in the middle of the authentication process. The interruption point can have the ability to de-algo (decrypt) the part of the message related to name, initial, and birthdate (the ID items) and this can be used in the subsequent identity check. The identity check is carried out as below:
1. The ID items can be sent to the “meta” server 240: which is updated once a day or more. The meta server 240, including its database 241, accesses in non-real time (backup time) the various governmental databases 243 and downloads specific information that it is allowed to download regarding users and stores these in its accumulative database 241. For this reason it has to be data protected. The meta server 240 downloads ID items and retains them securely. It is then able to give a “Yes or No” response to a query on the existence of a particular person whose ID details have been provided, for money laundering checks for example.
2. Alternatively, the ID items can be sent to the virtual server 244. This operates in real time. ID items are decrypted, and then the virtual server 244 accesses the various government/non-proprietary servers 242 to confirm the existence of the person whose ID details have been provided. After confirmation of the user's identity, the response is passed back to the authentication process 256 and the obtained information is deleted.
3. Alternatively, the ID items can be sent to the Splitter 248. Here relevant ID information is split prior to being sent to the central server 204—ID items are sent to government servers 242 and associated databases 243 with a tag (not shown). However, each government server 242 does not see the transaction details only the ID items. At the same time, the splitter 242 sends the full information to the central server 204 with the identifying tag. This is to keep the speed of the transaction optimal. The okay (ID check clear) comes back from government server 242 (in the form of a tag), tag one is matched to tag two (held to relevant transaction). A virtual loop goes to the central server 204 with a tag attached with a ‘yes’ or a ‘no’ security item, split-off product information, attach a tag to ID items, sent up to government server. No security breach. Back to central server 204 with a tag. This allows the spotting of transactions which are suspicious. This is a “KYC” (Know Your Client) check, without making the transaction time too long and thereby is a vital time saver which enables the checks to be carried out in real time during authentication.

The advantage of the above is that no human agency or electronic machine can use the system to generate coagulated information resulting from access to items of confidential information. Rather they can only generate a ‘validation’ or ‘go’ signal that the customer passed money laundering or other identity checks on the basis of confidential information held by the government. These results can be stored locally and time-stamped such that if a person is considered to be wanted by the police for example, this can be determined by a local check without having to go back to the government database to confirm this. This speeds up the authentication check and helps in completing money laundering requirements for example.

Total access to the systems is provided, as the identity check can come back with a result of ‘KYC (Know Your Client) unknown’ (indicating this person needs a further ID check). If the identity check is conducted during a registration process and results in a negative outcome, the registration is not carried out, and the user registration has to undergo further checks. Also if the KYC check result is unknown, instead of having his ID scanned or undertaking an iris scan, the user can also be asked to go to a real-time manned ID terminal and show his or her personal ID physically.

A user can prove their identity at prize winning by linking name, ID and symbol, or existing bond if they have previously registered; if not they forfeit rights to the prize.

The aspect described above, allows the system to check the identity of the user in the background. It is a non-intrusive check up which is carried out whilst registering the transaction and/or when redeeming a prize.

The splitter 248 is preferably provided before (splitter A) or at the front end (splitter B) of the central server 204. The reason for calling this a splitter is to allow it to be placed in proprietary areas out of the control of the central server (splitter A) thereby giving more credibility to the ID checking process for the user and making it independent of the registration process.

Alternatively, the splitter 248 can be part of the central system (splitter B). The registration check process can be carried out post transaction, but in this case it has to be kept to an approximate speed of no more that 4 seconds. Otherwise, the KYC check would be too slow and cannot be carried out in effective real time and perhaps could not be implemented on a lottery terminal for example.

It is envisaged that the issue methods of data validation e.g. splitter, meta server and database and virtual server and database, as applied to money laundering can be applied to other data identification requirements whereby a secondary user may wish to obtain information from the primary source to verify a third party's data authenticity but the primary source may want to control the totality or partiality of the data given to the secondary source due to its own security and other sensitivity requirements. So, for example, questions to a central database about whether a person exists, are they of any interest, or do they need any further validation can be answered without causing traffic problems at the central database of the primary source.

It is possible to use an improved steganographic method described in our co-pending International application filed on 24 Jun. 2011 entitled ‘Data Transmission Security Improvements’ (the contents of which are incorporated herein by reference) for enabling access to the intermediate verifiers in a valid window of time to improve security if required. This window can be controlled by the third party or be made available using a random variable generated by a random number generator.

It is also possible, in alternative embodiments, to generate unique user numbers which are an index to a virtual account for known user. The unique user number is set up as an option once the user has passed the KYC checks. In passing those checks, the user will have entered date of birth, initial and surname and will have selected a service to carry out such as money transfer or bankroll payment. Optionally they will have used a symbol key to identify themselves for the transaction and possibly even used a cheat sheet (see our co-pending international patent application WO 2010/086827). However, this is not essential. The virtual account simply stores the details of the user data entry and acts as a shortcut to avoid the user having to key in all of their details for the next time they need to use the relevant service. The unique customer number can also be embodied in a bar code which would simply be scanned in at a terminal to provide access to the virtual account which holds all the user details. In this way the user number can be used to validate bankroll (alternative way of payroll) method described in our co-pending international application as has been described above.

In some systems there is the possibility of fraud using covert data gathering techniques. For example, the techniques of ‘pharming’, where a worm is placed in a computer to observe the access to target site banks, or a Trojan horse, which involves silent listening to the system to watch what key strokes a customer puts in by tying it to remote buttons, are known. However, these types of attack have been addressed in our co-pending International application WO 2010/086827 by the use of a so called ‘cheat sheet’.

Further protection can be built in by the remote window only displaying scanned images so that no future digitally transferred virus from host PC for remote window can read digital connections underneath. In other words, the digital significance of a scanned image is held at a separate location to that of a remote window to the bank computer or the mainframe and is checked outside the real-time window opening so that it will only be attributed after the window has been closed. At this stage the image is tied back to the transaction number which has been issued digitally as a further refinement to stop the possibility of a virus being able to jump from host to a remote window at the mainframe.

In another embodiment, the system can use scanned images which are digitally attributed to transactions post closing of the remote window to the banks computer in order to avoid substitutional attack, namely where a virus redirects a window during a real session. This is linked to the post close send of an email to the account through a barcode. A temporary email address can be created as part of the programme on a public PC (personal Computer) with a security that if it is attacked in a substitutional attack and the barcode goes to a false email address, the barcode can still not be utilised as it contains hidden symbol information which has not been revealed during the session of the opening of the remote window.

In another embodiment, if at some point during the transaction process between bearer and registration, an ID or a separate photo has been taken, it is possible that a limited photo can be sent down to a VDU that is manned so that the customer will need to resemble their image which is being displayed.

There is also a possibility of putting in mobile numbers in the authentication procedure for both the customer for the validation process.

Any of the aforementioned serial number generation methods may be used in conjunction with the aforementioned security feature ablation methods, and such embodiments fall within the scope of the present invention. For example, a serial number may be generated which incorporates a user's personal identification data within the serial number, and is subsequently ablated onto the EM-sensitive ink layers. This may include incorporating at least a portion of the user's name in the ablated serial number. Using the methods of the present invention even financial instruments/value documents of relatively low value may be customised to the user. In prior art systems such customisation is impractical for low-cost financial instruments/value documents due to the increased production cost such customisation introduces. The present invention however, does not introduce any substantial costs into the production process, and accordingly is suitable even for use with low-value financial instruments/value documents.

It is envisaged, for financial instruments/value documents featuring a user's signature, the signature is read, using an optical camera and reproduced, using aforementioned ablation methods. In this embodiment, the printing press is provided with a freely movable light source (e.g. a movable laser), capable of reproducing even the most complex of signatures.

Similarly, where the financial instruments/value documents feature both a user's signature and printed name, both may be reproduced on the Financial Instrument/Value Document using aforementioned ablation techniques.

In a further aspect of the present invention, the aforementioned scratch card embodiment may be incorporated into a secure ticket verification process. This embodiment may be convenient for use in environments where it is desirable to accelerate the verification process of a ticket (or other value document) to minimise a user's discomfort at having to spend lengthy periods of time queuing or otherwise waiting for ticket verification. Human verification systems are prone to error and provide a low security threshold. Fraudulent tickets and documents are difficult to identify visually. The accuracy of ticket verification systems, reliant on human verification, is limited. In the present embodiment, it is envisaged that each ticket comprises several numbered scratch boxes, each box comprised of a scratchable coating overlaid on a security feature. Each scratch card ticket is provided with a unique identifier, such as a serial number. The ticket may be registered for admittance to a selected event, using one of several different registration methods. For example, the registration methods may include registering by telephone, SMS, by phone pad, or any other communication means. The telephone registration method may include telephoning a hotline and providing the unique ticket identifier (e.g. the serial number) to a central system. In response, the central system issues a numeric code identifying specific numbered scratch boxes appearing on the scratch card. The issued numeric code is generated on the basis of the provided scratch card serial number. In this way two different scratch cards receive two different numeric codes, and the central verification computer has a record of which security features in the scratch boxes should be shown on a genuine scratch card with a particular serial number.

The user then removes the scratchable coating from only those scratch boxes identified in the received numeric code. This process of removing the scratchable coating uncovers one or more security features. On entry into the selected event, such as a musical concert or sporting event, the scratch card ticket may be introduced into an electronic verification system, such as one of many offline electronic verification booths not at the turnstiles of the event. The verification booth reads the serial number appearing on the ticket, in addition to reading the uncovered security features. Both the serial number and the uncovered security features are then forwarded for cross-referencing to the central verification computer. On positive verification, the verification booth may print a visually verifiable confirmation of the validity of the scratch card ticket on the ticket using any one of the aforementioned methods. For example, this may include ablating a visually verifiable validity status on the scratch card. The visual confirmation optionally provides a subsequent human ticket checker at a turnstile for example, a fast and simple means of confirming the validity of the scratch card. Such a system is convenient where the validity of a very large number of tickets must be verified, at minimum discomfort to the users, in a short period of time, without compromising the integrity of the verification process.

Alternatively it is also possible to implement a slightly less secure but still highly practicable solution in which ticket verification can be carried out in real time without slowing down ticket entry queue. The process is the same as has been described above up until the user gets to the selected event. At the event the user simply presents his ticket to a turnstile and is either verified and accepted or rejected. The difference over the known prior art is that a subset of the central computer's database which is relevant for that day, location and event is downloaded to a local server at the event site which controls all of the turnstiles. Each of the presented tickets is checked against that locally stored subset of the database to confirm whether the serial number and the uncovered security feature on the ticket match those stored in the subset database. On confirmation that they do match the ticket holder is permitted access to the event.

This process is much faster and secure than the prior art systems as the local database subset is relatively small and therefore quickly searchable whilst at the same time providing the additional level of security. Furthermore, this obviates the need to print anything on the ticket as the response is simply to permit access to the event.

The term ‘long-term’ as used herein is intended to cover a time period of greater than six months and preferably a period of 1 to 10 years.

Another embodiment of the present invention is directed to two independent but associated aspects of a solution to at least some of the problems described previously. The first part of the embodiment relates to the generation of a value document using low-cost printing techniques and the value document itself. The second part relates to the secure validation of the value document and the system used to implement that validation.

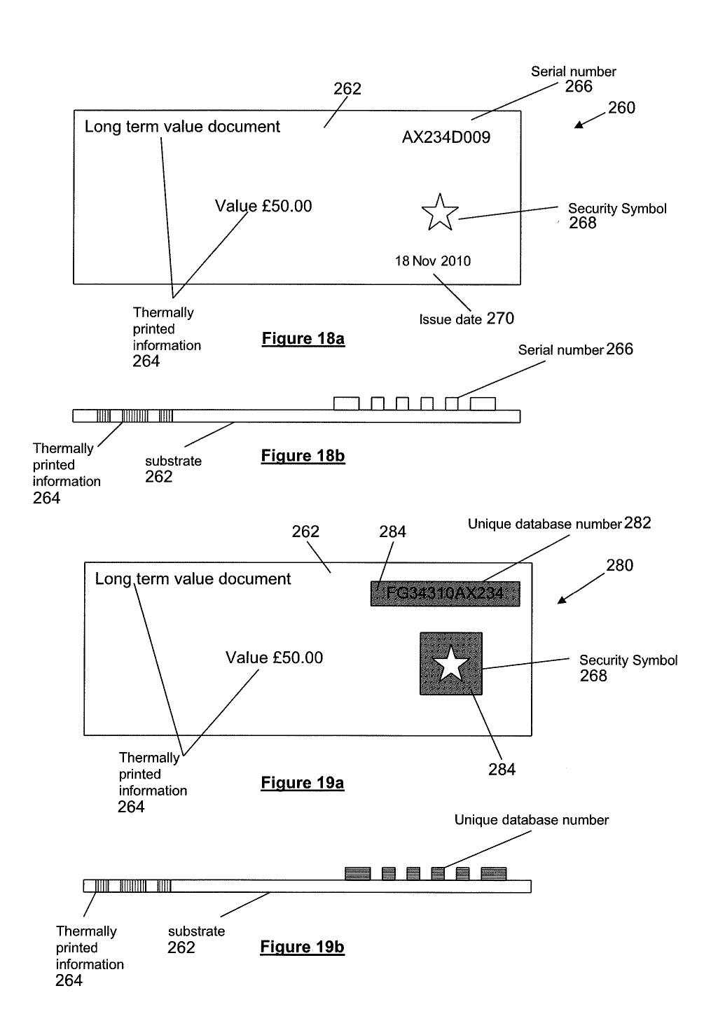

Referring now to FIGS. 18a and 18b, there is shown a long-term value document 260 produced by an embodiment of the present invention. The value document 260 has a substrate 262 on which is provided some thermally printed information 264 and also three security devices in the form of a serial number 266, a security symbol 268 and an issue date 270. Each of these security devices are printed in long-term ink (namely a durable ink which has a long life property of over 10 years).

The substrate 262 is of low cost and low quality, typically being comprised of thermally sensitive paper, on which information can readily be provided by exposure to a heated thermal print head. This makes basic cost of printing of information and the print equipment itself relatively inexpensive. However, the information 264 printed by means of the thermal print head only has a short lifespan of around 6 months or less if subsequently exposed to high usage and/or wear and tear. Nevertheless as the information required for authentication of the value document 260 is provided in long-term ink, these security features 266, 268, 270 are still readily readable in the long-term once the other thermally printed information 264 has faded.

The long-term ink may also comprise a colour-shifting ink which adds an extra dimension of security.

Referring to FIGS. 19a and 19b, a second long-term value document 280 produced by another embodiment of the present invention is shown. The second value document 280 is very similar to that of the first value document and so only the differences are described herein. The first difference is that in place of the two security features of the serial number 266 and the date of issue 270, there is provided a single unique database number 282. This database number 282 provides a key which can be processed to obtain a unique address within a database as will be described in detail later.

Another difference is that both the security symbol 268 and the unique database number 282 are created as stencils within respective printed blocks of long-term laser-ablatable ink 284. The advantage of this is that the printing procedure is simplified in that printing a block of ink to a substrate is fast and relatively inexpensive compared with the alternative of printing on the long-term ink using a conventional print head. The laser ablation can readily be carried out by use of a relatively low-cost laser diode. Furthermore, when the long-term ink is applied in a block to a region of the substrate and comprises a colour-shifting ink, the colour-shifting effects of the ink are more pronounced to the viewer as there is a greater area of ink provided on the substrate.

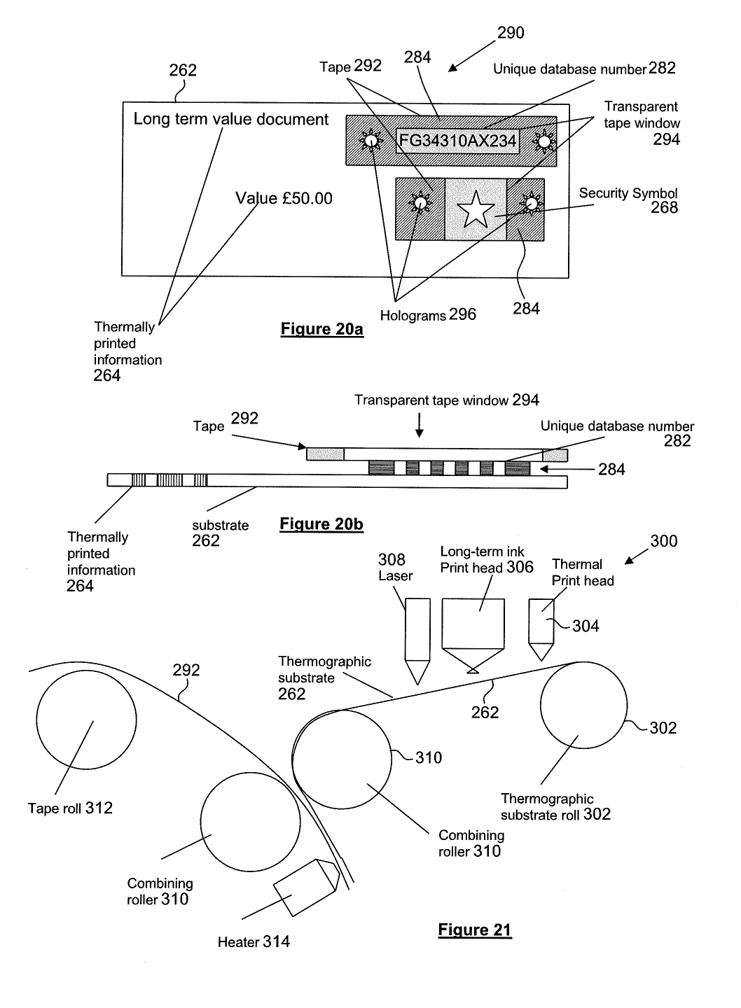

Referring to FIGS. 20a and 20b, a third long-term value document 290 produced by another embodiment of the present invention is shown. The third value document 290 is very similar to that of the second value document 280 and so only the differences are described herein.

The main difference is that the third value document 290 provides visually-verifiable security features which do not necessarily require an authentication procedure to provide a degree of comfort in the authenticity of the value document 290. The enhanced security features are provided by the application of a tape layer portion 292 over each of the existing security symbol 268 and unique database numbers 282. The tape layer portion 292 has a transparent tape window 294 which allows the unique database number 282, in one instance, to be visible to the observer of the value document 290. In the another instance, another tape layer portion 292 over the symbol security feature 268 also has an appropriate transparent window 294 which allows viewing of the symbol 268. In both cases, the tape layer portions 292 each are provided with holograms 296 within their tape structure. These holograms 296 provide a form of security against copying. Also the tape layers 292 are provided after ablation of the security feature 268, 282.

As an alternative to the application of a tape layer portion 292, a quick-drying liquid-plastic layer or a foil can be applied. Furthermore, the tape layer portion 292 or the quick-drying transparent liquid plastic layer portion can have an anti-photocopying/scanning characteristic which enables the clear patch of the layer to show up as a marked region when scanned or photocopied. Also rather than using holograms 296 within the structure of the tape, it is possible to use other known security devices such as a foil device or a patterned tape for example. It is to be appreciated that whatever additional security devices are provided in the tape layer 292, the cost of this is far less than providing the same on the substrate 262 itself as in the prior art.

It is also possible in another embodiment for different or additional security features to be added. For example, the name of the person to whom the value document is issued can be ablated onto the value document 290 as can an image of the person. As an extra security measure, the substrate can have been treated with a clear quick dry liquid/ink/other chemical treatment such that when exposed to a photocopy scanner this clear patch shows up as marked.

FIG. 21 shows a schematic low-cost printing device 300 provided within a terminal 202 for creating a thermographic substrate with a long-term ink portion 284 and an overlying tape portion 292. A thermo graphic substrate roll 302 retains a thermo graphic substrate 262 with a preprinted long term ink strip (in a similar manner to that described previously with respect to FIG. 2, but on a smaller printer terminal scale). The terminal has a thermal print head 304 which prints the thermal print information 264 onto the substrate 262. The security features which are not to be formed in the preprinted ink strips 284, (such as the serial number 266 in FIG. 18a) are printed in long term ink via a long-term ink print head 306. the security feature which are to be formed in the pre-printed ink portions 284 are formed by action of a low-cost laser 308 (typically a laser diode). This formed substrate 262 is then manipulated into position for combining with a tape layer 292 via a pair of combining rollers 310. the other feed into the pair of combining rollers 310 is from a tape roll 312 which stores a roll of tape. The combined tape layer 292 and the formed substrate 262 are then subjected to bonding via a heater 314.

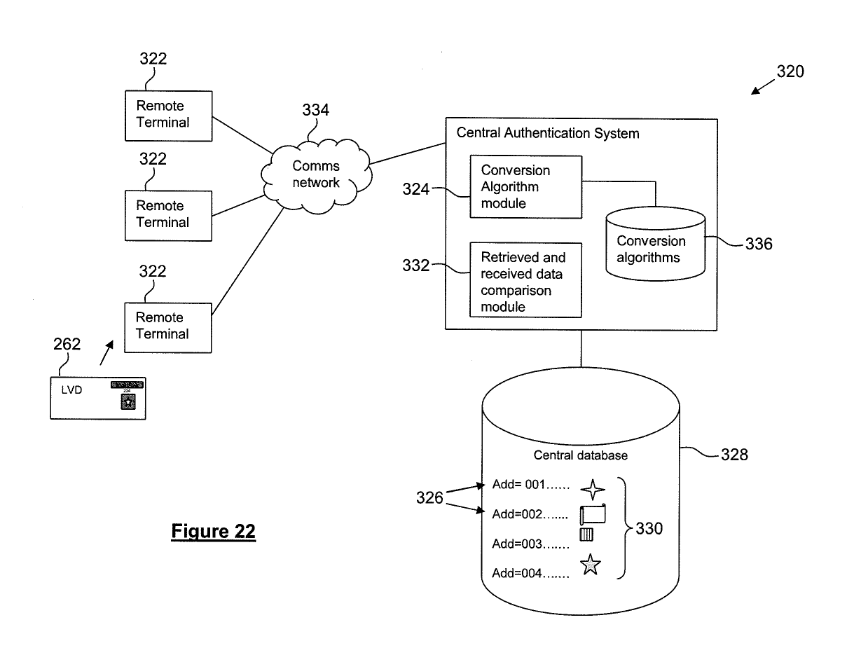

FIG. 22 shows an authentication system 320 of the present embodiment. This has been described in outline above, but includes a plurality of remote terminals 322 for use in authentication of the issued ticket (long term value document) 260, 280, 290. The issued ticket 260, 280, 290 has also been described above, though the present invention is not restricted to use of this. The authentication system 320 comprises a conversion algorithm module 324 which takes data uploaded to the authentication system and converts it into a unique address 326 in the central database 328 at which a data file with the correct symbol 330 is provided. The correct symbol 330 is retrieved and sent to the retrieved and received data comparison module 332 where it is compared with the originally received data. If there is a match, then an authentication signal can be generated and sent back via the communications network 334 to the remote terminal 322. However, if the symbols don't match, a non-authentication signal is sent instead. It is to be appreciated that a plurality of conversion algorithms 336 can be provided at the central authentication system (server) 320.

Receipt of the authentication or non-authentication signal at the terminal 322 can either be displayed on a visual display unit of the terminal 322, printed out on a slip or indicated by a driving some response indicating display such as a red/green light or a virtual voice indicating acceptance or not of the ticket. Also the authentication signal can be used to open a turnstile or provide access in some way to an event for example. Alternatively, any goods associated with the ticket can then be released to the ticket owner as a result.

Preferably both the ticket security and the authentication security as described above are provided together. The security would be covert to the human eye in the printed ticket under the tape and covert by reference to the database for validation by examination of the covert association between the features of the ticket. The symbol security is provided by the range of potentially infinite and unknown characters that can be used, i.e. the symbol 268 could not by computer data analysis reveal the covert algorithm which linked the open features of the ticket (name and/or serial number) with a concealed file on the central database with the correct authentication symbol in it.

As variation of the above, it is possible for the above method to be used to render extra security in any value documents where the seller wanted to associate the certificate/receipt/ticket with the buyer. This could be where either expensive security features had been previously added to the substrate and extra personalized security could be added at the point of sale not only with name/serial number/symbol but in the case of short-life instruments a quick visual check on a ticket e.g. a face of the purchaser in black and white by the ablation method described above. In this case the purchaser could upload an image of himself/herself either with the help of the seller with a scanner or by a buyer-supplied photograph and this would be ablated onto the ticket as a black and white image for a quick human check at a turnstile. An automatic turnstile would only have to check the date or some small numerical attribute with the signal. This would be useful when the seller doesn't want further transfers of title of the instrument by the original buyer without his involvement.

Referring back to FIGS. 20a and 20b, protection against reproduction of the ticket (value document) 290 itself by photocopy is provided when it is required for the ticket to be bearer only, i.e. not having any personal information about the purchaser on it. In this case, it is also possible to apply the cheap plastic strip as tape 292 to the thermographic strip. The laser can then ablate the symbol 268 referred to above from the ink-covered plastic strip/Sellotape® etc. In this way when photocopied, the feature would be replicated on paper as opposed to being a missing bit on a stencil type effect on tape rendering the ticket invalid and detectible as false by the human eye even before scanning by terminal 322 and connection to central server 320 for validation by algorithmic comparison.

This is an additional way of building security for banknotes and all forms of value documents as well as enabling thermographic printers to produce secure financial instruments at point of sale. This is because the security would be twofold—the authentication procedure using various conversion algorithms and the symbol and/or name and/or serial number as a stencil under the tape/plastic covering this tape. The security would be covert to the human eye in the print etc under the tape and covert by reference to the database for validation by examination of the covert association between the features.

Described below are further aspects and embodiments of the present invention which are directed to other inventive concepts.

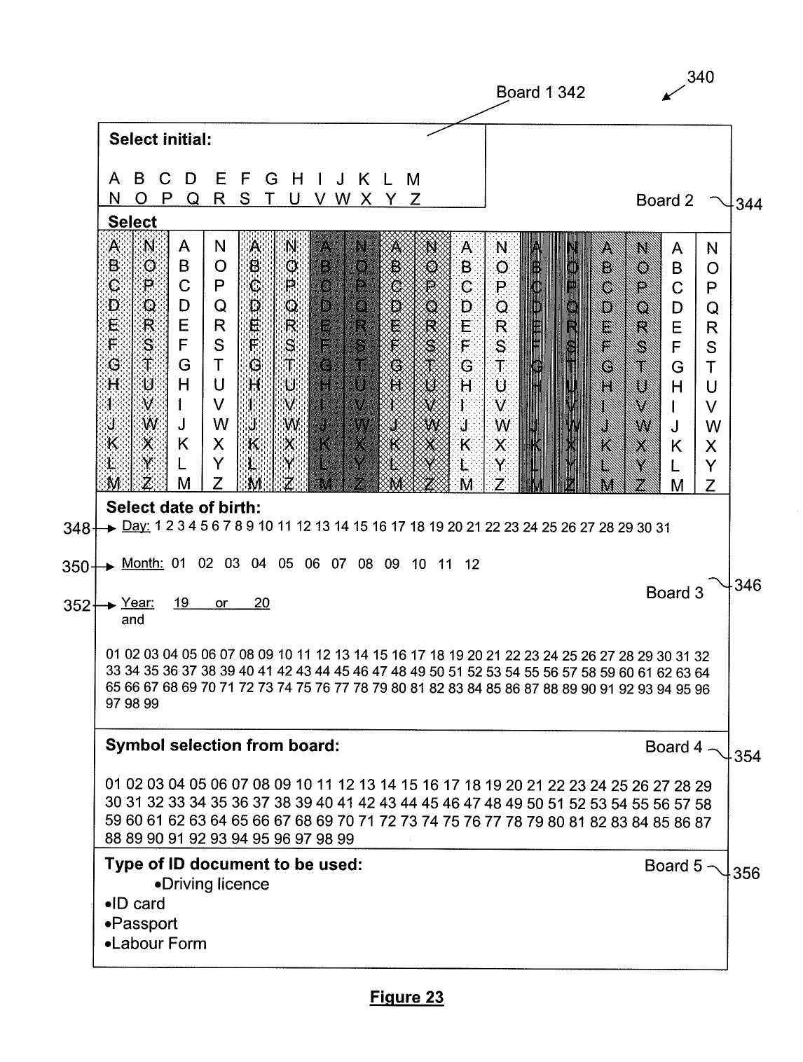

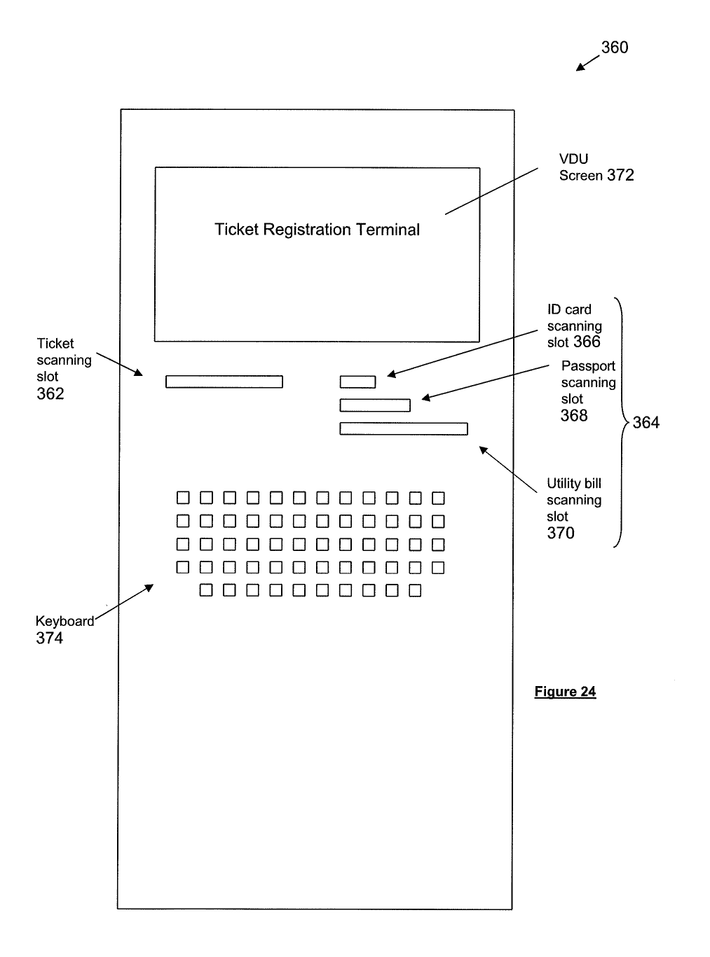

Referring to FIG. 23, the process of purchasing and authenticating a transaction ticket/slip is now described.

### Step One.

A customer walks into retailer and fills out transaction slip 340 (shown in FIG. 23). The transaction slip 340 has five boards each with a different function for KYC (Know Your Client) money laundering purposes. The first board 342 has letters A to Z, the second board 344 has letters A to Z, the third board 346 has numbers split into three sections, section one 348 numbered 1 to 31 (for days), section two 350 numbered 1 to 12 (for months) and section three 352 for year. Section three 352 of board 2 is split into three columns, first column 19 (century), second column 20 (century), third column numbers 1 to 99 (year in century). The fourth board has numbers 1 to 99 or a list of numbered symbols.

The whole process is designed to take less than 30 seconds. In use, customer circles a letter in board 1 corresponding to an initial of his first names. He then circles a letter in board 2 corresponding to the first letter of his surname. He uses board 3 to select the day, the month and the year of his birth or alternatively just the month and/or the day or the month and/or the year or some combination of one or more of month or day or year. Board 4 may either have symbols in it printed on the paper or may have numbers which would correspond to a either a printed large board with symbols displayed used as a display or symbols flashed up on a VDU. In this latter case the customer would pick his symbol and this would be displayed next to a number so all he has to do is tick the number corresponding to the symbol that he has picked.

In the fifth board 356 there are written identifying descriptions of ID documents, namely i.e. driving license, passport, Labour form etc. The customer ticks the type of ID document he or she is going to use at the second stage of the KYC authentication process which would take place at another location.

Optionally, there can be a sixth board listing a number of charities by name. The customer would be required to tick one of the charities to nominate that charity for his investment ownership to go to if he doesn't fulfill the second stage of the KYC authentication process or fails the second stage of the KYC authentication process.

The fifth and six boards are simply tick boxes with names next to them displayed somewhere on the transaction slip.

As an alternative, there may be a minimum selection area or areas allowing for the selection of a symbol plus a year or a day or a month or some combination of one or more of month or day or year plus a charity from a list of supplied charities. This selection may be made manifest by direct reference to this information as printed on a transaction slip where the customer ticks the item or covers the item with pen ink or pencil or ballpoint pen in such a way as to be obvious to a scanner. In addition, this selection may be made by reference to selecting numbers on the transaction slip relating to numbered items on a public or private visual display unit or a public or private printed display.

Step Two.

The transaction slip is scanned either at a manned terminal or at an ITVM (instant ticket vending machine). In the case of an ITVM there is a visual display unit which displays the numbers selected by the customer and other relevant information and provides the customer with the opportunity to correct the data entry if it is wrong.

In the case of a manned terminal, an ordinary lottery style ticket is issued with the transaction number linking the short-term prize event and the long-term event in the same way as described in our co-pending patent application no WO 2009/019612 and including symbol information as set out in our co-pending patent application WO 2010/086827.

This completes the purchase process and the first stage of the KYC authentication process.

Step Three.

At a different location the customer takes his prize draw ticket and goes to an automated registration machine 360 which includes a scanner see FIG. 24. Here the customer puts their ticket into one scanning slot 362 and their ID document into another scanning slot 364. Typically there are four slots: one slot for the transaction ticket 362, a second slot for a credit card-sized ID document 366, a third slot for a passport-sized ID document 368 and a fourth slot for a utility bill-sized document 370. It would also be possible to have these ID document slots combined into one long slot which can accommodate any of these different sized documents. The four slots referred to above could also all be combined into a multi-function single scanning slot designed to cope with different forms of transaction ticket, ID document and utility bill such that the prize draw ticket containing the financial instrument information etc would also be scanned in it.

A VDU screen 372 provided as part of the registration machine then displays a plurality of symbols for the customer to pick to confirm that they the same customer that purchased the ticket. The user makes his or her selection using the keypad 374 of the machine. Alternatively the VDU 372 can be a touch screen and the user can simply touch a selected symbol. This machine resembles an airline style check-in machine and uses similar automation and check systems as for an ordinary lottery ticket verification, to verify the customer.

At the first instance of this customer creating his registration entry, a unique transaction number which will be his unique account number corresponding to the customer name, birthdate and symbol is created such that if at any future point he or she buys a ticket related to the Steps 1 to 2, this transaction will be recorded in a general file (not shown) provided at the central authentication computer 320 (see FIG. 22) corresponding to the unique transaction account number entry for all his transactions.

The customer will, however, unless using the process outlined two paragraphs below, have to carry out the KYC authentication process for subsequent tickets with the same ID document as used before. This is because the customer may change their symbol and, in effect, the authentication system treats this as a transitional account, until the customer carries out the KYC authentication process and the transaction is tied to the pre-existing unique transaction number (and hence his general file). This unique transaction number is different to the transaction number on the lottery ticket, and effectively acts as the customers personal account number.

At the first instance of the second stage of the KYC authentication process for this customer carrying out the KYC process (for the first time), the authentication system creates a unique transaction number which effectively is the customer's file and/or account number at an issuing bank. This transaction number is a permanent account number for this customer with name ‘X’ and birthdate ‘Y’. Any future transactions that the customer carries out, which require a KYC authentication process at the second stage, will be logged to this bank account such that both the bank and the customer can access this information. The customer is allowed access this information by entering his name birthdate and his permanent symbol. The permanent symbol in his case will be the first symbol he ever picked. The customer is permitted to pick different future symbols for individual transactions but must always remember their first symbol to access the permanent account.

The unique transaction number can be printed by a long-term method as described above and the customer will merely scan this document together with any new tickets purchased at a second stage of the KYC authentication process.

The above process has a number of potential additional problems which can be resolved by the following embodiments described below.

Longevity of lottery ticket can be solved by having a unified lottery ticket and scratchcard whereby the remote terminal (which can be an ITVM) prints out a serial number and the customer has to scratch off the serial number first before scratching off the panels that he feels could be the winning panels for the scratchcard element. He can then as an aide memoir scratch off a section corresponding to his lottery draw numbers. The printout of the ticket from the ITVM, which he then uses to scratch off the serial number from the scratchcard, is described below.

The ITVM can print a receipt number corresponding to a one-off transaction number as per the ordinary lottery application and the customer can then scratch this out on the relevant panel of the scratchcard. The ITVM can also have a start serial number and an end serial number for the scratchcard which are used for an accounting function. This enables the preprinted serial number on the scratchcard to be linked to the transaction number in some way such that when this scratchcard is scanned in the second stage KYC process, the preprinted serial number and the scratched out new transaction number can be linked and subsequently examined for links registered on the central system so that the card is known as genuine.

It is also possible to have within an ITVM (or other remote vending terminal) a laser which includes a burn-off function which means that the customer doesn't have to scratch off the relevant numbers this is carried out by the terminal. All the user has to do is select their draw numbers.

One of the problems with a scratchcard will be to preserve it so that extra elements aren't accidentally scratched off. This is overcome by having a plastic peel back element of the card such that effectively two pieces of plastic have an element of glue in them and one piece is pulled away rather like a Band-Aid. This clear plastic is then folded back over the card by the customer to give total protection after he's done his scratch off so that the card now can't have extra elements scratched off.

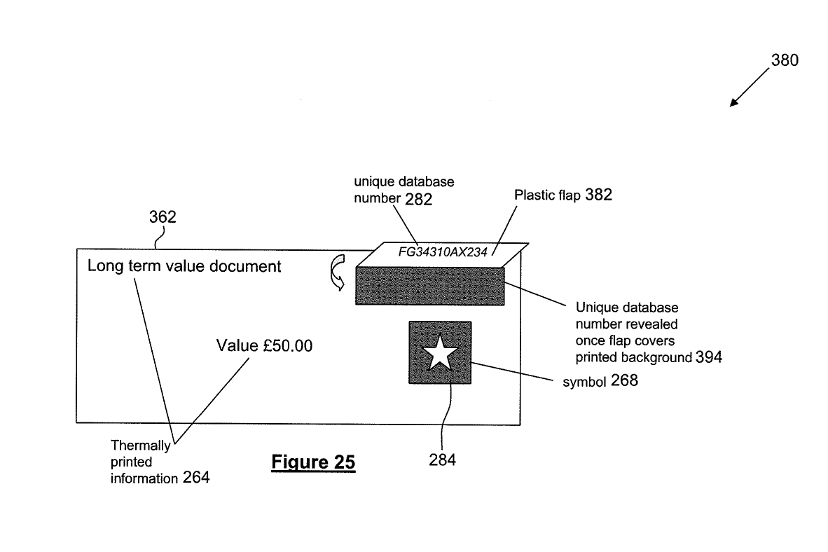

This extra plastic piece can be non-clear plastic such that a laser burns the relevant number straight through the plastic then the extra layer is stripped off and the plastic folded back over an area which has a coloured ink showing through it. This would enable a scanner to scan the area with the stencil cutout of the plastic and the fold back. Under this variation, part of the plastic could be clear to cover the scratched off elements for safety and part of the plastic could be unclear so that when the laser burns the number through in the ITVM and the customer folds it back, that becomes the identification number similar to that of a lottery ticket (see FIG. 25 and description later).

At the second stage of the KYC authentication process, the new permanent transaction number may be given to the customer using a thermographic paper and a permanent ink printing approach as has previously been described, so either on the existing thermographic slip or on a thermographic role which has a semi-permanent edge on which is printed the transaction number (that is effectively the permanent account number) as opposed to the transaction number on the ticket itself which can degrade.

Set out below is a user process for purchasing a multifunction ticket, or a prize draw or lottery ticket or even a secure transaction ticket. The process is relatively smooth, inexpensive and most of all quick. This latter point is important as it is important that the process does not detract or act as a bar to an impulsive purchase.

In this embodiment, the customer picks a symbol and constantly use that very same symbol for all subsequent transactions. Unlike the previous embodiments, this presents a security problem which can be partly mitigated in that the symbol is crossed out (such that it cannot be recognized) on the transaction slip and when the machine scans it, it registers the symbol by seeing the crossed bit out that is missing from the array of symbols. However, if a bank of 10 lines of symbols is considered with each line having several symbols in it, then if the symbol picked by the customer is always in the same place on the transaction slip this presents a security risk as anybody seeing the transaction slip, which is usually retained by the customer, effectively knows the symbol by comparison to a unscratched transaction slip.

If instead the symbols are displayed on a VDU and referred to the symbol by a number next to the symbol flashing on the VDU such the customer picks the number on the transaction slip, this process moves away from the impulse sale because now a 1000 symbols have to be displayed either in the same place at once in which case the number reference will always have the same problem i.e. anyone looking at the number only needs to go look at the VDU board to work out what the symbol is, or we could display the same symbol and constantly change the number requiring the customer to pay a tremendous amount of attention to the VDU board again moving away from a simple process.

The whole requirement for simplicity and the facilitation of an impulse sale pushes for the same set of symbols always to be printed on the transaction slip and the customer to pick it by scratching it out with a pen. Here the term ‘scratching out’ is not applying the method of a scratchcard, but rather scribbling out the symbol similarly to a pen method often applied to a lottery slip. If the print run moves the symbol to a considerable degree in the place on the transaction slip such that transaction slips printed with the same symbols have symbols in a markedly different position then there is a risk of the customer not being able to find the symbol and spending some time, getting frustrated and moving away from an impulse sale.

The solution is to move the symbol position within a given line, but to keep it within that line. By this it is meant that the symbol can be in a bank of say 10 symbols for example within each line and there are 10 lines of symbols (i.e. 100 symbols). In this case the customer's regular symbol in the first line was at position two in some transaction slips then it could be in position three, in position four, in position five etc in other transaction slips. However in each printed transaction slip the user's symbol always appears in the same line but just in different places. Moreover these lines could be numbered so the customer need only remember his symbol is in line 9.

If the number of symbols in a line of symbols is something of the order of 10 to 15 in a line, it increases the difficulty for a person who has not got hold of the now non-standard transaction slip to guess the symbol simply by sight of someone's transaction slip unless he is prepared to stand around holding 15 transaction slips and risk being caught for exhibiting suspicious behaviour. Conceptually as the lines have been numbered it would be possible to keep the symbol within the same line by number but vary the print order so line 2 gets printed first at the top of the row and line 4 next etc. This would multiply the variations considerably.

In addition, customers could be encouraged, once the transaction slip has been run through the machine, to destroy the transaction slip or to keep good hold of it. The moving of the symbol within a position in the line of 10 symbols would mean the customer only taking miniscule milliseconds to find his favoured symbol and scratch it out, but in the combination with the encouragement to keep safe and/or destroy the transaction slip, would significantly reduce an oversight risk of someone knowing the symbol which would increase as the customer now regularly would have to use the same symbol.

Conceptually, instead of returning the transaction slip to the customer following scanning and production of the ticket, the ticket itself can be provided with the prize draw numbers printed. The customer then only need correct any mistakes in the prize draw numbers at the terminal and thence keep only the ticket to make future purchases by scanning in the ticket to enter draw numbers in future draws. In this case the security information of the symbol is now not present on the ticket except covertly in the transaction number, as the transaction slip is destroyed either by the operator or by the machine itself, though preferably by the terminal machine itself.

A laser function can be provided in the terminal so the symbol and personal details such as birthdate section is in laser-sensitive ink on the transaction slip and after its reading by the terminal, the whole section of symbols and personal details can be ablated by the terminal (equivalent to being manually scratched out). Alternatively, the transaction slip can be overprinted with ink or shredded by the terminal.

In another embodiment, the transaction slip, where it has had the sensitive elements removed, becomes the ticket such that it also has the transaction number of the ticket cut into laser sensitive ink by use of a laser as described above. This is created using a stencil covering the substrate. This transaction number can be used for future purchases. However, crucially the sensitive information of birthdate and symbol has been removed from the ticket.

This methodology of the same symbol coming up in the same line seemingly in the same place, with a slight variation as to position in the line, can also be applied to a VDU button screen placed on a ITVM.

The importance of this is that rather than putting a scanned sheet into an ITVM, a customer only needs his favoured symbol. In one embodiment, where the customer picks a symbol and their birth year, this is a two button hit which is potentially quick enough to include as an automated VDU and pushbutton automated entry system on a ITVM or conceptually a touch screen VDU with symbols in one part and a birth year display of zero to 99 in another. In the case of the VDU touch screen, the problems associated with comparing the random variable transaction slips, which are provided on paper and which have a limit to the amount of variations one can make, disappears. The variations are limited because if one exceeds 15 characters in the line it becomes difficult for an eye scan to quickly locate the relevant symbol. In this embodiment, the actual line into which the symbol goes is not being changed as this would present a search requirement for the customer going beyond a quick impulse purchase. In this embodiment different ITVMs would have the symbol in a different order within the same line so as to allow the eye of the customer to easily find it, but again if anyone is shoulder surfing (unscrupulously overlooking the customer data entry) they would not be able to workout which symbol was picked.

Below is described a complete process of a customer interaction with the system of the present embodiments. This covers a new customer and then at a later stage that customer receiving a single account number which becomes his permanent ID number. This number is given to them in some form for automated use elsewhere, but they will have to know and use the single symbol throughout these events which is associated with the single account number. Also because the customer may not carry their card with them and be making a purchase from new, this process provides the ability to retro link the new purchase with the customer's existing account number by an automated process at a later date which is linked because of the symbol.

### Process

A new customer goes to a remote prize draw terminal and picks draw numbers in a conventional manner within a given prize draw, i.e. he will tick the box marked as this week's prize draw. This given prize draw will correlate with a future date of redemption in the long-term at which point the customer is entitled to redeem his investment/capital according to the redemption rules pertaining to the investment, having potentially received returns on his investment/capital during the investment period. Thus the transaction number will contain both the short-term event i.e. the prize draw number details and the long-term event i.e. the date of investment liquidation/capital redemption. Substantially this is a long-term event at which point the investment in capital terms is returned to the customer. This is the subject of co-pending International patent application WO 2009/019612.

In addition the customer will have picked a single symbol, having been informed that this symbol will need to be his symbol thereafter for all transactions, and his year and/or month and/or day of birth as a two numeral item or a four numeral item or a six numeral item. This symbol and birthdate (either in full or in part) will be associated with the very same transaction number that also includes the short-term event and the long-term event. This is the subject of co-pending International patent application WO 2010/086827. This single transaction number on the lottery ticket includes therefore four pieces of information apart from the date, the time, the terminal number etc. These pieces of information are the symbol, the birth year (personal information), the draw number and the long-term date which capital redemption in some form can take place. This forms the first part of the KYC authentication process.

At a different place to the first purchase and first step of the KYC process, the second part of the KYC authentication process takes place. Here the customer puts his transaction ticket into a scanning slot along with his ID document (as has been described previously). Now the symbol is verified on-screen as is the birthdate, the draw numbers and the long-term event. This provides an entry in a file at the authentication system which has a single permanent transaction number, effectively a unique account number, which is now associated with the symbol and the identity of the customer. Someone entering the transaction number at some further point in conjunction with the name and or further personal information plus the symbol, the symbol being all important as it is the one piece of information which no one can conceptually guess about the customer, will be able to access or use that unique account number.

Here the symbol is being combined together with the name and or other personal information at the second stage and thus contacts the central authentication system. The name and/or other personal information has been validated by the scanning of the ID document, with the obvious possibility that that ID document can be quizzed with its issuer by a separate remote database query.

This second part of the KYC authentication process has created a user account file with an account number into which, at the first event of the second stage of the KYC authentication process (when this new account number is created) is entered the draw numbers. The user account file also significantly stores the redemption date, effectively the series reference which pertains to the investment which will be carried out as a block. This means that for example the system will know that a customer A with an account number 111 has series Alpha investment which can be redeemed in 2030 and as the bulk Alpha investment generates an agglomerated performance, the system can download as subdivided individualized performance information to the associated accounts for Alpha.

The automated registration machine (described above with ref to FIG. 24) also has a printing ability such that it can produce a bar coded and number printed card. The card reproduces the now permanent single account number which governs the customer and his first purchase. This number and a barcode is scanable by the point-of-sale lottery terminals where the first stage of the KYC process takes place so that any future purchase can automatically get credited to that account.

However, it has to be assumed that either the number and barcode may denigrate as they are typically printed on a thermographic paper substrate and therefore, barring the above described long-term printing solution on thermographic paper, this number and barcode may be unsuitable for scanning at some point, or indeed the customer may have forgotten to carry this card with him when he is at a future purchase point. At this future purchase point, he need only repeat the same process as before, namely pick symbol and birth year and draw number etc, but then crucially all he need do is for the second part of the KYC authentication process in another place at a similar, or exact automated machine, scan in his ticket and his barcode/account number card, which he can now have located because this is a second stage non-impulsive process, but he need not produce his ID documents as they have already been verified. He may also key in the numbers of his account number which he has recorded manually in a more permanent fashion than thermographic paper

This can be carried out at an Internet website, on his own computer or at a publicly available computer with Internet connectivity (possibly in the bank to have some security so it would be on an intranet), or even using the slots or keyboard on the aforementioned second KYC authentication process terminal. At any of these locations the customer would simply enter in the transaction number of the new ticket and the single account number which he was issued at first purchase of the second stage of the KYC authentication process. The Internet website will give him a choice of names birthdates and symbols and by selecting it he will have effectively verified that he really is who he says he is. This means that the process for someone who as forgotten his card with his permanent account number or has had his card denigrated such that he would need to reissue one, will be remarkably simplified compared to the second stage of the KYC authentication process for a first-time customer.

The requirement for a customer to have a verified address, would be answered at the second stage by reference to a name, birthdate and other information, with the customer also now picking the utility provider allowing the system to automatically interrogate utility providers databases for an address confirmation. This is in case, the ID document doesn't have an address built into it. Also the system can handle a HAM reference which will means that although there isn't an address, the customer is classified as a Hold All Mail (HAM) customer and may be required to provide some form of address proof at a later stage. However, the customer will be regarded to have passed the KYC authentication process only but will not be able to effect actual payments or returns of money until they have provided an address which has been verified.

Many of the countries have a person on a relevant utility database such that the customer may only have to select the relevant provider utility and the district to be able to without the benefit of his ID document, actually confirm his address to record it in the account data file on the authentication system with an automated process. Indeed the customer may have an address database with the government/ministry of interior/labour ministry/post office. He may even may be able to enter a post code as sufficient to identify that database entry.

If the ITVM machine has a way of telling the serial number of the scratchcard then it will print the thermographic lottery ticket with a lottery number (technically the transaction number) with a transaction number printed in the normal way on the ticket. The ITVM terminal can also print on the ticket a separate box related to the serial number to be scratched off the card. Namely the customer will have been informed that to make the scratch card valid, he has to scratch off the panes that are related to the information in the box.

This information printed on the lottery ticket can refer to the relevant panel by number reference or can contain an actual symbol or rendition of the picture/image/symbol printed on the scratch card. Under this is one or more is the instant winner designation panels which are revealed by the scratch off action.

If the scratch card is being sold as an additional product to the lottery ticket at a retailer point of sale, the serial number then a number to be scratched off will relate to the retailer's ID. This is because it would already be known which series of serial numbers were sold at which retailer, namely not the individual number but the series (batch) of numbers.

This will be useful as some scratch cards will derive their prize funding from the main lottery (or prize draw) ticket percentage of sales sent to smaller prizes and some will derive from promotions and will be used by supporting goods and service vendors as loyalty cards and purchase incentive cards (for example those with a scratch card can get a discount on goods etc purchased). However, there will be an accounting need to tie a generic game scratch card to an individual promoter hence the requirement for a scratch-off number tie in.

The lottery ticket can have a box for which promotion you want to tie up to e.g. ‘Curries’ or ‘Harrods’ which is exercisable on a generic game card which hasn't been pre-designated to the promoter.

FIG. 25 shows a further embodiment of the ITVM generated ticket. This embodiment is provided for the situations where the ITVM cannot read a serial number of the ticket and thus can be used to retrofit existing ITVMs.

Here the ticket (value document) 380 comprises a folded over piece of plastic (a plastic flap) 382 for providing the unique database number 282. The plastic flap 382 is attached to the substrate 262 by glue or by known thermal bonding techniques. Thermal techniques are also used to form the unique database number 282 in the plastic flap 382. In use, when the plastic flap 382 covers a printed background area 394, it acts as a stencil and the database number 282 can be readily determined.

The above described embodiments are provided for illustrative purposes only and would not appear to be considered limiting to the skilled addressee. Furthermore, alternative embodiments related to any combination of the above described embodiments are envisaged and fall within the spirit and scope of the present invention.

1. A method of creating an optical security element in a value document using a low-cost printing device of a data processing terminal, the method comprising:
providing a flexible substrate having a pre-printed ink portion; wherein the pre-printed ink portion is provided in an unexposed state which does not provide an optical security function of the security element;
configuring a variable laser irradiation device to determine a part of the unexposed pre-printed ink portion to be exposed to laser radiation in a machine-controlled manner; and,
exposing the unexposed pre-printed ink portion to laser radiation in the machine-controlled manner to create from the pre-printed ink portion a predefined pattern, wherein the optical characteristics of the pattern provide the optical security element.

2. The method of claim 1, wherein the exposing step comprises exposing a layer of the value document at an irradiated location above or below the unexposed pre-printed ink portion such that the pre-printed ink portion is optically exposed at this irradiated location.

3. The method of claim 2, wherein the exposing step comprises creating a stencil within the layer of the value document above or below the pre-printed ink portion.

4. The method of claim 1, wherein the exposing step comprises irradiating portions of the pre-printed ink portion to create the predefined pattern from within the ink portion.

5. The method of claim 4, where in the pre-printed ink portion comprises an Electromagnetic-sensitive colour-shifting ink or optically varying ink (OVI) or optically varying magnetic ink (OVMI).

6. The method of claim 4, where in the pre-printed ink portion comprises an electromagnetic-sensitive metallic layer.

7. The method of claim 6, wherein the value document comprises a metallic layer adjacent the pre-printed ink layer and the step of creation of the stencil within the ink portion exposes the metallic layer as part of the optical security element.

8. The method of claim 7, wherein the pre-printed ink portion comprises a plastic strip portion containing a reactive ink, the plastic strip portion having predefined areas of weakness and the exposing step comprises exposing a selected plurality of the predefined areas of weakness to laser radiation causing the ink to leak from these irradiated areas of weakness out of the plastic strip onto an adjacent layer of the value document.

9. The method of claim 8, wherein exposing step comprises perforating the plastic strip portion at a plurality of predefined locations to create the predefined pattern.

10. The method of claim 9, wherein the pre-printed ink portion is optically reactive when exposed to the atmosphere, and the exposing step causes the pre-printed ink portion at the location of the pattern to change in its optical characteristics.

11. The method of claim 1, wherein the pre-printed ink portion is provided on a first face of a substrate and the exposing step is carried out on a second face of the substrate, such that the security element created has different optical characteristics when viewed from the first face of the substrate and the second face of the substrate.

12. The method of claim 1, further comprising providing an upper and a lower light transparent covering layer over the pre-printed ink layer, the upper covering layer being transparent to the wavelength of the laser radiation and the lower layer being sensitive to the wavelength of the laser radiation, providing a reactive chemical layer between the upper and lower covering layers, and the exposing step causing ablation of the pattern in the lower covering layer thereby releasing the contents of the chemical layer onto the pre-printed ink layer to form the pattern in the ink layer.

13. The method of claim 12, wherein the exposing step releases the contents of the chemical layer causing a chemical reaction with the pre-printed ink layer in the vicinity of the exposure to create an area of the pre-printed ink portion where the pre-printed ink is not visible.

14. The method of claim 1, wherein the pre-printed ink portion comprises two layers of ink, the lower layer of ink having a wavelength shifting property which absorbs light at a first wavelength in a non-visible electromagnetic spectrum and transmits light at a different wavelength in a visible part of the electromagnetic spectrum.

15. The method of claim 14, wherein the lower layer comprises a electromagnetic-radiation resistant ink and the upper layer comprises a electromagnetic-radiation sensitive ink.

16. The method of claim 1, wherein the exposing step creates a pattern of characters having a non-adjustable font.

17. The method of claim 1, wherein the providing step comprises providing a low-cost thermographic paper substrate and the method further comprises printing on the thermographic substrate using a thermographic printer.

18. The method of claim 1, further comprising heating the substrate to cure the ink layer prior to issuing the value document for use.

19. The method of claim 1, wherein the method is implemented on a print terminal where the terminal is selected from the set comprising: a lottery terminal, a kiosk, a bank terminal, a point of sale terminal, an automated teller machine, a cash register and an instant ticket vending machine.

20. The method of claim 19, wherein the security element is a validation identifier and the method further comprises reading a pre-printed serial identifier provided on the substrate and deriving from the serial identifier the validation identifier to be exposed in the pre-printed ink portion using machine-stored information provided at the print terminal or remotely at a central server that is connectable to the terminal.

21. The method of claim 20, further comprising providing a pre-printed series of characters under the pre-printed ink layer and exposing selected portions of the pre-printed ink layer to reveal characters which in combination make up the security element.

22. The method of claim 21, wherein the step of providing the pre-printed series of characters comprises providing a series of concentric bands of characters and the exposing step comprises revealing one character from each band.

23. The method of claim 22, wherein the exposing step comprises creating a visible link between each of the exposed characters to indicate the correct order in which the characters are to be read.

24. The method of claim 21, wherein the step of providing the pre-printed series of characters comprises providing an exposed set of registration marks for locating the relative positions of the series of pre-printed characters.

25. A data processing terminal for creating an optical security element in a value document, the terminal comprising:
a low-cost printing device comprising a variable irradiation device;
a module for providing a flexible substrate having a pre-printed ink portion; wherein the pre-printed ink portion is provided in an unexposed state which does not provide an optical security function of the security element;
a processor for determining a part of the unexposed pre-printed ink portion to be exposed to radiation in a machine-controlled manner; and,
a controller for controlling the variable irradiation device to expose the unexposed pre-printed ink portion to radiation in the machine-controlled manner to create from the pre-printed ink portion a predefined pattern, wherein the optical characteristics of the pattern provide the optical security element.

26. The data processing terminal of claim 25, wherein the irradiation device comprises a diode infrared laser or a low-cost ultraviolet laser.

27. A validation process for use with a value document comprising a machine-readable validation identifier and a machine-readable serial identifier on the value document, the validation process comprising:
reading the validation and the serial identifiers at a validation terminal;
using machine-stored information to determine a resultant validation identifier from the read serial number or a resultant serial identifier from the read validation identifier;
comparing the resultant validation or serial identifier with the respective read validation or serial identifier; and,
validating the value document if the read and resultant validation or serial identifiers are equivalent.

28. The validation process of claim 27, wherein the using step comprises applying a validation algorithm to the read serial identifier, the validation algorithm producing the resultant validation identifier.

29. The validation process of claim 27, wherein the using step comprises applying an inverse validation algorithm to the read validation identifier, the inverse validation algorithm producing the resultant serial identifier.

30. The validation process of claim 27, further comprising transmitting the read identifiers to a central validation server, using the read serial identifier to look up a corresponding stored resultant validation identifier.

31. The validation process of claim 27, further comprising reading further corroborative information provided on the value document and using the corroborative information to determine the validity of the value document.

32. The validation process of claim 31, wherein the further corroborative information comprises a date/time stamp provided on the value document at the time of its issue.

33. The validation process of claim 31, wherein the further corroborative information comprises a central database record identifier provided on the value document at the time of its issue.

34. The validation of claim 31, wherein the reading step comprises radiating the validation identifier with a predetermined wavelength of light and sensing a resultant different wavelength of light reflected from the validation identifier.

35. The validation process of claim 34, wherein sensing step comprises sensing a first wavelength of light reflected from a first ink layer of the validation identifier and a second wavelength of light reflected from a second colour-shifting ink layer of the validation identifier and analysing the spectrum of the sensed wavelengths.

36. A printing device for creating an optical security element in a value document, the device comprising:
a variable electromagnetic energy irradiation device:
a module for providing a flexible substrate having a pre-printed ink portion; wherein the pre-printed ink portion is provided in an unexposed state which does not provide an optical security function of the security element;
a processor for determining a part of the unexposed preprinted ink portion to be exposed to radiation in a machine-controlled manner; and,
a controller for controlling the variable irradiation device to expose the unexposed pre-printed ink portion to electromagnetic radiation in the machine-controlled manner to create from the pre-printed ink portion a predefined pattern, wherein the optical characteristics of the pattern provide the optical security element.

37. The printing device of claim 36, wherein the variable irradiation device includes at least one exposure stencil.

38. The printing device of claim 37, wherein the variable irradiation device comprises a plurality of fixed exposure stencils.

39. The printing device of claim 38, wherein the plurality of fixed exposure stencils are provided as difference faces of a rotatable drum.

40. The printing device of claim 39, wherein a plurality of rotatable drums are provided, each having its own electromagnetic radiation source.

41. The printing device of claim 38, further comprising a diffraction element for diffusing the radiation created from a radiation source to the plurality of different stencils.

42. The printing device of claim 36, wherein the variable irradiation device comprises a machine-controlled configurable stencil.

43. The printing device of claim 42, wherein the machine-controlled configurable stencil comprises an electronically controllable matrix of LCD elements.

44. The printing device of claim 43, further comprising a sensor for sensing at least one characteristic of the value document to be printed, and determining means for determining the quality of the value document based on the at least one sensed characteristic, the controller being operable to create the pre-defined pattern in the pre-printed ink portion in response to a positive determination by the determining means of the quality of the value document.

45. The printing device of claim, further comprising an image capture device for capturing an image of a user identifier and wherein the controller is arranged to use the captured image as at least part of the predefined pattern.

46. The printing device of claim 45, wherein the image capture device is arranged to capture a user signature and the controller is arranged to use the captured image as at least part of the predefined pattern.

47. The printing device of claim 36, wherein the variable electromagnetic energy irradiation device comprises a maser.

48. A long-term value document having a low-cost thermal priming substrate with portions thereof provided respectively with an independent identifier and a symbol in long-term ink on the low-cost substrate, wherein the independent identifier is related to the symbol in a machine-verifiable manner using data not provided on the document.

49. The long-term value document of claim 48, wherein the independent identifier comprises a date/time identifier and a serial identifier.

50. The long-term value document of claim 48, wherein the independent identifier comprises a central database record identifier.

51. The long-term value document of claim 50, wherein any of the identifiers are provided in a pre-printed long-life ink portion provided on the low-cost substrate.

52. The long-term value document of claim 51, further comprising personal information pertinent to the user of the value document, the personal information having been printed in long-term ink on the value document at the time of the document's issue.

53. The long-term value document of claim 54, wherein the personal information comprises an image of the user obtained at a value document issuing terminal.

54. The long-term value document of claim 55, wherein the personal information comprises a user signature, an independently verifiable user date, a user name or a part of a user name.

55. The long-term value document of claim 54, wherein the symbol comprises a visually-determinable defect which is detectable on machine reading of the symbol but which is not reproduced by implementing a photocopy procedure on the symbol.

56. The long-term value document of claim 55, wherein the long-term ink comprises an ink which is not reproduced by implementing a photocopy procedure on the value document comprising the long-term ink.

57. The long-term value document of claim 56, further comprising a visually-verifiable security feature, which does not require any authentication procedure to provide a general level of confidence in the authenticity of the value document.

58. The long-term value document of claim 57, wherein the visually-verifiable security feature comprises a tape layer portion provided over the identifiers.

59. The long-term value document of claim 58, wherein the visually-verifiable security feature comprises a quick-drying plastics layer or a foil tape layer portion provided over the identifiers.

60. The long-term value document of claim 59, wherein the visually-verifiable security feature includes a hologram.

61. The long-term value document of claim 60, wherein the document comprises a scratchcard.

62. The long-term value document of claim 61, where in the scratch card comprises a protective peel back sheet which can be configured to overlie and thereby protect unused scratch off portions of the scratch card once the user has scratched off selection portions of the scratch card.

63. A validation process for use with a value document comprising a machine-readable serial identifier, a machine-readable independent identifier and a symbol identifier on the value document, the validation process comprising:
reading the serial and validation identifiers at a remote validation terminal;
transmitting at least the serial and validation identifiers to a central validation server;
exposing the serial and validation identifiers to an address determining algorithm;
using an address determined by the algorithm to look up a validation symbol stored at the address location; and
enabling comparison of the validation symbol and the respective symbol identifier to enable validation of the value document.

64. The validation process of claim 63, further comprising validating the value document if the symbol identifier and validation up symbol are equivalent.

65. The validation process of claim 64, wherein the reading step comprises reading the symbol identifier, the transmitting step comprises transmitting the read symbol identifier to the central validation server, and the enabling step occurs at the central validation server.

66. The validation process of claim 65, further comprising using the validation identifier to select one of a plurality of address-determining algorithms provided at the central validation server and using the selected address-determining algorithm in the exposing step.

67. The validation process of claim 66, further comprising using the validation identifier to select one of a plurality of address-determining algorithms provided at the central validation server and using the selected address-determining algorithm in the exposing step.

68. A networked terminal for validating an issued value document, the terminal comprising:
a display screen for presenting information to the user;
a data input interface for enabling user input of input data;
a first scanner for scanning an issued value document to generate value document data;
a second seamier for scanning a machine-readable identity item verifying the identity of the user to generate user identification data;
a processor for collating user input data, the value document data and the user identification data into an authentication request message; and,
a communication means for transmitting the authentication request to a central server.

69. A method of creating a uniquely identifiable value document on one of a plurality of networked low-cost data processing terminals, the method comprising:
obtaining a unique terminal identifier of the data processing terminal;
using a unique terminal identifier of the data processing terminal as a first part of a serial identifier;
obtaining a second part of the serial identifier created by use of a number generating process;
combining the first and second parts of the serial identifier to generate the serial identifier of the value document; and,
printing the serial identifier on the value document.

70. The method of claim 69, wherein the obtaining step comprises using a random number generating process to create the second part of the serial identifier.

71. The method of claim 70, wherein the obtaining step comprises creating the second part of the unique serial number at the terminal.

72. The method of claim 71, wherein the obtaining step comprises using at the terminal a predetermined algorithm provided by a central server to create the second part of the serial identifier.

73. The method of claim 72, further comprising selecting the predetermined algorithm from one of a plurality of predetermined algorithms stored at the terminal.

74. The method of claim 73, wherein the selecting step comprises selecting the predetermined algorithm randomly from the plurality of predetermined algorithms stored at the terminal.

75. The method of claim 72, further comprising receiving from the central server the plurality of predetermined algorithms for use in the creating step, and updating the serial identifier generating process to use one of the received algorithms.

76. The method of claim 74, further comprising receiving a signal from the central server to select a particular one of the plurality of stored algorithms.

77. The method of claim 76, wherein the creating step comprises using user-entered data to create the second part of the identifier.

78. The method of claim 77, further comprising providing the user with an interactive data selection game and wherein the creating step comprises using data enter by interaction with the data selection game to create the second part of the identifier.

79. The method of claim 78, wherein the game comprises a ‘spot-the-ball’ game and the data entered by interaction with the game comprises grid coordinates.

80. The method of claim 78, further comprising providing the data selection game on a mobile device of the user and the terminal receiving the user-interaction data from the mobile device.

81. The method of claim 77, wherein the user-entered data comprises personal user identification data.

82. The method of claim 81, wherein the obtaining step further comprises obtaining a geographical regional identifier of the networked terminal.

83. The method of claim 82, wherein the printing step comprises printing a second identifier based on other information relevant to the networked terminal.

84. The method of claim 83, wherein the other information comprises at least one of a date/time of the printing step and a geographical regional identifier of the networked terminal.

85. The method of claim 84, wherein the obtaining step comprises receiving at the terminal the second part of the unique serial number generated by a central server.

86. The method of claim 85, further comprises converting the created serial identifier into an encrypted form and the printing step comprises printing the encrypted form of the serial identifier on the value document.

87. The method of claim 86, the wherein encrypting step comprises using an encryption process known by a central server connected to the networked terminals.

88. The method of claim 87, further comprising transmitting the unique terminal identifier to a central server for storage and use in a subsequent validation of the value document.

89. The method of claim 1, wherein the exposing step comprises creating in the pre-printed ink portion, the pattern comprising a plurality of sub-regions which are in turn created by applying a perforation mask to the exposing step.

90. The method of claim 1, wherein the pre-printed ink portion comprises a transparent ink, and the exposing step comprises creating an opaque pattern in the transparent ink layer as a result of the exposure of regions of the pre-printed transparent ink portion to the laser radiation.

91. A system for carrying out an automated authentication procedure of the identity of a person, the system comprising:
data receiving input means for receiving key data regarding a person;
constructing means for using the key data to construct a request for validating the identity of the person;
transmitting means for transmitting the request to a server holding personal data regarding the person;
receiving means for receiving response data from the server regarding the validity of the person's identity, the response data being generated by use of the key data; and
generating means for generating an outcome of the authentication procedure based on the response data and sending the same to an authentication process; and,
wherein the key data is minimized to a family name, an initial and a date of birth of the person.

92. The system of claim 91, further comprising:
a local data store for storing the response data; and
wherein the transmitting means is arranged to transmit a plurality of requests to a plurality of servers holding personal data regarding the person;
the receiving means is arranged to receive response data from the plurality of servers; and,
the data store is arranged to accumulate the received response data into a data file for the person.

93. The system of claim 92, wherein the transmitting means and receiving means are arranged to operate in real-time by sending out requests and receiving response data within 4 seconds; and to delete data file from the data store once the generating means has sent the generated response to the authentication procedure.

94. The system of claim 92, wherein the transmitting means and receiving means are arranged to operate in outside of real-time by sending out and receiving response data over a time period greater than one day; and to accumulate and retain the response data in the data store after the generating means has sent the generated response to the authentication procedure.

95. The system of claim 94, wherein the generating means is arranged to generate a subsequent response to a subsequent request for validating the identity of the person, the generating means using the accumulated data in the data file to create the outcome.

96. The system of claim 92, wherein the transmitting means further comprises a splitting module for splitting the request into a plurality of requests for sub data to send to a plurality of servers; the receiving means further comprises a re-assembly module for reassembling the responses received from the plurality of servers.

97. The system of claim 96, wherein the transmitting means further comprises a tagging module for tagging each of the plurality of requests and the re-assembly module is arranged to use the tagged responses to reassemble the responses received from the plurality of servers.

98. The system of claim 97, wherein the splitting module and the reassembly module are provided at a server implementing the authentication process.

99. The system of claim 97, wherein the splitting module and the reassembly module are provided at a location which is accessible before the authentication procedure is implemented.

100. A secure ticket verification process for entry through a barrier, wherein the ticket is a scratch card, the method comprising:
receiving a scratch card value document at a ticketing booth; the scratch card having a visible serial number and revealed information previously provided under scratch-off portions;
reading the serial number and the information shown at the revealed scratch-off portions of the scratch card;
verifying the relationship between the serial number and the read information using machine stored information not provided on the ticket; and,
if the relationship is valid, printing on the ticket an easily recognizable identifier for reading at the barrier and which openly signifies the validity of that ticket for a related event.

101. The method of claim 79, further comprising providing the data selection game on a mobile device of the user and the terminal receiving the user-interaction data from the mobile device.
